(19) United States
(12) Patent Application Publication
(10) Pub. No.: US 2025/0060533 A1
(43) Pub. Date: Feb. 20, 2025

(54) AUTOMATED FIBER PREPARATION AND WELDING METHODS AND SYSTEM

(71) Applicant: RAM Photonics Industrial, LLC, Webster, NY (US)

(72) Inventors: John Marciante, Webster, NY (US); Per Adamson, Conesus, NY (US); Michael Cinquino, Conesus, NY (US); Joseph Lawson, Rochester, NY (US); Robert Balonek, Rochester, NY (US)

(73) Assignee: RAM Photonics Industrial, LLC, Webster, NY (US)

(21) Appl. No.: 18/803,312

(22) Filed: Aug. 13, 2024

Related U.S. Application Data
(60) Provisional application No. 63/533,285, filed on Aug. 17, 2023.

(51) Int. Cl. G02B 6/255; G02B 6/245; G02B 6/25; G02B 6/42

(52) U.S. Cl. CPC G02B 6/2555; G02B 6/245; G02B 6/25; G02B 6/2551; G02B 6/4221

(57) ABSTRACT

A method for constructing a fiber array includes a) selecting a fiber spool among one or more fiber spools; b) processing a portion of the fiber spool to form an optical fiber having an output end; c) positioning a substrate at a position of a plurality of positions; and d) aligning the output end of the optical fiber to the substrate. The method also includes e) coupling the output end of the optical fiber to a location of a plurality of locations on the substrate; f) detaching the optical fiber from the fiber spool to form an input end of the optical fiber; and g) marking the optical fiber. The method further includes repeating c) through g) for each of the plurality of locations on the substrate determining that the substrate has been positioned at each of the plurality of positions.

### CROSS-REFERENCES TO RELATED APPLICATIONS

This application claims priority to U.S. Provisional Patent Application No. 63/533,285, filed on Aug. 17, 2023, entitled “Automated Fiber Preparation and Welding Methods and System,” the disclosure of which is hereby incorporated by reference in its entirety for all purposes.

### BACKGROUND OF THE INVENTION

Optical fibers have been widely used in optical systems. In some optical systems, multiple optical fibers can be spliced together, or an optical fiber can be bonded to an optical element. During the alignment process it is generally important to align the fiber such that light emitted by the optical fiber is minimally offset with respect to a corresponding end component. For example, a cleave angle of a cleaved end of an optical fiber may impact the offset or orientation of light emitted by the optical fiber. Any offset in the emitted light may impact the performance of the optical fiber in an optical system. Despite the progress made in the area of optical fibers and optical systems, there is a need in the art for improved methods and systems related to optical fibers and optical systems.

### SUMMARY OF THE INVENTION

The present disclosure relates generally to methods and systems related to optical systems including optical fibers. More particularly, embodiments of the present invention provide methods and systems that can be used to automate fabrication of fiber arrays including a plurality of optical fibers. The disclosure is applicable to a variety of applications in lasers and optics, including fiber laser implementations.

Numerous benefits are achieved by way of the present disclosure over conventional techniques. For example, embodiments of the present invention enable an automated fiber preparation and welding system. For instance, utilizing embodiments of the present invention in an automation setting, various optical fiber preparation, inspection, and attachment processes may be integrated in an efficient manner. Specifically, data associated with quality and cleanliness of various processes may be collected as part of the automated laser welding system described herein. These and other embodiments of the disclosure, along with many of its advantages and features, are described in more detail in conjunction with the text below and corresponding figures.

### DESCRIPTION OF THE DRAWINGS

FIG. 1 is a flowchart of an embodiment of an automated fiber preparation and welding system of the present disclosure.

FIG. 2 is a flowchart illustrating a method of constructing an optical fiber array according to an embodiment of the present disclosure.

FIGS. 3A-3B depict a simplified schematic diagram of an optical fiber presence sensing system according to an embodiment of the present invention.

FIG. 4 is a simplified schematic diagram of an optical fiber presence sensing system according to another embodiment of the present invention.

FIG. 5 is a flowchart of an embodiment of a method of the present disclosure.

FIG. 6A provides a simplified schematic diagram of a cleave angle measurement system, according to an embodiment of the present invention.

FIG. 6B illustrated a side view of the optical fiber as provided in the cleave angle measurement system, according to an embodiment of the present invention.

FIG. 7A illustrates a computational image of an emission face measurement used to calculate a cleave angle measurement, according to an embodiment of the present invention.

FIG. 7B depicts a diagram illustrating distance variable impacts on calculating a cleave angle, according to an embodiment of the present invention.

FIG. 8 depicts a diagram illustrating a computational image of multiple emission face measurements used to calculate a cleave angle, according to an embodiment of the present invention.

FIGS. 9A-9B depict diagrams illustrating computational images using an optical center to calculate and/or verify a cleave angle according to an embodiment of the present invention.

FIGS. 10A-10B provide computational images illustrating an embodiment including an invalid emission face measurement, according to an embodiment of the present invention.

FIGS. 11A-11B provide computational images illustrating an embodiment including an invalid emission face measurement, according to an embodiment of the present invention.

FIGS. 12A-12B illustrate a cleave angle measurement system, according to an embodiment of the present invention.

FIGS. 13A-13C illustrate embodiments of the surface of the optical fiber channel, according to embodiments of the present invention.

FIG. 14 is a simplified flowchart illustrating a method for measuring a cleave angle of an optical fiber using a cleave angle measurement system according to an embodiment of the present invention.

FIG. 15 is a simplified flowchart illustrating a method of measuring a cleave angle of a plurality of optical fibers using a cleave angle measurement system according to an embodiment of the present invention.

FIG. 16 is a simplified schematic diagram of a cleave angle measurement system, according to an embodiment of the present invention.

FIG. 17 is a simplified perspective view of a cleave angle measurement system, according to an embodiment of the present invention.

FIG. 18 is a simplified flowchart illustrating a method for measuring a cleave angle of an optical fiber using a cleave angle measurement system according to an embodiment of the present invention.

FIG. 19 is a simplified perspective view of a cleave angle measurement system, according to another embodiment of the present invention.

FIG. 20 is a simplified flowchart illustrating a method for measuring a cleave angle of an optical fiber using a cleave angle measurement system according to another embodiment of the present invention.

FIG. 21 is a simplified schematic diagram of an optical fiber alignment and positioning system according to an embodiment of the present invention.

FIG. 22 is a simplified schematic diagram of a vacuum stage for the optical fiber alignment and positioning system illustrated in FIGS. 6A-6B, according to an embodiment of the present invention.

FIG. 23 is a simplified schematic diagram of a vacuum stage for the optical fiber alignment and positioning system illustrated in FIGS. 6A-6B having a mechanical immobilizer, according to an embodiment of the present invention.

FIGS. 24A-24C illustrate embodiments in which an optical fiber is disposed within the optical fiber channel, according to an embodiment of the present invention.

FIG. 25 is a simplified flowchart illustrating a method for aligning and positioning an optical fiber using an optical fiber alignment and positioning system according to an embodiment of the present invention.

FIG. 26 is a simplified schematic diagram of a microlens array (MLA), according to an embodiment of the present invention.

FIG. 27 is a simplified schematic diagram of a conventional alignment process for aligning an optical fiber with a lenslet of an MLA.

FIG. 28A provides a simplified schematic diagram of a system for performing an MLA alignment according to an embodiment of the present invention when an optical fiber is located at the nominal position.

FIG. 28B provides a simplified schematic diagram of a system for performing an MLA alignment according to an embodiment of the present invention when the optical fiber is in rotational misalignment.

FIG. 28C provides a simplified schematic diagram of a system for performing an MLA alignment according to an embodiment of the present invention when the optical fiber is in rotational misalignment.

FIG. 29A provides a diagram illustrating an emission spot used to calculate a tilt measurement, according to an embodiment of the present invention.

FIG. 29B is a diagram illustrating an emission spot positioned such that the tilt measurement is within the tilt threshold, according to an embodiment of the present invention.

FIGS. 30A-30B depict a simplified schematic diagram illustrating alignment of an optical fiber with a lenslet in an MLA using the MLA alignment system, according to an embodiment of the present invention.

FIG. 31 provides a simplified flowchart illustrating a method of aligning an optical fiber with an MLA using an MLA alignment system according to an embodiment of the present invention.

FIG. 32 provides a simplified flowchart illustrating a method of aligning multiple optical fibers with multiple lenslets of an MLA using an MLA alignment system according to an embodiment of the present invention.

### DETAILED DESCRIPTION OF THE INVENTION

Various embodiments of the present disclosure describe constructing a laser welded fiber array in a fully automated fashion. A system for constructing a laser welded array may comprise stages for processes including selection of an optical fiber from different fiber sources, preparation of the optical fiber, alignment of the optical fiber to a substrate, attachment of the optical fiber to the substrate, marking of the optical fiber, and detachment of the welded optical fiber from the spool, and advancing the substrate for placement of the remaining optical fibers as determined by the design of the laser welded array. Using conventional methods, one or more of these processes are performed manually, which increases the final cost of the product to the consumer. Accordingly, embodiments of the present invention achieve lower cost and produce laser arrays with increased efficiency as described herein.

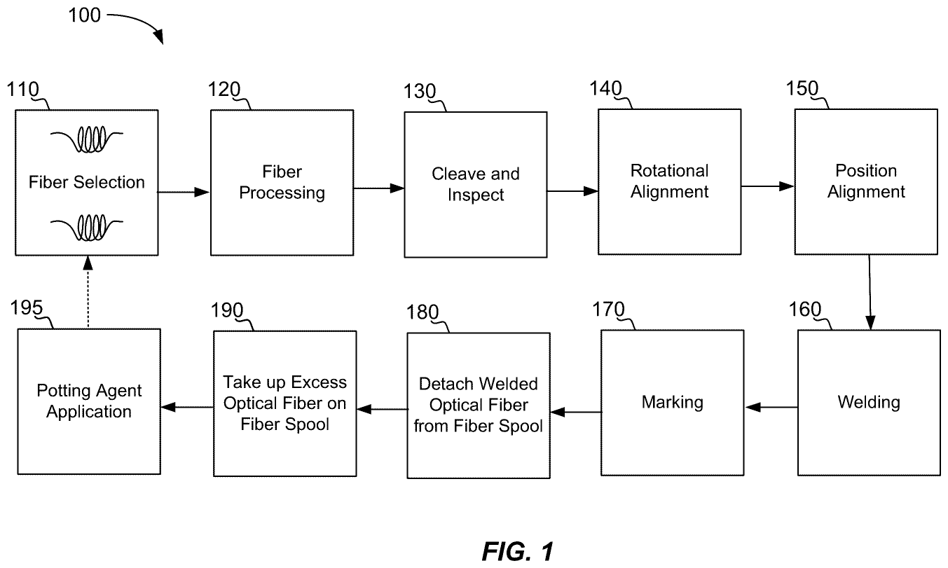

FIG. 1 is a flowchart of an embodiment of an automated fiber preparation and welding system of the present disclosure. The system 100 includes a fiber selection stage 110, a fiber processing stage 120, a cleave and inspection stage 130, a rotational alignment stage 140, a position alignment stage 150, a welding stage 160, a marking stage 170, a removal stage 180, a return stage 190, and a potting agent application stage 195. The system 100 may include more or less stages than those described herein. The system 100 may include the stages in any order or configuration in addition to the configuration of the system 100 shown in FIG. 1. In various embodiments, the system 100 produces laser welded fiber array(s) in a fully automated fashion. Processes performed at each of the stages are conventionally performed manually, resulting in increased cost of labor and goods. It would be beneficial to automate the system 100 to increase efficiency. Each stage is described in further detail with respect to various figures discussed below.

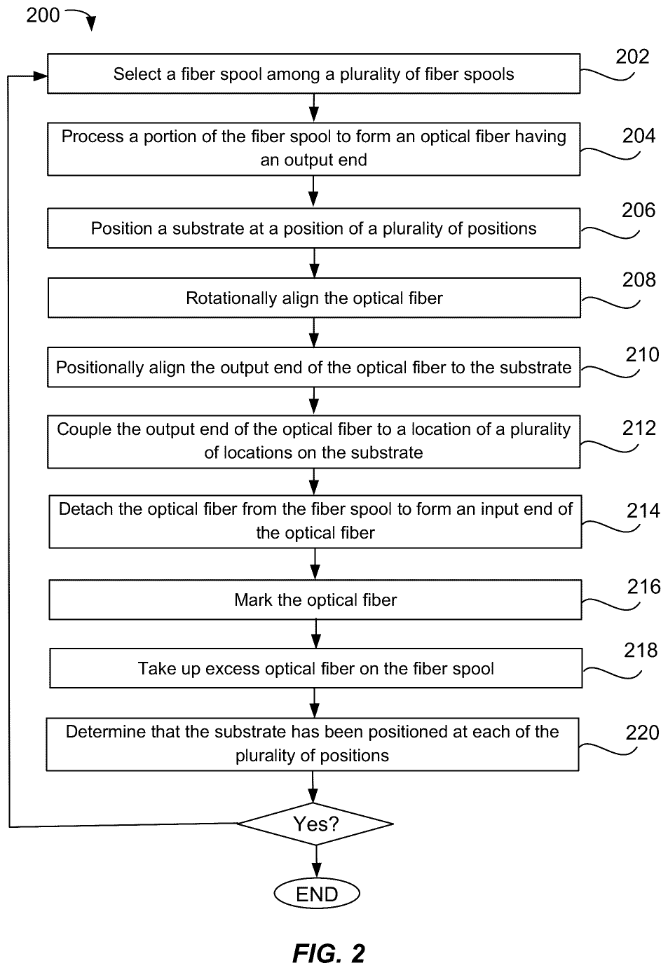

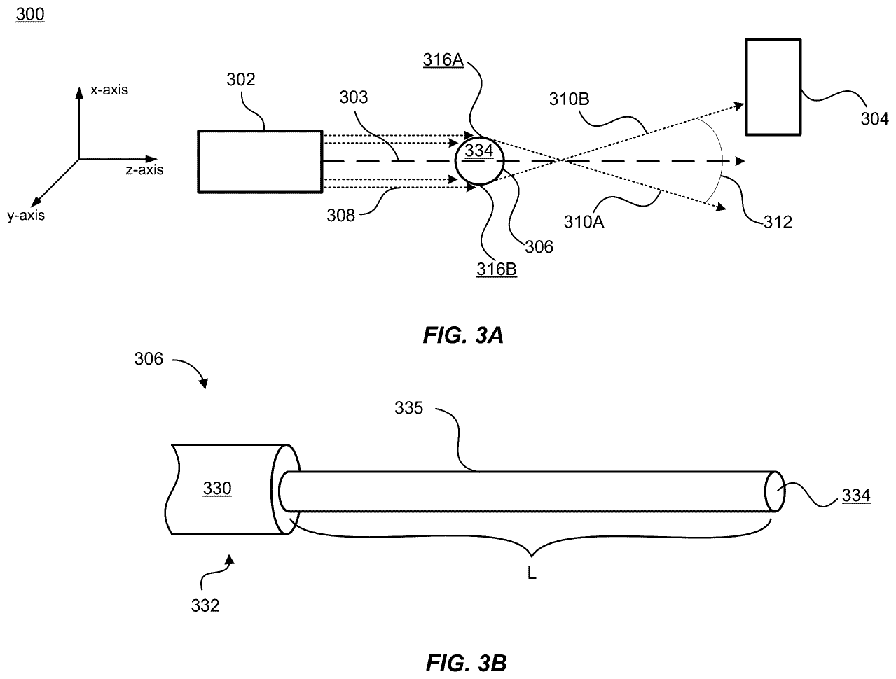

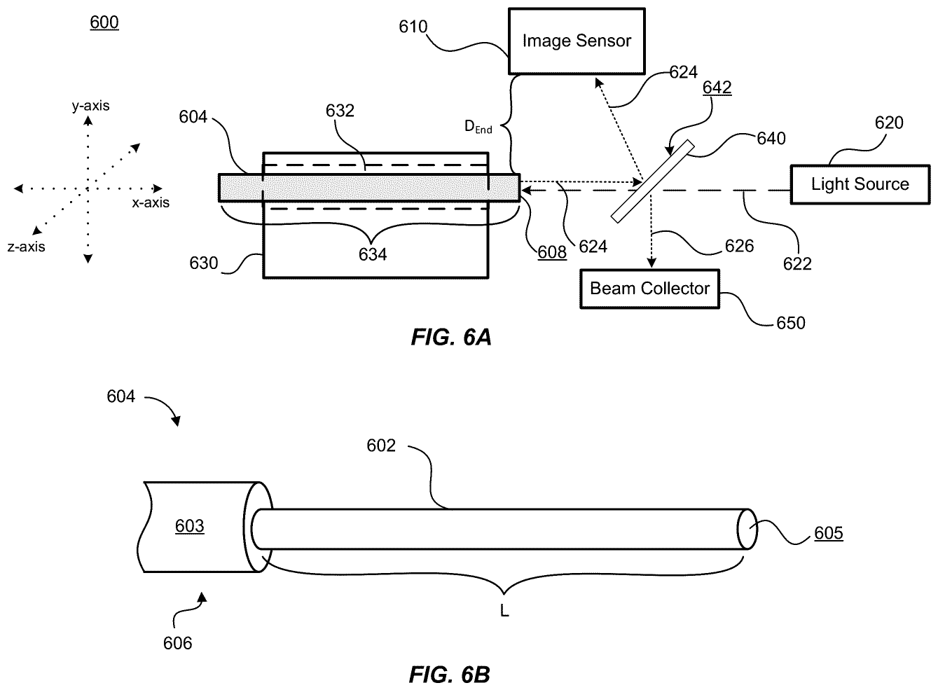

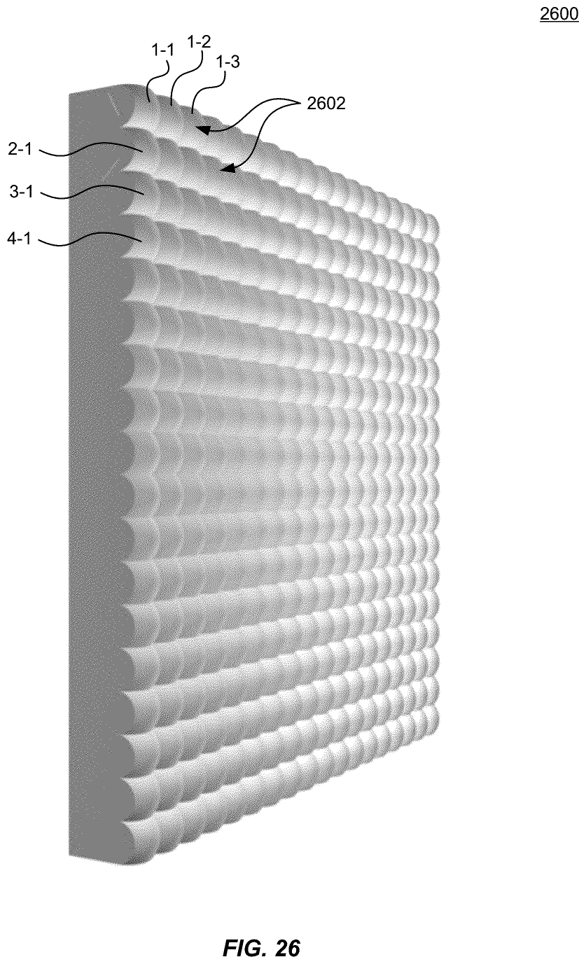

FIG. 2 is a flowchart of an embodiment of a method of the present disclosure. Various embodiments of method 200 may be performed in an automated system such as system 100 shown in FIG. 1. Embodiments of method 200 are described in further detail with respect to FIGS. 3-32 and it should be understood that various embodiments of the present disclosure may implement any combination of embodiments described herein without limitation unless otherwise noted herein. For example, FIGS. 3A-5 describe optical fiber presence sensing such as for the fiber selection stage 110 of FIG. 1. FIGS. 6A-20 describe cleave angle measurement such as for the cleave and inspection stage 130 of FIG. 1. FIGS. 21-25 describe rotational alignment such as that performed using the rotational alignment stage 140 of FIG. 1. FIGS. 26-32 describe position alignment such as that performed using the position alignment stage 150 of FIG. 1.

According to various embodiments, a system, such as system 100 of FIG. 1, is prepared to perform method 200 using a combination of automated and manual tasks. One or more fiber spools may be manually installed into the system. A laser may be manually attached to the back end (e.g., an input end) of the one or more fibers spools. A substrate is installed either manually or automatically such that the optical fibers may be disposed (e.g., welded) onto the substrate according to the method 200 described below. The substrate may be automatically aligned to a first location of a plurality of locations for an optical fiber, to be described in further detail below.

Method 200 includes selecting a fiber spool among one or more fiber spools (202). Selecting a fiber spool among one or more fiber spools may include locating and gripping a fiber spool in a manner to be described in further detail below. For example, method 200 may include locating and gripping an optical fiber. Selecting the fiber spool among the one or more fiber spools may be performed at the fiber selection stage of a system, such as the fiber selection stage 110 of system 100 as shown in FIG. 1. FIGS. 3A-5 describe optical fiber presence sensing for fiber spool selection in further detail below.

Method 200 also includes processing a portion of the fiber spool to form an optical fiber having an output end (204). In various embodiments, a length of fiber from the fiber spool is drawn from the fiber spool with reduced or minimal twisting. The output end of the optical fiber may be characterized as the end of the optical fiber that outputs characterization light when an opposite end of the optical fiber receives light from a light source. Processing may further include removal of the optical fiber jacket and transporting the fiber end to a fiber jacket removal mechanism while ensuring a snag-free fiber path. The fiber end may be installed into the optical fiber jacket removal mechanism and any coating may be removed from the selected fiber spool to form predetermined length of the optical fiber.

Processing may further include cleaning the length of the optical fiber. Cleaning the optical fiber may include transporting the optical fiber to a clean area in the system and removing any coating debris from the optical fiber. Processing a portion of the fiber spool to form an optical fiber having an output end may be performed at the fiber processing stage of a system, such as the fiber processing stage 120 of system 100 as shown in FIG. 1.

In various embodiments, an output end of the optical fiber is cleaved and inspected prior to proceeding with method 200. Cleaving and inspecting the optical fiber may include transporting the optical fiber to a cleaver and installing the optical fiber in the cleaver. The optical fiber may be cleaved to form the input end and removed from the cleaver. In some embodiments, fiber debris is removed from the cleaver. Cleaving and inspecting the input end of the optical fiber may be performed at the fiber cleaving and inspection stage of a system, such as cleave and inspection stage 130 of FIG. 1. In various embodiments, the optical fiber may be inspected and the cleave angle may be measured or otherwise verified, according to any of the embodiments described in detail below. The optical fiber may be determined to pass or fail and the decision to detach the optical fiber or abandon the optical fiber may be made based at least in part on predetermined criteria. FIGS. 6A-20 further describe cleave angle measurement and verification such as for the cleave and inspection stage 130 of FIG. 1.

Various alignment processes described herein may be performed in an automated manner. For example, aligning the output end of the optical fiber may include rotational alignment where the current fiber rotation position is determined, and the fiber rotation position may be corrected to a desired fiber rotation position. In at least some embodiments, the fiber rotation position includes the relative position between the optical fiber and the substrate in three spatial dimensions and two angular dimensions (e.g., tip/tilt). Determining and correcting the fiber rotation position may be automated processes within a system, according to various embodiments described herein. For example, FIGS. 21-25 describe rotational alignment such as for the rotational alignment stage 140 of FIG. 1.

The method 200 also includes positioning a substrate at a position of a plurality of positions (206). For example, a substrate may include a plurality of locations for optical fiber attachment and the substrate may be translated to a plurality of positions such that an optical fiber may be disposed at each location on the substrate for forming the fiber array. The substrate may be configured to be positioned within the automated system such that an optical fiber may be placed at each predetermined location on the substrate. For example, the substrate may be configured to be translated in each of an x-, y-, and z-direction in order to properly place an optical fiber at each location on the substrate.

Method 200 includes rotationally aligning the output end of the optical fiber to the substrate (208). In at least some embodiments, the output end of the optical fiber is coupled to the substrate. Prior to coupling, the output end of the optical fiber is aligned with a particular location on the substrate for forming the fiber array. Various embodiments of alignment of the optical fiber to the substrate are described in detail below with respect to other figures.

Rotationally aligning the output end of the optical fiber to the substrate may be performed at the fiber alignment stage of a system, such as the rotational alignment stage 140 of system 100 as shown in FIG. 1.

Method 200 includes positionally aligning the output end of the optical fiber to the substrate (210). In at least some embodiments, the output end of the optical fiber is coupled to the substrate. Prior to coupling, the output end of the optical fiber is aligned with a particular location on the substrate for forming the fiber array. Various embodiments of alignment of the optical fiber to the substrate are described in detail below with respect to other figures. Aligning the output end of the optical fiber to the substrate may be performed at the fiber alignment stage of a system, such as the position alignment stage 150 of system 100 as shown in FIG. 1. Further embodiments of aligning the output end of the optical fiber to the substrate are described with respect to FIGS. 26-32.

Method 200 also includes coupling the output end of the optical fiber to a location of a plurality of locations on the substrate (212). In various embodiments, once the fiber alignment is finalized, the optical fiber may be moved and attached to a substrate. The optical fiber may be coupled to the substrate using welding, gluing, or other processes known in the art. As would be appreciated by one having ordinary skill in the art upon reading the present disclosure, a fiber array is formed on the substrate having a plurality of predetermined locations on which an optical fiber is to be mounted or otherwise coupled. In various embodiments, an optical fiber is laser welded to each of the plurality of locations on the substrate. The attachment may be inspected and verified in an automated manner to ensure that the attachment is within any predefined requirements set by the user, the system, the intended application, etc.

The method 200 also includes detaching the optical fiber from the fiber spool to form an input end of the optical fiber (214). Method 200 also includes marking the optical fiber (216). Marking the optical fiber may include labelling the optical fiber including characteristic information of the optical fiber such as physical details including materials and/or location. Marking the optical fiber includes labelling the optical fiber including an index to a position in the fiber array. For example, the characteristic information may include how an optical fiber indexes to a position on the fiber array. Referring ahead to FIG. 26 in one exemplary embodiment, each lenslet 2602 may correspond to an indexed position such as 1-1, 1-2, 1-3, 2-1, 3-1, 4-1, or the like, to indicate a position in the array. Labelling the optical fiber with characteristic information may include the indexed position associated with the optical fiber. In some embodiments, the optical fiber coupled to the substrate is transported to a fiber labeling station, such as marking stage 170 of system 100 shown in FIG. 1, and a label may be printed onto the optical fiber, onto coating or plastic cover of the optical fiber, or otherwise added to the optical fiber. In various embodiments, detaching the optical fiber from the fiber spool to form an input end includes taking up any excess fiber and locating and grabbing the output end (218). The optical fiber may be cut from the fiber spool resulting in an optical fiber having an input end and an output end. The input end of the optical fiber may be an end of the optical fiber which receives light from a light source in a manner that would be appreciated by one having ordinary skill in the art.

In some embodiments, detaching the optical fiber from the fiber spool to form an input end of the optical fiber occurs prior to processing (204), positioning the substrate (206), and/or aligning the output end of the optical fiber to the substrate (208, 210). For example, the length of the optical fiber may be determined and created prior to coupling the output end of the optical fiber to a location of a plurality of locations on the substrate (212).

Method 200 includes repeating the process for each of the plurality of locations on the substrate and determining that the substrate has been positioned at each of the plurality of positions (220). For example, each position of the substrate may be associated with each of the plurality of locations on the substrate such that when the substrate has been positioned at each position and method 200 has been performed at each position, an optical fiber has been coupled to each of the locations at the plurality of locations to form the fiber array. In various embodiments, method 200 may be repeated and the substrate may be advanced to the next location such that an optical fiber is coupled to the next array point based on a pre-populated (e.g., predetermined) geometric array description, as would be understood by one having ordinary skill in the art upon reading the present disclosure.

The method 200 also includes applying a potting agent to the fiber-substrate interface. In various embodiments, after welding, a potting agent may be applied to the fibers. For example, a chemical glue or bonding agent may be applied to an area surrounding each fiber that is in contact with the substrate. In some embodiments, a heat source and/or an ultraviolet light source may be used to initiate a chemical reaction involving the chemical glue or bonding agent.

In other embodiments, another curing agent or initiator may be used. The potting agent provides additional strain relief on the fiber-substrate interface to improve product life cycle robustness. Furthermore, applying the potting agent may protect the fiber and substrate from environmental damage. Applying the potting agent, and any subsequent curing or finishing process, may be performed after each individual fiber is welded, after a specified number of fibers have been welded, or after all fibers have been welded.

In various embodiments, a system, such as system 100 described with respect to FIG. 1, concurrently processes a plurality of optical fibers in the manner described above with respect to method 200 and FIG. 2. For example, a plurality of optical fibers may be drawn from fiber spools and processed concurrently. The plurality of optical fibers may be disposed adjacent to one another in the fiber array, according to some embodiments.

FIG. 3A is a simplified schematic diagram of an optical fiber presence sensing system 300 according to an embodiment of the present invention. Various embodiments of the optical fiber presence sensing system 300 may be incorporated in an automated system such as system 100 shown in FIG. 1. As shown, the optical fiber presence sensing system 300 may include an illumination source 302 and a detector 304. The illumination source 302 may be positioned to emit a light beam 308 toward the detector 304 along an optical axis 303. As illustrated in FIG. 3A, the optical axis 303, which can also be referred to as an optical path, is aligned with the z-axis, which can also be referred to as a longitudinal axis. The light beam 308 may be a collimated light beam. The illumination source 302 may include a laser, a light emitting diode (LED), an arc lamp, a fiber optic illuminator, an incandescent source, a fluorescent source, a phosphorescent source, or the like. The detector 304 can be a photodiode, an array of photodiodes, a camera, or the like.

An optical fiber 306 may be positioned along the optical axis 303 between the illumination source 302 and the detector 304. The optical fiber 306 may be a transparent optical fiber. In some embodiments, the optical fiber 306 may include a jacket or coating provided by a manufacturer. In other embodiments, the optical fiber 306 may not include a jacket or coating. The optical fiber 306 may have a diameter that is less than 250 μm. For example, the optical fiber 306 may have a diameter that is less than 225 μm, less than 200 μm, less than 175 μm, less than 150 μm, less than 125 μm, or less than 100 μm. In various embodiments, the optical fiber may be a polarization maintaining fiber. For example, the optical fiber may be or include bow-tie fibers, panda fibers, multi-core fibers, elliptical fibers, photonic crystal optical fibers, and the like.

The optical fiber 306 may be positioned along the optical axis 303 such that the light beam 308 illuminates at least a portion of the optical fiber 306. In the embodiment illustrated in FIG. 3A, the optical fiber 306 is positioned along the optical axis 303 in a centered configuration such that the light beam 308 illuminates the optical fiber 306 over the entire diameter of the optical fiber 306. In FIG. 3A, the diameter of the light beam 308 and the diameter of the optical fiber 306 are equal, but this is not required and in other embodiments, the diameter of the light beam 308 is less than the diameter of the optical fiber 306 or the diameter of the light beam 308 is greater than the diameter of the optical fiber 306. Moreover, although the optical fiber 306 is centered on the origin of the x-z axes, the optical fiber 306 may be positioned at a location with a positive or negative z-position as well as a positive or negative x-position as long as an overlap exists between the light beam 308 and the optical fiber 306. One of ordinary skill in the art would recognize many variations, modifications, and alternatives.

For ease of discussion, FIG. 3B is provided to illustrate a side view of the optical fiber 306 as provided in the optical fiber presence sensing system 300. As shown by FIG. 3B, the optical fiber 306 may include a fiber body 332 and a fiber core/cladding 335. The fiber core/cladding 335 can terminate at an emission face 334. The fiber body 332 includes a jacket 330 surrounding the fiber core/cladding 335 in the fiber body 332. Light is emitted from emission face 334 during operation of the optical fiber 306.

For the optical fiber 306 illustrated in FIG. 3B, the fiber core/cladding 335 is characterized by a length L. As described more fully in relation to FIGS. 3A and 3B, the fiber core/cladding 335 can be disposed in the optical fiber presence sensing system 300 such that the fiber core/cladding 335 of the optical fiber 306 can be positioned with the length L perpendicular to the optical axis 303 corresponding to the light beam 308 emitted by the illumination source 302. The length L of the fiber core/cladding 335 of the optical fiber 306, and the position of the optical fiber 306 with respect to the illumination source 302 is described in greater detail with respect to FIGS. 3A and 3B.

Referring once again to FIG. 3A, the optical fiber 306 may be positioned along the optical axis 303 of the light beam 308 as emitted by the illumination source 302. In FIGS. 3A and 3B, the fiber core/cladding 335 extends along the y-axis, which is collinear with the optical axis 303. In other embodiments, the optical fiber 306 may be positioned such that portions of the light beam 308 refract through at least a portion of the fiber core/cladding 335 of the optical fiber 306. For example, the light beam 308 may refract through one or both of a first side 316A of the optical fiber 306 (i.e., the top half cylinder portion of the optical fiber) and a second side 316B of the optical fiber 306 (i.e., the bottom half cylinder portion of the optical fiber).

Due to the cylindrical nature of the fiber core/cladding 335 of the optical fiber 306, the light beam 308 refracts through the first side 316A and the second side 316B of the optical fiber 306 to form first refracted beam 310A and the second refracted beam 310B. First refracted beam 310A and second refracted beam 310B are understood to include the light beams refracted at the angles in angular range 312 between the first refracted beam 310A and the second refracted beam 310B. Because the first refracted beam 310A and the second refracted beam 310B are refracted through the optical fiber 306, which acts as a cylindrical lens, the first refracted beam 310A and the second refracted beam 310B may form a vertical line along the angular range 312 that is perpendicular to the length of the optical fiber 306. The width of the vertical line will be equal to the width (measured along the y-axis) of the light beam 308. In some embodiments, the width of the vertical line may also depend on a distance from the illumination source 302 and the divergence of the first refracted beam 310A and the second refracted beam 310B. The vertical line (aligned with the x-axis) is formed along the angular range 312.

To detect the presence of the optical fiber 306, the detector 304 may be positioned off-axis from the light beam 308 emitted by the illumination source 302. In other words, the detector 304 may be positioned off of the optical axis 303. Positioning the detector 304 off-axis may mean positioning the detector 304 either at a predetermined distance along the x-axis above or below the illumination source 302. Since the detector 304 can be in alignment with the illumination source 302 in the x-z plane (i.e., not displaced along the y-axis), the detector 304 will receive light refracted through the optical fiber and, therefore, be able to detect the presence of the optical fiber 306 as a result of refraction of the light beam 308 by the optical fiber 306. Although the detector 304 in FIG. 3A is oriented perpendicular to the optical fiber 306, in some embodiments, the detector 304 may be tilted toward the optical fiber 306.

By positioning the detector 304 off of the optical axis of the light beam 308 emitted by the illumination source 302, the detector 304 may only receive and thereby detect a portion of the vertical line formed by the first refracted beam 310A and the second refracted beam 310B. Since the first refracted beam 310A and the second refracted beam 310B are formed as a result of refraction by the optical fiber 306, if the optical fiber 306 is not present, then the first refracted beam 310A and the second refracted beam 310B are not formed, and the optical fiber 306 is not sensed.

It should be understood that in some embodiments, if the optical fiber 306 is positioned such that its length is aligned with the x-axis rather than the y-axis, then the first refracted beam 310A and the second refracted beam 310B may form a horizontal line along the y-axis instead of a vertical line along the x-axis. In such cases, the detector 304 may be positioned off-axis along the x-axis such that at least a portion of the horizontal line impinges on the detector 304.

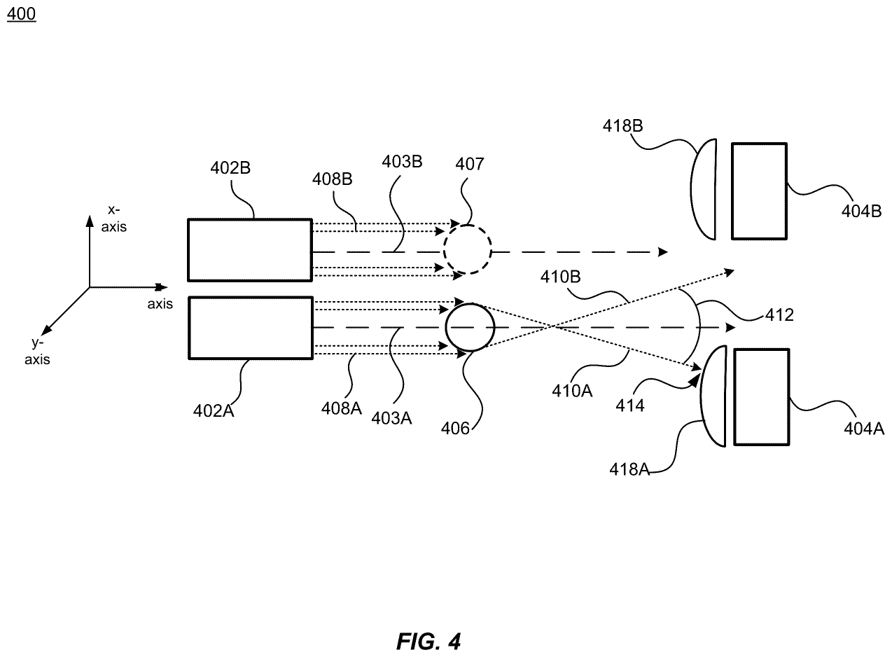

FIG. 4 is a simplified schematic diagram of an optical fiber presence sensing system according to another embodiment of the present invention. Referring to FIG. 4, an optical fiber presence sensing system 400 is illustrated, according to an embodiment herein. Various embodiments of optical fiber presence sensing system 400 may be performed in an automated system such as system 100 shown in FIG. 1. As shown, the optical fiber presence sensing system 400 may include a first illumination source 402A and a second illumination source 402B. The first illumination source 402A and the second illumination source 402B may be the same or similar to the first illumination source 402A illustrated in FIG. 4A. The optical fiber presence sensing system 400 may allow for detection of a position of an optical fiber when disposed in the optical fiber presence sensing system 400.

The optical fiber presence sensing system 400 may also include a first detector 404A and a second detector 404B. The first detector 404A and the second detector 404B may be the same or similar to the first detector 404A illustrated in FIG. 4A. The first illumination source 402A may be configured to emit a first light beam 408A towards the first detector 404A. The first light beam 408A is centered on first optical axis 403A. The second illumination source 402B may be configured to emit a second light beam 408B towards the second detector 404B. The second light beam 408B is centered on second optical axis 403B. The first detector 404A may be positioned off-axis with respect to the first light beam 408A produced by the first illumination source 402A. In other words, the first detector 404A may be positioned along the x-axis at an x-position separated from the x-position along the x-axis where the first light beam 408A is located. Thus, the first detector 404A is off-axis with respect to first light beam 408A produced by the first illumination source 402A.

Similarly, the second detector 404B may be positioned off-axis from the second illumination source 402B. In the embodiment illustrated in FIG. 4, the second detector 404B is positioned at a greater x-position than the position of the second optical axis 403B on which second light beam 408B is centered. The first detector 404A and the second detector 404B may be positioned such that each detector can only receive a vertical line formed by refracted beams formed from a respective light beam, i.e., first light beam 408A and second light beam 408B, respectively. For example, the first detector 404A may be positioned to only receive light from a vertical line formed by refracted beams produced as a result of the interaction of the first light beam 408A with the optical fiber 406, and the second detector 404B may be positioned to only receive light from a vertical line formed by refracted beams produced as a result of the interaction of the second light beam 408B with the optical fiber 406 positioned in the optional second position 407.

In some embodiments, the first illumination source 402A and the second illumination source 402B may be configured to emit different wavelengths. In such embodiments, the first detector 404A and the second detector 404B may be configured to detect the wavelength of the respective illumination source, i.e., the first illumination source 402A and the second illumination source 402B, respectively. Although the present example illustrated in FIG. 4 illustrates two illumination sources and two detectors, it should be appreciated that any number of illumination sources and/or detectors may be used. One of ordinary skill in the art would recognize many variations, modifications, and alternatives.

As shown, an optical fiber 406 may be disposed between the first illumination source 402A and the first detector 404A. The optical fiber 406 may be positioned such that a length of the optical fiber 406 is perpendicular to the first light beam 408A emitted by the first illumination source 402A. Similarly, the optical fiber 406 may be positioned in the optional second position 407 such that a length of the optical fiber 406 positioned in the optional second position 407 is perpendicular to the second light beam 408B emitted by the second illumination source 402B.

The optical fiber presence sensing system 400 may allow for the optical fiber 406 to be sensed in more than one position. For example, when the optical fiber 406 is positioned in a first position, as illustrated in FIG. 4, the first detector 404A may detect the presence of the optical fiber 406. When the optical fiber 406 is positioned in an optional second position 407, the second detector 404B may detect the presence of the optical fiber 406 in this optional second position 407.

To sense the optical fiber 406 in the first position as illustrated in FIG. 4, the first light beam 408A may be emitted onto at least a portion of the length of the optical fiber 406. As discussed above, due to the cylindrical nature of the length of the optical fiber 406, the first light beam 408A may be refracted by the optical fiber to form the first refracted beam 410A and the second refracted beam 410B. The first refracted beam 410A and the second refracted beam 410B are understood to include refracted beams at angles within the angular range 412. The first refracted beam 410A and the second refracted beam 410B may form a vertical line. A portion of the vertical line formed by the first refracted beam 410A and the second refracted beam 410B may be received by the first detector 404A at point 414. Based on receiving a portion of the vertical line formed by the first refracted beam 410A and the second refracted beam 410B, the first detector 404A may detect the presence of the optical fiber 406 in the first position. In embodiments where the optical fiber 406 is in the optional second position 407, the second detector 404B may detect the presence of the optical fiber 406 in the optional second position 407 via a similar technique.

In some embodiments, the optical fiber presence sensing system 400 may include one or more collecting lenses. For example, a first collecting lens 418A may be positioned in front of the first detector 404A. In other words, the first collecting lens 418A may be positioned between the optical fiber 406 and the first detector 404A. A second collecting lens 418B may be similarly positioned in front of the second detector 404B. The first collecting lens 418A may be positioned to capture at least a portion of the first refracted beam 410A and the second refracted beam 410B and direct the first refracted beam 410A and the second refracted beam 410B towards the first detector 404A. Similarly, the second collecting lens 418B may be positioned to capture at least a portion of light refracted by the optical fiber 406 when disposed in the optional second position 407, and direct the refracted light to the second detector 404B. In some embodiments, the first collecting lens 418A and/or the second collecting lens 418B may include a folding mirror or beam splitter. Depending on the configuration of the optical fiber presence sensing system 400, a collecting lens, a folding mirror, or a beam splitter may be used to direct the first refracted beam 410A and the second refracted beam 410B to the first detector 404A and/or the second detector 404B.

As noted above, the first detector 404A and the second detector 404B may each be positioned off-axis from a respective illumination source. As shown in FIG. 4, the second detector 404B may be off-axis from the second illumination source 402B such that the second light beam 408B is not received by the second detector 404B when the optical fiber 406 is not present in the optional second position 407. The second detector 404B may also be positioned to not receive either the first refracted beam 410A or the second refracted beam 410B that may be refracted from the optical fiber 406 when the optical fiber 406 is in the first position illustrated in FIG. 4. Similarly, the first detector 404A may be positioned off-axis from the first illumination source 402A to not receive the first light beam 408A when the optical fiber 406 is not in the first position illustrated in FIG. 4. Additionally, the first detector 404A may be positioned to not receive light from the second light beam 408B that is refracted by the optical fiber 406 when the optical fiber is in the optional second position 407. One example of positions for the first detector 404A and the second detector 404B may be that the first detector 404A is positioned off-axis along the x-axis below the first illumination source 402A and the second detector 404B may be positioned off-axis along the x-axis above the second illumination source 402B.

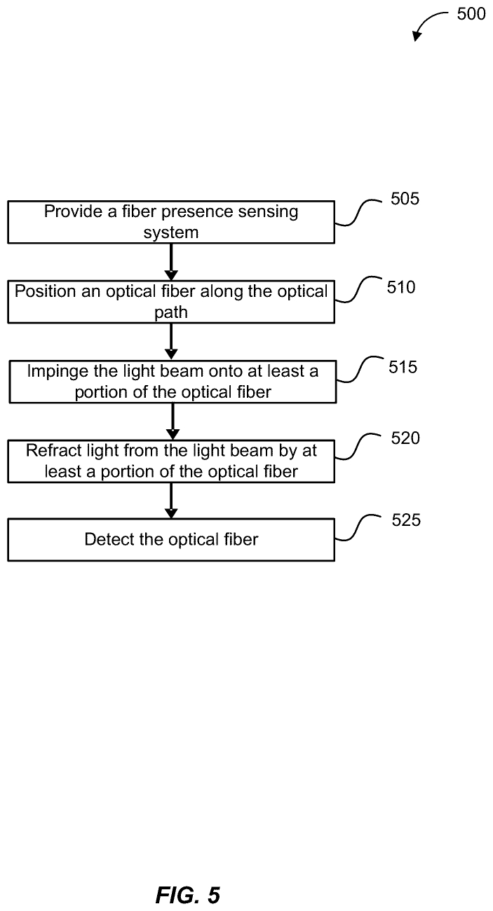

FIG. 5 is a flowchart of an embodiment of a method of the present disclosure. FIG. 5 is a simplified flowchart illustrating a method of sensing the presence of an optical fiber using an optical fiber presence sensing system according to an embodiment of the present invention. For ease of discussion, the method 500 illustrated in FIG. 5 is described with reference to FIG. 3A; however, it should be understood that any systems or techniques described herein may be applicable. Various embodiments of method 500 may be performed in an automated system such as system 100 shown in FIG. 1. Method 500 describes a method of selecting a fiber spool among a plurality of fiber spools described above with respect to FIG. 2. Method 500 describes a process in a system such as the fiber selection stage 110 of system 100 described with respect to FIG. 1. It should be appreciated that similar numbering may be used to describe similar components and that components of any of the FIGS. described herein may be used in conjunction with other components of any other FIGS. described herein.

The method 500 of sensing the presence of an optical fiber using an optical fiber presence sensing system includes providing the optical fiber presence sensing system (505). The optical fiber presence sensing system, for example, optical fiber presence sensing system 300, includes a first illumination source that is configured to emit a light beam along an optical path.

For example, the first illumination source may be a laser or an LED. The light beam can be emitted along an optical path aligned with an optical axis of the first illumination source. The optical fiber presence sensing system may also include a first detector, such as the detector 304 illustrated in FIG. 3. The detector may be positioned off-axis with respect to the optical path along which the light beam emitted from the first illumination source propagates, as illustrated in FIG. 3A, and be configured to detect the presence of light.

The method 500 also includes positioning an optical fiber along the optical path (510). In some embodiments, the optical fiber is positioned such that the length of the optical fiber is perpendicular to the optical path along which the light beam emitted by the first illumination source propagates. The optical fiber, for example optical fiber 306 illustrated in FIG. 3A, may be positioned such that its length, L, is perpendicular to the optical path of the light beam emitted by the first illumination source.

The method 500 further includes impinging the light beam onto at least a portion of the optical fiber (515). For example, the first illumination source may emit a light beam 308 that impinges on the optical fiber 306, as illustrated in FIG. 3A.

The method 500 additionally includes refracting light from the light beam by at least a portion of the optical fiber (520). As illustrated in FIG. 3A, first refracted beam 310A and second refracted beam 310B are produced as light beam 308 is refracted by optical fiber 306. The method also includes detecting, based at least in part on the refracted beam and using the first detector, the optical fiber (525). For example, the optical fiber presence sensing system 300 may detect the optical fiber 306 based on the first refracted beam 310A or the second refracted beam 310B. In some embodiments, detecting the optical fiber may further include detecting, using the first detector, at least a portion of a refracted beam. For example, the detector 304 may detect one or both of the first refracted beam 310A and the second refracted beam 310B. As described above, the first refracted beam 310A and the second refracted beam 310B may be formed by refracting through a portion of the optical fiber 306.

In some embodiments, the optical fiber presence sensing system 300 may further include a second illumination source and a second detector. In such embodiments, the method 500 may further include determining, using the first detector and the second detector, a position of the optical fiber. For example, as illustrated by FIG. 4, the position of the optical fiber 406 may be determined by the first detector 404A and the second detector 404B.

It should be appreciated that the specific steps illustrated in FIG. 5 provide a particular method of detecting an optical fiber according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

To provide accurate and consistent measurements of a cleave angle of an optical fiber to below 1 degree of angle, a cleave angle measurement system is provided herein. FIG. 6A provides a simplified schematic diagram of a cleave angle measurement system 600 according to an embodiment of the present invention. The cleave angle measurement system 600 may allow for measuring of a cleave angle of an optical fiber 604. Specifically, the cleave angle measurement system 600 may measure the cleave angle of a cleaved end 608 of the optical fiber 604. As noted above, the cleaved end 608 of the optical fiber 604 may be formed during a manufacturing process of the optical fiber 604. For example, the optical fiber 604 may be cleaved or otherwise cut from a spool or longer length of optical fiber. During the cleaving process, the cleaved end 608 may be formed having a cleave angle. As will be discussed in greater detail below, the cleave angle may be a reference to how perpendicular the cleaved end 608 of the optical fiber 604 is to the optical axis of the optical fiber 604. The optical axis of the optical fiber 604 may be parallel with the longitudinal length 634 of the optical fiber 604.

The optical fiber 604 may be a polarization maintaining fiber having one or more stress rods, a patterned microstructure, or one or more cores. In some embodiments, the optical fiber 604 may be or include a bow-tie fiber, a panda fiber, a multi-core fiber, an elliptical fiber, a photonic crystal optical fiber, or the like. The optical fiber 604 may have a diameter that is less than 250 μm. For example, the optical fiber 604 may have a diameter that is less than 225 μm, less than 80 μm, less than 175 μm, less than 150 μm, less than 125 μm, or less than 100 μm. In some embodiments, the optical fiber 604 may have a diameter that is greater than 250 μm. For example, the diameter of the optical fiber 604 may be greater than 300 μm, 350 μm, or 400 μm. The diameter of the optical fiber 604 may depend on the type of the optical fiber.

The cleave angle measurement system 600 may be able to measure the cleave angle of the optical fiber 604 to within a degree of angle. In some embodiments, the cleave angle measurement system 600 may be able to measure the cleave angle of the optical fiber to within a 0.5 degree of angle, to within a 0.3 degree of angle, or within a 0.25 degree of angle. In other words, the cleave angle measurement system 600 is able to measure the cleave angle with precise accuracy. In addition to the precise accuracy achievable by the cleave angle measurement system 600, the cleave angle measurement system 600 provides consistent repeatability of a cleave angle measurement. The repeatability and the precise measurements provided by the cleave angle measurement system 600 illustrate the accuracy at which the cleave angle measurement system 600 is able to measure the cleave angle of the optical fiber 604.

To measure the cleave angle of the optical fiber 604, the cleave angle measurement system 600 may include stage 630, a light source 620, and an image sensor 610. In some embodiments, the stage 630 may include an optical fiber channel 632. The optical fiber channel 632 may be a portion of the stage 630 that is configured to receive at least a portion of a longitudinal length 634 of the optical fiber 604. For example, the optical fiber channel 632 may be a v-groove. The optical fiber channel 632 may be optimized or adjusted for various cladding diameters of the optical fiber 604.

The optical fiber channel 632 may also be configured to secure the optical fiber 604 during the cleave angle measurement process. To hold the optical fiber 604 in the desired position, the optical fiber 604 may be held in place by one side. It is often desired to hold the optical fiber 604 such that it can be easily released from the desired position without impacting the position of the optical fiber 604. A common means of holding the optical fiber 604 in a desired position that allows for easy release of the optical fiber 604 may include a vacuum chuck or other clamping mechanisms. As such, in some embodiments, the optical fiber channel 632 may include a vacuum chuck or a clamp for securing the optical fiber 604 in the optical fiber channel 632.

In some embodiments, the optical fiber 604 may be placed in the optical fiber channel 632 such that at least a portion of a fiber core or cladding of the optical fiber 604 is secured by the optical fiber channel 632. For ease of discussion, FIG. 6B is provided to illustrate a side view of the optical fiber 604 as provided in the cleave angle measurement system 600. As shown by FIG. 6B, the optical fiber 604 may include a fiber body 606 and a fiber core/cladding 602. The fiber core/cladding 602 may be referred to as an inner portion of the optical fiber 604. The fiber core/cladding 602 can terminate at an emission face 605. The fiber body 606 includes a jacket 603 surrounding the fiber core/cladding 602 in the fiber body 606. For example, the jacket 603 may be a plastic coating applied to the fiber core/cladding 602. Light is emitted from emission face 605 during operation of the optical fiber 604. The emission face 605 may be part of the cleaved end 608.

As noted above, the optical fiber 604 may include various manufacturing properties, such as the cleave angle. Other manufacturing properties of the optical fiber 604 may include a bend or curvature of the optical fiber 604 along the longitudinal length, L, of the optical fiber 604. During, or after the manufacturing process, the optical fiber 604 may be wound or rolled into a bundle, which can result in a bend or curvature of the optical fiber 604 along the longitudinal length 634. Additional manufacturing characteristics of the optical fiber 604 may include the material of the optical fiber 604, the material used to form the jacket 603, and the jacket 603 itself. For example, the jacket 603 may be applied such that the jacket 603 includes irregularities. Irregularities may include a thickness with which the jacket 603 is applied to the optical fiber 604. Irregularities may make an outer surface of the optical fiber 604 non-cylindrical. Any irregularities in the jacket 603 may negatively impact the measurement of the cleave angle. Additionally, the jacket 603 may cause bending of the optical fiber due to memory caused by spooling of the optical fiber during the manufacturing process.

To prevent irregularities of the jacket 603 from impacting the cleave angle measurement, the jacket 603 may be removed over a portion of the longitudinal length 634 of the optical fiber 604. For example, a longitudinal length, L, of the fiber core/cladding 602, also referred to as an inner portion, may be exposed by removing the jacket 603 for that length. The longitudinal length, L, may start at the cleaved end 608 of the optical fiber 604 and extend along the longitudinal length 634. In some embodiments, the longitudinal length, L, may range from 1 mm to 25 mm, from 5 mm to 8 mm, or from 10 mm to 15 mm. In an example embodiment, the longitudinal length, L, from which the jacket 603 is removed, may be 10 mm or 1 cm.

The optical fiber 604 may be secured in the optical fiber channel 632 by the longitudinal length, L, of the fiber core/cladding 602. By holding the optical fiber 604 using the fiber core/cladding 602, the cleave angle measurement system 600 may provide for more accurate measurements and consistent repeatability of cleave angle measurements.

As those skilled in the art will readily appreciate, removing the jacket 603 from the fiber core/cladding 602 may not impact the functionality of the optical fiber 604. For example, many applications utilize removal or stripping of the jacket 603 of the optical fiber 604. Moreover, cleaving of the optical fiber 604 generally includes removal of a portion the jacket 603 from the cleaved end 608 of the optical fiber 604. Accordingly, removing the jacket 603 from the longitudinal length, L, of the fiber core/cladding 602 may not impact the functionality and applicability of the optical fiber 604.

Referring once again to FIG. 6A, the optical fiber 604 may be positioned in the optical fiber channel 632 such that the cleaved end 608 is in optical alignment with the light source 620. Optical alignment may mean that light beam 622, when transmitted by the light source 620, is directed onto the cleaved end 608 of the optical fiber 604. The light source 620 may be configured to emit the light beam 622 toward the cleaved end 608. For example, the light source 620 may include a laser, a light emitting diode (LED), an arc lamp, a fiber optic illuminator, an incandescent source, a fluorescent source, a phosphorescent source, or the like. In an example embodiment, the light source 620 may include an external laser.

As shown, the light source 620 may transmit the light beam 622 toward the cleaved end 608 such that the light beam 622 is reflected off of the cleaved end 608. The light beam 622 may reflect off of the cleaved end 608 as reflected light 624. The reflected light 624 may be received by the image sensor 610. The image sensor 610 may be configured to detect the reflected light 624. For example, the image sensor 610 may be or include a camera, quadrant photodiode, or other instrument capable of sensing light. In an example embodiment, the image sensor 610 may be a silicon imaging camera or an infrared camera.

In some embodiments, the reflected light 624 may be directed to the image sensor 610 by a beam splitter 640. The beam splitter 640 may be positioned in axial alignment with the optical fiber 604 and the light source 620. The beam splitter 640 may be positioned between the optical fiber 604 and the light source 620 along the x-axis. The beam splitter 640 may also be positioned to reflect the reflected light 624 to the image sensor 610. For example, the beam splitter 640 may include a surface 642 that reflects a portion of the reflected light 624 toward the image sensor 610. The surface 642 of the beam splitter 640 may be a reflective surface such as a mirror. In an example embodiment, the beam splitter 640 may be a non-polarizing beam splitter. For example, the beam splitter 640 may be a standard 50:50 beam splitter.

In some embodiments, the cleave angle measurement system 600 may include a beam collector 650. The beam collector 650 may collect stray light 626. Specifically, the beam collector 650 may prevent the stray light 626 from reaching the image sensor 610. For example, the beam collector 650 may be implemented as an empty tube or a light dump.

As illustrated, the cleave angle measurement system 600 may not include any additional lens to direct, refract, or collimate the light beam 622 or the reflected light 624. Conventional methods often include one or more lenses to manipulate the optical properties of light used to measure the cleave angle of an optical fiber. By not including a lens, the cleave angle measurement system 600 may include fewer components than conventional systems and may provide a faster and more convenient system and technique for measuring a cleave angle. For example, the cleave angle measurement system 600 may not require the positioning and lighting of components with a lens, thereby providing a more convenient method of measuring a cleave angle.

The image sensor 610 may be positioned at a distance, D_{End}, from the cleaved end 608 of the optical fiber 604. The distance, D_{End}, may be the total distance that the reflected light 624 travels from the cleaved end 608 to reach the image sensor 610. For example, the image sensor 610 may be positioned such that the distance, D_{End}, is at least 10 cm, at least 25 cm, at least 50 cm, or at least 100 cm from the cleaved end 608.

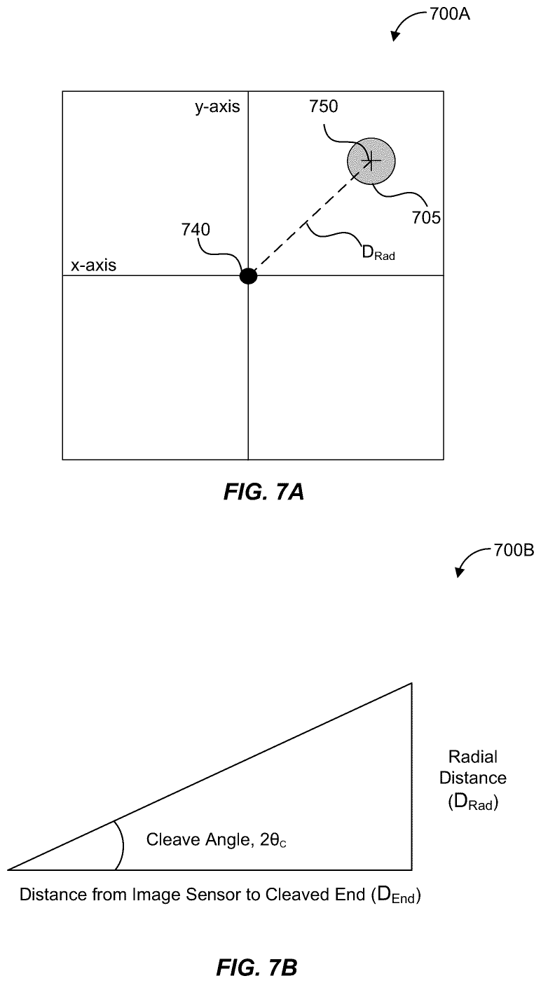

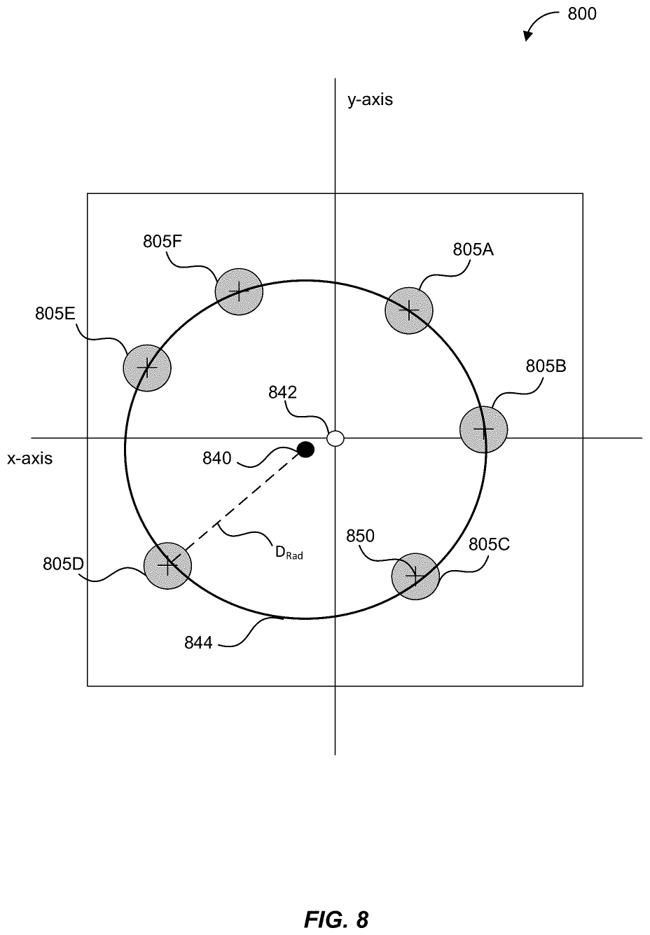

The image sensor 610 may detect the reflected light 624 from the cleaved end 608. Specifically, the image sensor 610 may detect the emission face 605 of the optical fiber 604 to generate an emission face measurement. Turning now to FIG. 7A, a computational image 700A of an emission face measurement 705 used to calculate a cleave angle measurement is provided. Although the following discussion is with respect to FIGS. 6A and 6B, it should be understood that any systems or techniques provided herein may be used.

The computational image 700A may be generated based on the reflected light 624 detected by the image sensor 610. For example, an image used to generate the computational image 700A may be captured by receiving the reflected light 624. One of several image processing methods can be utilized to detect and/or identify the various components of the optical fiber. In some embodiments, the various components of the optical fiber can be identified based on pixel coordinates within the captured image.

The computational image 700A may include an emission face measurement 705. The emission face measurement 705 may correspond to the emission face 605 of the optical fiber 604. The computational image 700A may include an x-axis and a y-axis. The emission face measurement 705 may be generated on the computational image 700A at x-y coordinates with respect to an optical center 740. The optical center 740 may be computationally determined. The optical center 740 may be an optical center of the image sensor 610. For example, as illustrated, the optical center 740 may be determined to be at an origin point of the x-y axes. Another method of determining the optical center 740 is discussed in greater detail with respect to FIG. 8.

A centroid 750 may be identified for the emission face measurement 705. The centroid 750 may be computationally determined as a center point within the emission face measurement 705. The centroid 750 of the emission face measurement 705 may be used to determine the cleave angle of the optical fiber 604. For example, a radial distance, D_{Rad}, for the optical fiber 604 may be determined based on the centroid 750. The radial distance, D_{Rad}, may be a distance from the centroid 750 of the optical fiber 604 to the optical center 740. The radial distance, D_{Rad}, may be measured in units of pixels or mm.

Turning now to FIG. 7B, a diagram 700B illustrating distance variable impacts on calculating a cleave angle is provided. As shown by the diagram 700B, the cleave angle, θ_{C}, may be determined based on the radial distance, D_{Rad}, and the distance, D_{End}, from the image sensor to the cleaved end.

Specifically, the cleave angle, θ_{C}, may be calculated based on the following cleave angle equation:

$${θ}_{C} = ( {tan}^{- 1} ( \frac{{D}_{Rad}}{{D}_{End}} ) ) / 2$$

The above cleave angle equation may provide a greater degree of accuracy over conventional cleave angle measurement techniques. For example, because the cleave angle equation is based off of the radial distance, D_{Rad}, which in turn is determined by light reflected off of the cleaved end 608 of the optical fiber 604, there may be an increase in sensitivity to cleave angle variation. In some embodiments, there may be a 50% increase in sensitivity gained by measuring the cleave angle, θ_{C}, with reflected light 624 versus conventional methods that use light emitted from the cleaved end 608 of the optical fiber 604 or from conventional methods that use interferometry techniques. The increased sensitivity may allow for cleave angle measurements that are within a 0.5 degree angle measurement.

Importantly, because the above cleave angle equation uses the reflected light 624, the cleave angle measurement system 600 can measure any style of optical fiber 604. For example, the cleave angle measurement system 600 may use the geometry of the reflected beam after reflection from the optical fiber 604 to determine the emission face measurement 705 that is independent of fiber wavelength design, core size, and microstructures within the optical fiber 604. The cleave angle measurement system 600 may use light within the visible spectrum, thereby allowing for easy alignment and a more efficient cleave angle measurement method.

In some embodiments, the optical fiber 604 may be rotated to improve a cleave angle measurement. For example, the optical fiber 604 may be rotated about the x-axis via stage 630. The optical fiber 604 may be rotated from a first position by a pre-determined rotation amount to a second position. At the second position, the image sensor 610 may generate a second emission face measurement based on the reflected light 624.

Turning now to FIG. 8, a diagram illustrating a computational image 800 of multiple emission face measurements used to calculate a cleave angle according to an embodiment of the present invention is provided. For ease of discussion, FIG. 8 is discussed with relation to FIGS. 6, 7A, and 7B; however, it should be understood that any systems or techniques disclosed herein may be applicable.

As shown, the computational image 800 may include multiple emission face measurements 805A-F. Each of emission face measurements 805A-F may correspond to the cleaved end 608 of the optical fiber 604 at a different rotational position. For example, the emission face measurement 805A may be generated based on the optical fiber 604 in a first position. After generating the emission face measurement 805A, the optical fiber 604 may be rotated by a pre-determined rotation amount to a second position. At the second position, the emission face measurement 805B may be generated. The emission face measurements 805C-F may be generated following the same technique for the optical fiber 604 in a third position, fourth position, fifth position, and sixth position, respectively. A centroid 850 may be determined for each of the emission face measurements 805A-F, as discussed with respect to FIG. 7A.

In some embodiments, such as the embodiment illustrated by FIG. 8, the computational image 800 may be used to calibrate the cleave angle measurement system 600. For example, the computational image 800 may be used to determine an optical center 840 for the image sensor 610. The optical center 840 may vary depending on the orientation of the optical fiber channel 632 and/or the optical fiber 604. For example, the optical fiber 604 may have a diameter that may impact the optical center 840 of the image sensor 610. Additionally, the positioning of the optical fiber channel 632 with relation to the image sensor 610 may impact the optical center 840 of the image sensor 610.

To determine the optical center 840, an emission face arc 844 may be determined. For example, the emission face arc 844 may be determined based on the centroid 850 for each of the emission face measurements 805A-F. In other words, the emission face arc 844 may be fitted to centroid 850 for each of the emission face measurements 805A-F. Then, based on the emission face arc 844, the optical center 840 may be determined as the central point of the emission face arc 844. As illustrated in this embodiment, the optical center 840 may not be an origin point 842 of the x-y axes. Instead, the cleave angle measurement system 600 may be calibrated such that the optical center 840 is based off of the optical fiber 604 and the current positioning of the components within the cleave angle measurement system 600, such as the optical fiber channel 632.

In some embodiments, the emission face arc 844 may be mathematically determined for the emission face measurements 805A-F. For example, the emission face arc 844 may be determined using the following equations [I]-[XII], which include fitting least squares equations to a circle. Once determined, the emission face arc 844 may be used to determine whether an emission face measurement within the emission face measurements 805A-F is invalid or valid.

Equation [I] starts with an equation for a circle, where a and b correspond to the x-y coordinates, respectively, for the centroid of the emission face arc 844. Here, the centroid of the emission face arc 844 may be the optical center 840. R is the radius for the emission face arc 844. Here, R may be the radial distance, D_{Rad}.

$${( x - a )}^{2} + {( y - b )}^{2} = {R}^{2} \qquad [ I ]$$

For a given measured point, i, on the emission face arc 844, the residual error may be defined by dᵢ, characterized by the following equation [II].

$${d}_{i} = \sqrt{{( {x}_{i} - a )}^{2} + {( {y}_{i} - b )}^{2}} - {R}^{2} \qquad [ II ]$$

A sum of residuals for n points is a function of a, b, and R, characterized by the following equation [III].

$$F ( a , b , R ) = {{\sum }_{i = 1}^{n} [ {( {x}_{i} - a )}^{2} + {( {y}_{i} - b )}^{2} - {R}^{2} ]}^{2} \qquad [ III ]$$

Equation [III] as rewritten becomes equation [IV] based on equations [V]-[VII].

$$F ( a , b , R ) = {{\sum }_{i = 1}^{n} [ {x}_{i}^{2} + {y}_{i}^{{2}^{}} + B {x}_{i} + C {y}_{i} + D ]}^{2} Where : \qquad [ IV ]$$

$$B = - 2 a \qquad [ V ]$$

$$C = - 2 b \qquad [ VI ]$$

$$D = {a}^{2} + {b}^{2} - {R}^{2} \qquad [ VII \}$$

Variable F in Equation [IV] is then differentiated with respect to B, C, and D to yield equations [VIII], [IX], and [X], as follows.

$$( \sum {x}_{i} ) B + ( \sum {y}_{i} ) C + n D = - \sum ( {x}_{i}^{2} + {y}_{i}^{2} ) \qquad [ VIII ]$$

$$( \sum {x}_{i} {y}_{i} ) B + ( \sum {y}_{i}^{2} ) C + ( \sum {y}_{i} ) D = - \sum ( {x}_{i}^{2} {y}_{i} + {y}_{i}^{3} ) \qquad [ IX ]$$

$$( \sum {x}_{i}^{2} ) B + ( \sum {x}_{i} {y}_{i} ) C + ( \sum {x}_{i} ) D = - \sum ( {x}_{i}^{3} + {x}_{i} {y}_{i}^{2} ) \qquad [ X ]$$

The Equations [VIII]-[X] may be reduced to a matrix, as illustrated by Equation [XI].

$$[ \begin{matrix}\sum {x}_{i} & \sum {y}_{i} & n \\ \sum {x}_{i} {y}_{i} & \sum {y}_{i}^{2} & \sum {y}_{i} \\ \sum {x}_{i}^{2} & \sum {x}_{i} {y}_{i} & \sum {x}_{i}\end{matrix} ] ( \begin{matrix}B \\ C \\ D\end{matrix} ) = ( \begin{matrix}- \sum ( {x}_{i}^{2} + {y}_{i}^{2} ) \\ - \sum ( {x}_{i}^{2} {y}_{i} + {y}_{i}^{3} ) \\ - \sum ( {x}_{i}^{3} + {x}_{i} {y}_{i}^{2} )\end{matrix} ) \qquad [ XI ]$$

Equation [XI] may be in the form of:

$$Mv = p \qquad [ XII ]$$

Solving Equations [I]-[XII] may determine variables B, C, and D. Once variables B, C, and D are known, an optimal centroid and radius for the emission face arc 844 may be determined.

The emission face arc 844 may correspond to the cleave angle of the optical fiber 604. For example, if the cleaved end 608 of the optical fiber 604 is perfectly cleaved, thereby being exactly perpendicular to the optical axis of the optical fiber 604, the emission face measurements 805A-F would not precess when the optical fiber 604 is rotated about the optical axis (e.g., x-axis), and thus no emission face arc 844 would be generated. Instead, the emission face measurements 805A-F for the optical fiber 604 at different positions would stay in the same location on the computational image 800. As the cleave angle increases, however, the emission face arc 844 may also increase as the optical fiber 604 is rotated to different positions. As such, the emission face arc 844 as illustrated may indicate the non-perfect cleave angle of the cleaved end 608 of the optical fiber 604.

A radial distance, D_{Rad}, for each of the emission face measurements 805A-F may then be determined. The radial distance, D_{Rad}, may be the distance for each emission face measurement 805A-F at a given position to the optical center 840.

To calibrate the cleave angle measurement system 600, an optical fiber having a known cleave angle may be used for generation of emission face measurements 805A-F. Then, using the known cleave angle and the determined radial distance, D_{Rad}, a correlation between the known cleave angle and the radial distance, D_{Rad}, can be determined. Because the cleave angle at the radial distance, D_{Rad}, is known, and a cleave angle at the optical center 840 is known to be zero, then a cleave angle can be extrapolated or calculated for other radial distances, D_{Rad}.

In some embodiments, calibration of the cleave angle measurement system 600 may allow for swift cleave angle measurement processing of multiple optical fibers. For example, a single measurement may be used to determine a cleave angle for an optical fiber. Since the optical center 840 is determined based on the above-described calibration process, and a correlation between cleave angle and radial distance, D_{Rad}, is determined, a cleave angle may be determined based on a single emission face measurement. Specifically, the cleave angle may be determined based on a radial distance, D_{Rad}, for the single emission face measurement.

In some embodiments, additional emission faces measurements may be collected to increase the accuracy of the cleave angle measurement or to verify the validity of the initial cleave angle measurement. As any noise within the cleave angle measurement system 600 may impact a cleave angle measurement, verifying the validity of a cleave angle measurement may be advantageous to improve the accuracy of a cleave angle measurement.

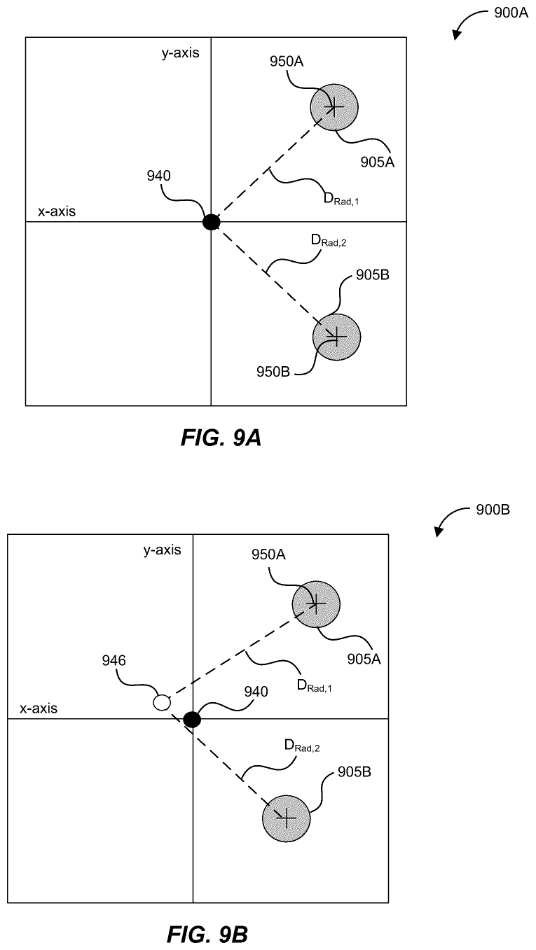

Turning now to FIGS. 9A-B, diagrams illustrating computational images using an optical center to calculate and/or verify a cleave angle according to an embodiment of the present invention are provided. For ease of discussion, FIGS. 9A-B are discussed with relation to FIGS. 6A-8; however, it should be understood that any systems or techniques disclosed herein may be applicable.

FIG. 9A provides computational image 900A. As shown, the computational image 900A includes two emission face measurements: emission face measurement 905A and emission face measurement 905B. The emission face measurements 905A and the emission face measurement 905B may be generated based on the reflected light reflected off of the cleaved end of the optical fiber in a first position and a second position, respectively.

The emission face measurement 905B may be generated to verify the validity of a cleave angle measurement calculated based on a first radial distance, D_{Rad,1}, for the emission face measurement 905A. To verify the cleave angle measurement for the emission face measurement 905A, a first centroid 950A for the emission face measurement 905A may be determined and a second centroid 950B for the emission face measurement 905B may be determined. Then, using the first centroid 950A, a first radial distance, D_{Rad,1}, may be determined for the emission face measurement 905A. Similarly, using the second centroid 950B, a second radial distance, D_{Rad,2}, may be determined for the emission face measurement 905B.

As discussed above, a radial distance may be determined as the distance from the centroid of an emission face to the optical center. Thus, in a first example embodiment, the first radial distance, D_{Rad,1}, may be determined from the first centroid 950A to the optical center 940, and the second radial distance, D_{Rad,2}, may be determined from the second centroid 950B to the optical center 940. If the first radial distance, D_{Rad,1}, and the second radial distance, D_{Rad,2}, are equal, then the emission face measurement 905B may be validated. The emission face measurement 905B may be validated by the first radial distance, D_{Rad,1}, and the second radial distance, D_{Rad,2}, being equal because, as discussed above with reference to FIG. 8, as the optical fiber 1804 is rotated, the emission face arc 844 may be formed. If the emission face measurement 905A and the emission face measurement 905B are both valid, then the first centroid 950A and the second centroid 950B should have x-y coordinates along the same emission face arc. As such, the first radial distance, D_{Rad,1}, and the second radial distance, D_{Rad,2}, should be the same or within a threshold, as a radius of a circle is constant. Thus, if the first radial distance, D_{Rad,1}, and the second radial distance, D_{Rad,2}, are not equal, then one or both of the emission face measurement 905A and the emission face measurement 905B may be invalid.

In a second example embodiment, the emission face measurement 905B may be validated via a different method. Turning now to FIG. 9B, a computational image 900B may be the same as the computational image 900A except that the emission face measurement 905B may be captured in a different orientation. In this example, the first radial distance, D_{Rad,1}, and the second radial distance, D_{Rad,2}, may be determined by determining a point 946 at which the first radial distance, D_{Rad,1}, and the second radial distance, D_{Rad,2}, are equal. If the point 946 is not the same as the optical center 940, then one or both of the emission face measurement 905A and the emission face measurement 905B may be an invalid measurement. To determine whether emission face measurement 905A and/or emission face measurement 905B is invalid, one or more emission face measurements may be taken and similarly validated.

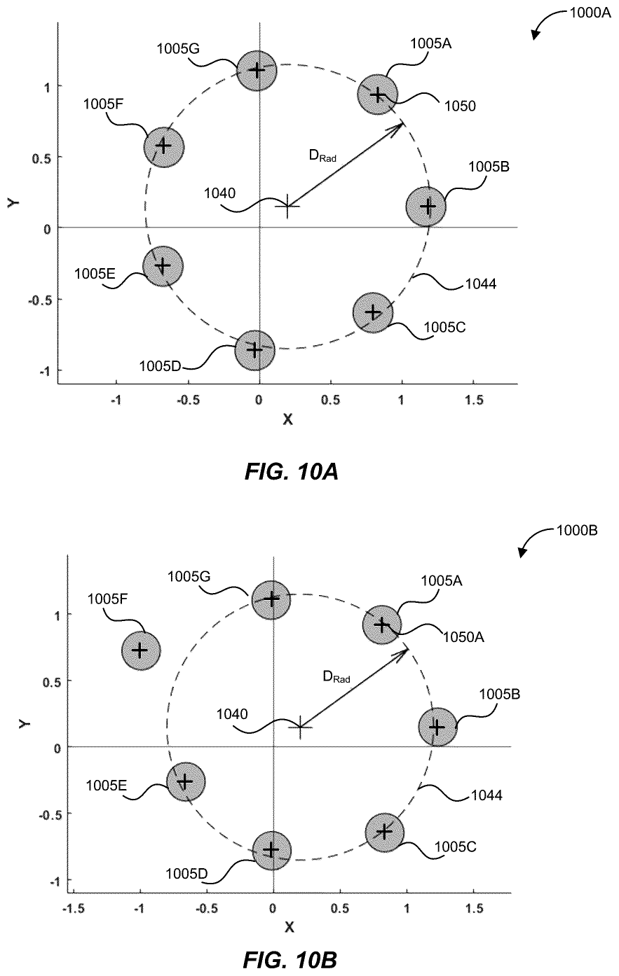

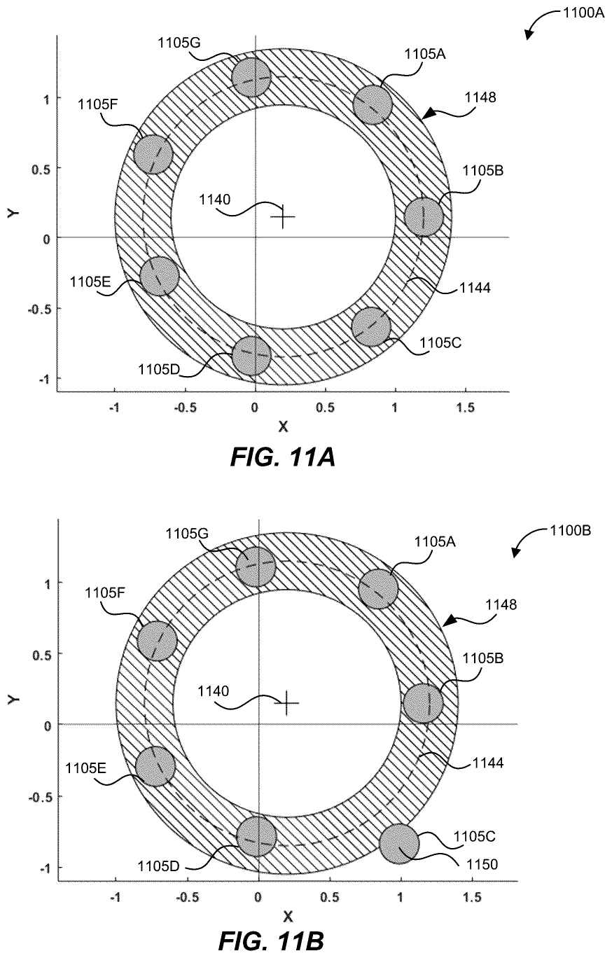

FIGS. 10A-10B provide diagrams illustrating computational images of multiple emission face measurements used to calculate a cleave angle based on one or more validity checks, according to an embodiment of the present invention. For ease of discussion, FIGS. 10A-10B are discussed with relation to FIGS. 6A-9B; however, it should be understood that any systems or techniques disclosed herein may be applicable.

FIG. 10A provides a computational image 1000A. The computational image 1000A may include emission face measurements 1005A-G. The emission face measurements 1005A-G may be measured based on the cleaved end 608 of the optical fiber 604 being in various positions as the optical fiber 604 is rotated about an optical axis (e.g., x-axis). As shown by centroid 1050A corresponding to emission face measurement 1005A, a centroid may be determined for each of the emission face measurements 1005A-G.

In the embodiments illustrated in FIGS. 10A and 10B, the cleave angle measurement technique may not require a calibration procedure to determine an optical center 1040. Instead, the optical center 1040 may be determined based on the emission face measurements 1005A-G.

For example, an emission face arc 1044 may be determined based on the centroids (e.g., centroid 1050A) for each of the emission face measurements 1005A-G. Then, the optical center 1040 may be determined as the center point of the emission face arc 1044.

Once the optical center 1040 is determined, a radial distance, D_{Rad}, may be determined for the emission face measurements 1005A-G. Using the radial distance, D_{Rad}, and the cleaved end distance, D_{End}, a cleave angle may be calculated for the optical fiber 604.

In some embodiments, one or more of the emission face measurements 1005A-G may not be valid. Turning now to FIG. 10B, a computational image 1000B is provided illustrating an embodiment including an invalid emission face measurement. An emission face measurement may be invalid for a variety of reasons, including noise in the cleave angle measurement system 600 or mis-positioning of the optical fiber 604 in the optical fiber channel 632. In an illustrative example, a piece of dust in the optical fiber channel 632 may cause the cleaved end 608 to be placed in an improper position during the rotation of the optical fiber 604. As such, the emission face measurement 1005F corresponding to the improper position of the cleaved end 608 may be an invalid measurement.

To identify emission face measurement 1005F as an invalid measurement, the emission face arc 1044 may be determined. The emission face arc 1044 may be determined by aligning the centroids of as many emission face measurements as feasible. In the illustrated example, the emission face arc 1044 is formed by emission face measurements 1005A-E and 1005G. In an example where the emission face measurement 1005C was also invalid, then the emission face arc 1044 may be determined by aligning the centroids of the emission face measurements 1005A-B, 1005D-E, and 1005G. Any invalid emission face measurements, such as the emission face measurement 1005F, may be discarded. In some embodiments, an invalid emission face measurement may indicate that the cleave angle measurement system 600 would benefit from cleaning or repositioning prior to other measurements.

In other embodiments, emission face measurements, and thereby the cleave angle measurements, may be verified against a threshold. Turning now to FIGS. 11A-11B, diagrams illustrating computational images of multiple emission face measurements used to calculate a cleave angle verified against a threshold according to an embodiment of the present invention are provided. For ease of discussion, FIGS. 11A-11B are discussed with relation to FIGS. 6A and 10A-10B; however, it should be understood that any systems or techniques disclosed herein may be applicable.

FIG. 11A provides a computational image 1100A. As shown, the computational image 1100A may include emission face measurements 1105A-G. The emission face measurements 1105A-G may be the same or similar to the emission face measurements 1005A-G. An emission face arc 1144 may be generated for the emission face measurements 1105A-G similar to the emission face arc 1044 as discussed above. Additionally, an optical center 1140 may be determined similar to the optical center 1040 as discussed above.

A threshold region 1148 may be determined for the emission face measurements 1105A-G. The threshold region 1148 may determine whether an emission face measurement within the emission face measurements 1105A-G is invalid or valid.

In some embodiments, the threshold region 1148 may be determined based on the D_{End} and the application requirements for cleave angle, θ_{c}. Once the threshold region 1148 is determined, the emission face measurements 1105A-G may be compared to the threshold region 1148 to determine validity or acceptability of the measurements.

FIG. 11B provides a computational image 1100B in which emission face measurement 1105C may be invalid. As shown, the emission face measurement 1105C falls outside of the threshold region 1148. In some embodiments, if any portion of the emission face measurement 1105C falls outside of the threshold region 1148, then emission face measurement 1105C may be invalid and may be discarded. In other embodiments, the emission face measurement 1105C may be determined to be invalid only if a centroid 1150 of the emission face measurement 1105C or the entirety of the emission face measurement 1105C falls outside of the threshold region 1148.

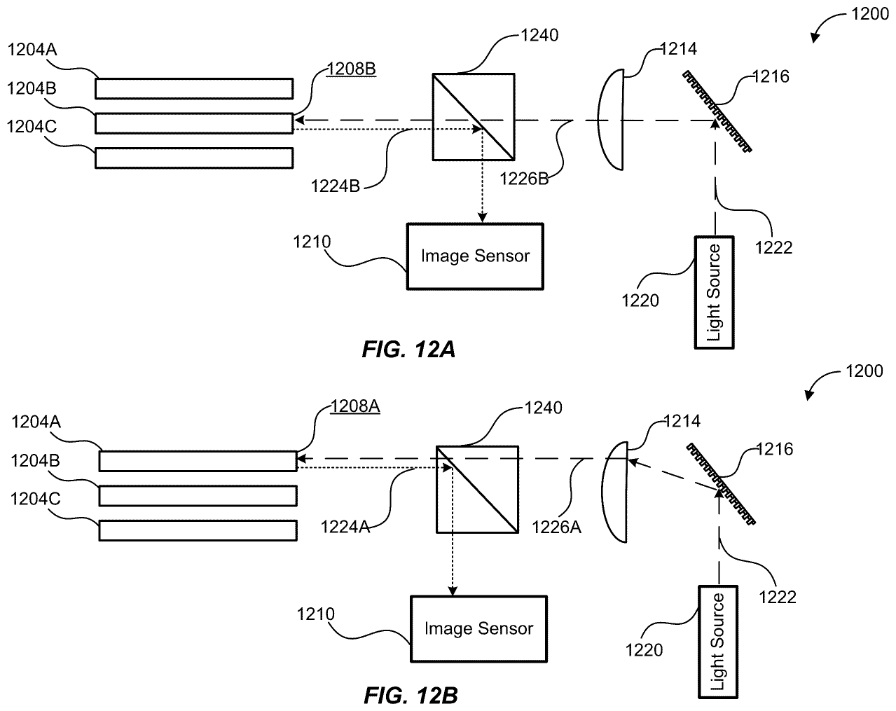

In some embodiments, the cleave angle measurement system and techniques provided herein may be used to measure cleave angles for a plurality of optical fibers. For example, a cleave angle may be measured for each optical fiber in a fiber array. Turning now to FIGS. 12A-B, schematic diagrams illustrating a cleave angle measurement system according to an embodiment of the present invention are provided. For ease of discussion, FIGS. 12A-B are discussed with relation to FIGS. 6A and 8; however, it should be understood that any systems or techniques disclosed herein may be applicable.

FIGS. 12A and 12B illustrate a cleave angle measurement system 1200. The cleave angle measurement system 1200 may be configured to measure a cleave angle for multiple optical fibers: i.e., first optical fiber 1204A, second optical fiber 1204B, and third optical fiber 1204C. In an example embodiment, the cleave angle measurement system 1200 may be used to measure a cleave angle for one or more optical fibers in a fiber array. In such an example, first optical fiber 1204A, second optical fiber 1204B, and third optical fiber 1204C may be part of a fiber array.

The cleave angle measurement system 1200 may include an image sensor 1210 and a light source 1220. The image sensor 1210 may be the same or similar to the image sensor 610, and the light source 1220 may be the same or similar to the light source 620. In some embodiments, the light source 1220 may be capable of wavelength modulation or may be a broadband light source. Similar to the light source 620, the light source 1220 may be configured to emit light beam 1222. The light beam 1222 may be directed to second cleaved end 1208B of the second optical fiber 1204B.

In some embodiments, the light beam 1222 with a second wavelength may be directed to the second cleaved end 1208B by one or more optical components. For example, as illustrated, the cleave angle measurement system 1200 may include a grating 1216 which directs a diffracted light beam 1226B at an angle based on wavelength. The grating 1216 may be positioned to produce diffracted light beam 1226B with a second wavelength from the light source 1220 directed toward the second cleaved end 1208B.

In some embodiments, a collecting lens 1214 may be positioned between the grating 1216 and the second cleaved end 1208B. The collecting lens 1214 may be configured to collect and direct the diffracted light beam 1226B from the grating 1216 to the second cleaved end 1208B. In some embodiments, the collecting lens 1214 may be configured to collimate the diffracted light beam 1226B after diffraction from the grating 1216. In other embodiments, the collecting lens 1214 may be configured to filter out one or more wavelength ranges from the light beam 1222 such that a specific wavelength of the light beam 1222 reaches the second cleaved end 1208B.

After the diffracted light beam 1226B reaches the second cleaved end 1208B, the diffracted light beam 1226B may be reflected off of the second cleaved end 1208B as reflected light 1224B. The reflected light 1224B may be directed to the image sensor 1210 by a beam splitter 1240. The beam splitter 1240 may be the same or similar to the beam splitter 640.

Similar to the cleave angle measurement system 1700, the cleave angle measurement system 1200 may measure a cleave angle of the second cleaved end 1208B by receiving the reflected light 1224B at the image sensor 1210. For example, the cleave angle measurement system 1200 may measure the cleave angle according to techniques discussed herein. For example, based on the reflected light 1224B received by the image sensor 1210, an emission face may be measured for the second cleaved end 1208B.

Since optical fibers within an array are often fixed in position, measuring a cleave angle of multiple fibers within an array may include modifying the transmission pathway of the light beam 1222. For example, turning now to FIG. 12B, an embodiment in which a cleave angle for the first optical fiber 1204A is measured is provided. Because first optical fiber 1204A, second optical fiber 1204B, and third optical fiber 1204C are fixed in place, to reflect light off of first cleaved end 1208A of the first optical fiber 1204A, the wavelength of the light beam 1222 may be modified.

To modify the transmission pathway of the light beam 1222 such that the light beam 1222 reflects off of first cleaved end 1208A, the light beam 1222 may be modified to have a first wavelength. Grating 1216 may produce diffracted light beam 1226A at a second angle based on the wavelength of light beam 1222. The collecting lens 1214 may be configured to collect and direct the diffracted light beam 1226A from the grating 1216 to the first cleaved end 1208A. For example, the collecting lens 1214 may position the diffracted light beam 1226A such that the diffracted light beam 1226A is transmitted to the first cleaved end 1208A.

After the diffracted light beam 1226A reaches the first cleaved end 1208A, the diffracted light beam 1226A may be reflected off of the first cleaved end 1208A as reflected light 1224A. The reflected light 1224A may be directed to the image sensor 1210 by a beam splitter 1240. The beam splitter 1240 may be the same or similar to the beam splitter 640.

Similar to the cleave angle measurement system 600, the cleave angle measurement system 1200 may measure a cleave angle of the first cleaved end 1208A by receiving the reflected light 1224A at the image sensor 1210. For example, the cleave angle measurement system 1200 may measure the cleave angle according to techniques discussed herein. For example, based on the reflected light 1224A received by the image sensor 1210, an emission face may be measured for the first cleaved end 1208A.

The collecting lens 1214 may be positioned to collect the diffracted light beam 1226A regardless of where the light beam 1222 contacts the grating 1216. Similarly, the beam splitter 1240 may be positioned so that the reflected light 1224A reflected from the first cleaved end 1208A is directed to the image sensor 1210. A cleave angle for the first cleaved end 1208A may be calculated based on an emission face measurement gathered from the reflected light 1224A received by the image sensor 1210, as disclosed herein.

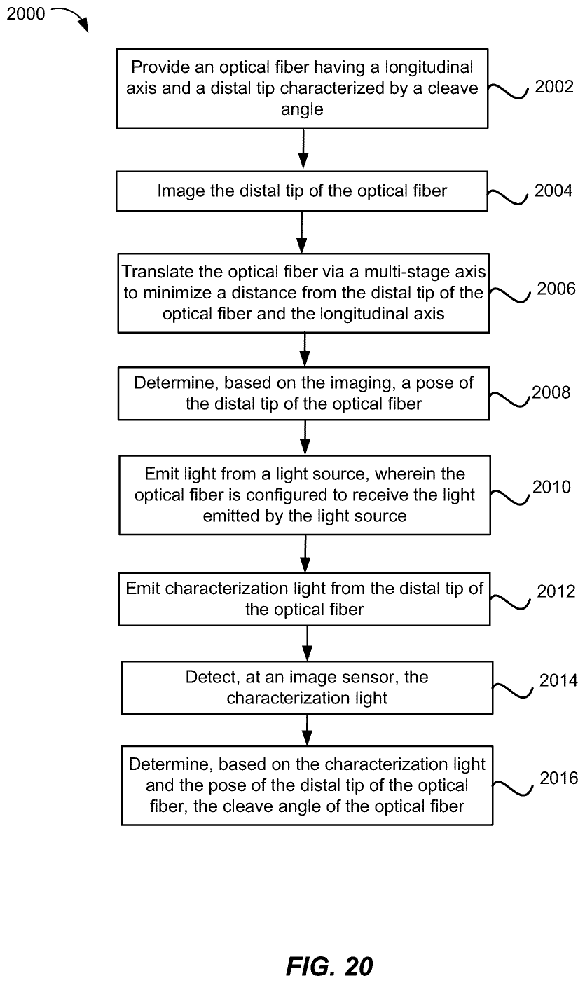

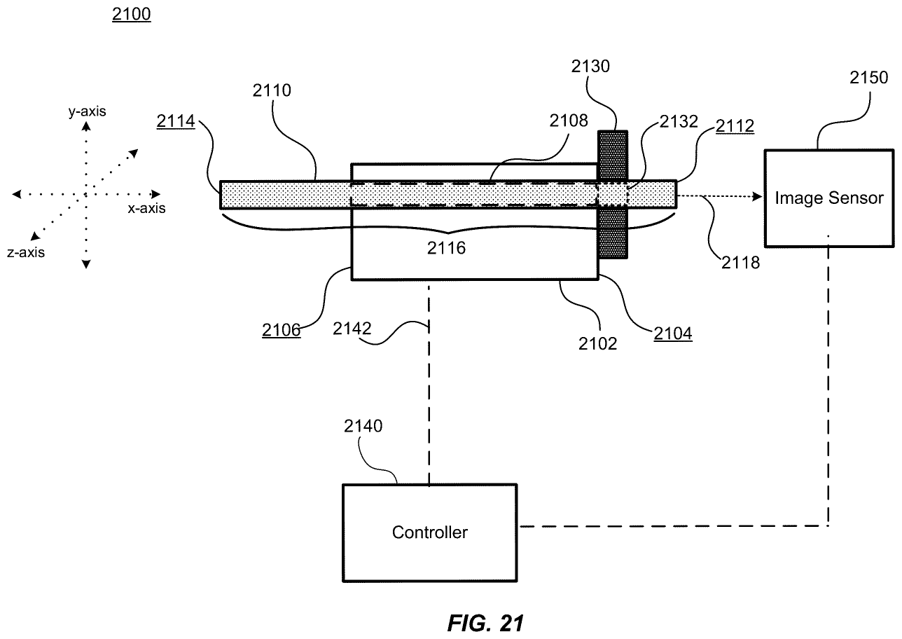

Since optical fibers in a fiber array are difficult to rotate, a calibration optical fiber may be used to calibrate the cleave angle measurement system 1200. For example, the cleave angle measurement system 1200 may be calibrated according to the techniques discussed above with reference to FIG. 20. Then, once the cleave angle measurement system 1200 is calibrated, a cleave angle for each of first optical fiber 1204A, second optical fiber 1204B, and third optical fiber 1204C may be measured without requiring rotation of each optical fiber.

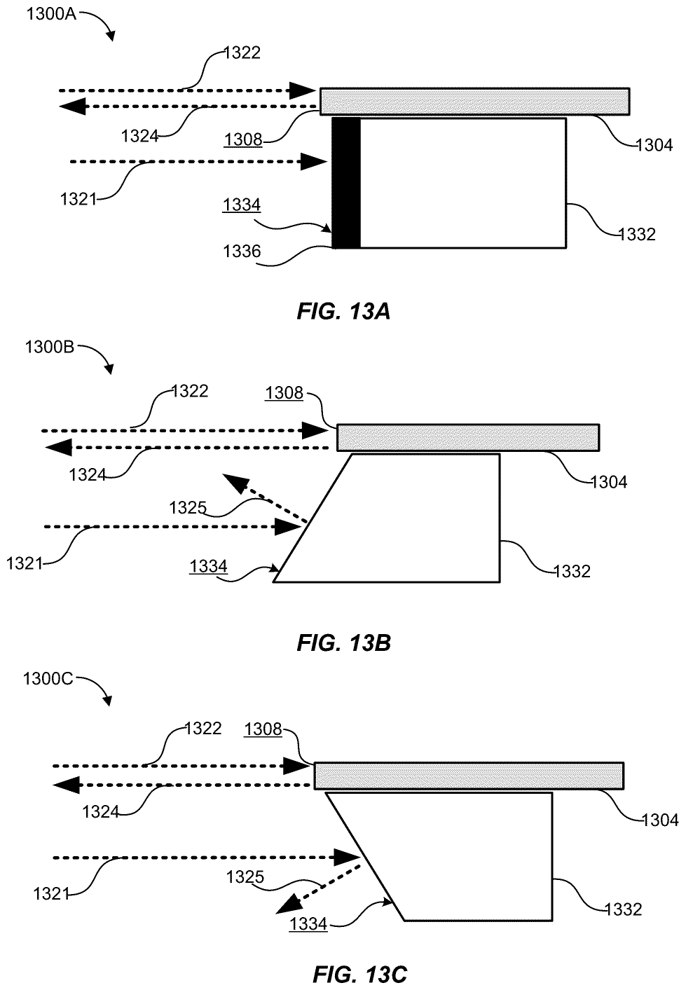

Turning now to FIGS. 13A-C, schematic diagrams illustrating various optical fiber channel arrangements according to an embodiment of the present invention are provided. For ease of discussion, FIGS. 13A-B are discussed with relation to FIG. 6; however, it should be understood that any systems or techniques disclosed herein may be applicable.

The light beam 1322 from a light source, for example, light source 620, may be reflected off of a cleaved end 1308 to determine the cleave angle of the optical fiber 1304. To increase the accuracy of the cleave angle measurement, it may be advantageous to reduce or minimize the amount of light beam 1322 that is reflected off of surfaces that are not the cleaved end 1308. FIGS. 13A-C provide various modifications that may be made to surface 1334 of the optical fiber channel 1332 to reduce or minimize reflection of the light beam 1322 off of non-cleaved end surfaces. The optical fiber channel 1332 may be the same or similar to the optical fiber channel 632. The light beam 1322 may be the same or similar to the light beam 622 in that the light beam 1322 may be emitted by a light source, such as the light source 620. Optical fiber 1304 may be disposed in the optical fiber channel 1332 such that a cleaved end 1308 is oriented to receive the light beam 1322 emitted from the light source. The optical fiber 1304 may be the same or similar to the optical fiber 604.

FIG. 13A illustrates an embodiment 1300A in which the surface 1334 of the optical fiber channel 1332 is blackened or otherwise darkened. For example, the surface 1334 may include a dark section 1336. The dark section 1336 may be light absorbing in order to absorb light beam 1321. The light beam 1321 may be a portion of the light beam 1322 that does not contact the cleaved end 1308 of the optical fiber 1304. To prevent the light beam 1321 from reflecting off of the surface 1334, the dark section 1336 may absorb the light beam 1321. In an example embodiment, the dark section 1336 may be a coating that is applied to the surface 1334.

In other embodiments, the surface 1334 may be angled to reflect the light beam 1321 at an angle that is different than the reflected light 1324. FIGS. 13B and 13C illustrate embodiments 1300B and 1300C in which the surface 1334 is angled in order to direct any reflected light 1325 from the light beam 1321 at an orientation that is different from the transmission angle of the reflected light 1324. By reflecting the light beam 1321 at a transmission angle that is different from the reflected light 1324, the reflected light 1325 may be directed away from an image sensor, such as the image sensor 1210, and thereby not received by the image sensor. Depending on the arrangement of the cleave angle measurement system, the surface 1334 may be angled in a first direction, as illustrated by the embodiment 1300B, or in a second direction, as illustrated by the embodiment 1300C.

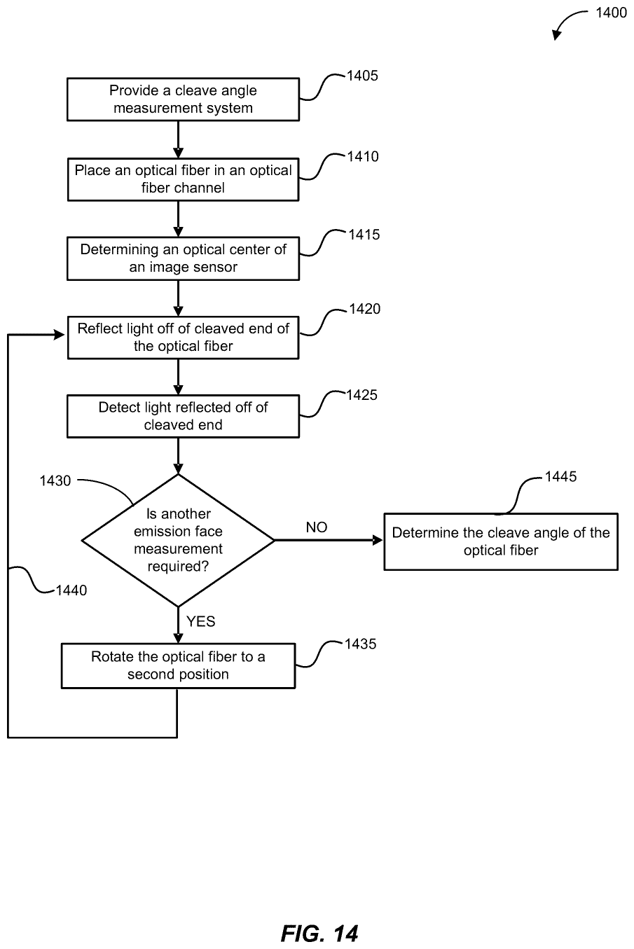

FIG. 14 is a simplified flowchart illustrating a method 1400 for measuring a cleave angle of an optical fiber using a cleave angle measurement system according to an embodiment of the present invention. Various embodiments of a method 1400 for measuring a cleave angle of an optical fiber using a cleave angle measurement system may be performed in an automated system such as system 100 shown in FIG. 1. For ease of discussion, FIG. 14 is discussed with reference to FIG. 6A, however, it should be understood that any systems and techniques described herein may be applied.

The method 1400 may include steps 1405 and 1410. At step 1405, a cleave angle measurement system 600 may be provided. The cleave angle measurement system 600 may include an optical fiber channel 632, an image sensor 610, and a light source 620. At step 1410, an optical fiber 604 may be placed into the optical fiber channel 632. The optical fiber 604 may include a cleaved end 608 and may be positioned such that the cleaved end 608 is in optical alignment with the light source 620. In some embodiments, the cleave angle measurement system 600 may also include a beam splitter 640. In such embodiments, the method 1400 may also include transmitting light from the light source 620 through the beam splitter 640, reflecting light off of the cleaved end 608 of the optical fiber 604, and reflecting, by the beam splitter 640, the light reflected off of the cleaved end 608 of the optical fiber 604 to the image sensor 610.

In still other embodiments, the cleave angle measurement system 600 may also include a beam collector 650. In such embodiments, the method 1400 may also include collecting, by the beam collector 650, stray light generated by the light reflecting off of the cleaved end 608 of the optical fiber 604.

In some embodiments, the method 1400 may also include, prior to placing the optical fiber 604 in the optical fiber channel 632, removing a jacket 603 from the cleaved end 608 of the optical fiber 604 to expose a fiber core/cladding 602 (e.g., the inner portion of the optical fiber with the coating removed) of the optical fiber 604. For example, a longitudinal length, L, of the fiber core/cladding 602 of the optical fiber 604 that is exposed may be between 5 and 20 mm. In such embodiments, the method 1400 may further include securing the fiber core/cladding 602 of the optical fiber 604 in the optical fiber channel 632.

The method 1400 may also include determining an optical center of an image sensor 610 at step 1415. The optical center of an image sensor 610 may be determined by a variety of techniques. For example, in some embodiments, determining an optical center of the image sensor 610 may include generating, based on the light detected by the image sensor 610, a first emission face measurement for the cleaved end 608 of the optical fiber 604 in a first position, computing a first optical centroid of the first emission face measurement, determining a first radial distance for the first emission face measurement of the optical fiber 604, and computing, based on the first radial distance, the cleave angle for the cleaved end 608 of the optical fiber 604. After determining the first optical centroid for the first emission face measurement in the first position, the method can include rotating the optical fiber 604 to a second position. Then, based on light reflected off of the cleaved end 608 of the optical fiber 604, a second emission face measurement for the optical fiber 604 in the second position may be generated and a second optical centroid of the second emission face measurement may be computed. In some embodiments, the optical fiber 604 may be further rotated to a third position, and based on light reflected off of the cleaved end 608 of the optical fiber 604, a third emission face measurement for the optical fiber 604 in the third position may be generated, and a third optical centroid of the third emission face measurement may be generated therefrom. The optical center of the image sensor 610 may be determined based on the first optical centroid, the second optical centroid, and the third optical centroid.

In other embodiments, the optical center of the image sensor 610 may be determined by a calibration technique. In such an embodiment, the method 1400 may include placing a calibration optical fiber in a first position in the optical fiber channel 632, where the calibration optical fiber comprises a cleaved end with a known cleave angle. The image sensor 610 may detect light reflected off of the cleaved end of the calibration optical fiber and a first emission face measurement for the calibration optical fiber in the first position may be generated based on the light detected by the image sensor 610. Then the calibration optical fiber may be rotated to a second position. In the second position, a second emission face measurement may be generated for the calibration optical fiber in the second position based on light reflected off of the cleaved end of the calibration optical fiber. The optical center of the image sensor 610 may be determined based on the first emission face measurement and the second emission face measurement. In embodiments involving the calibration technique, the step 1415 may be performed prior to steps 1405 and 1410.

The method 1400 may include steps 1420 and 1425. At step 1420, light may be reflected off of the cleaved end 608 of the optical fiber 604. The light may be provided by the light source 620. At step 1425, the image sensor 610 may detect the light reflected off of the cleaved end 608 of the optical fiber.

In some embodiments, the method 1400 may include step 1430 at which a determination of whether another emission face measurement is utilized. To determine whether another emission face measurement is utilized, an emission face measurement may be generated and a determination may be made whether the emission face measurement is valid. For example, the method 1400 may include generating, based on the light detected by the image sensor 610, a first emission face measurement for the cleaved end 608 of the optical fiber 604 in a first position, computing a first optical centroid of the first emission face measurement, and determining a first radial distance for the first emission face measurement of the optical fiber 604.

In some embodiments, the determination may be made that another emission face measurement is to be performed. In such embodiments, the method 1400 may continue to step 1435 and the optical fiber 604 may be rotated to a second position. After the optical fiber 604 is rotated to the second position, the method may return via iteration step 1440 to step 1420. For example, the method 1400 may include rotating the optical fiber 604 to the second position (step 1435) and then generating, based on light reflected off of the cleaved end 608 of the optical fiber 604, a second emission face measurement for the optical fiber 604 in the second position. A second optical centroid of the second emission face measurement may be computed and a determination may be made whether the first emission face measurement or the second emission face measurement are valid (step 1430).

Determining whether the first emission face measurement or the second emission face measurement are valid may include determining a circular radius based on the optical center, determining a second radial distance for the second emission face measurement based on the circular radius, and determining whether the second radial distance and the first radial distance align at the optical center. In other embodiments, determining whether the first emission face measurement or the second emission face measurement are valid may include determining whether the first emission face measurement is within a threshold and determining whether the second emission face measurement is within the threshold.

In other embodiments, the determination, based on the first radial distance and the first centroid, may be made that no other emission face measurement is to be performed. In such embodiments, the method 1400 may continue to step 1445. At step 1445, the method may include computing, based on the first radial distance, the cleave angle for the cleaved end 608 of the optical fiber 604. As noted above, the cleave angle measurement system provides for accurate cleave angle measurements with precision down to a 0.5 degree or less angle measurement.

It should be appreciated that the specific steps illustrated in FIG. 14 provide a particular method of measuring a cleave angle of an optical fiber using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize many variations, modifications, and alternatives.

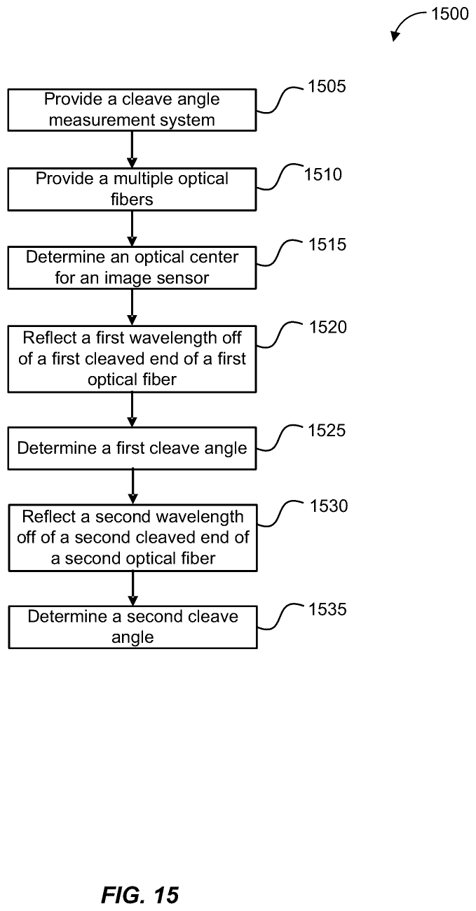

FIG. 15 is a simplified flowchart illustrating a method 1500 of measuring a cleave angle of a plurality of optical fibers using a cleave angle measurement system according to an embodiment of the present invention. Various embodiments of a method 1500 of measuring a cleave angle of a plurality of optical fibers using a cleave angle measurement system may be performed in an automated system such as system 100 shown in FIG. 1. For ease of discussion, FIG. 15 is discussed with reference to FIG. 12A-B; however, it should be understood that any systems and techniques described herein may be applied.

The method 1500 may include steps 1505 and 1510. At step 1505, the method 1500 may include providing a cleave angle measurement system 1200. The cleave angle measurement system 1200 may include a first optical fiber channel, a second optical fiber channel, an image sensor 1210, and a light source 1220. At step 1510, multiple optical fibers, e.g., first optical fiber 1204A, second optical fiber 1204B, and third optical fiber 1204C, may be provided. For example, the first optical fiber 1204A may be placed in the first optical fiber channel and the second optical fiber 1204B may be placed in the second optical fiber channel. In some embodiments, the first optical fiber 1204A, the second optical fiber 1204B, and the third optical fiber 1204C may be part of an optical fiber array.

Each of the first optical fiber 1204A, the second optical fiber 1204B, and the third optical fiber 1204C may include a cleaved end. For example, the first optical fiber 1204A may include a first cleaved end 1208A and the second optical fiber 1204B may include a second cleaved end 1208B. The first cleaved end 1208A and the second cleaved end 1208B may be positioned facing the light source 1220.

In some embodiments, the method 1500 may also include, prior to placing the first optical fiber 1204A in the first optical fiber channel, removing a coating from the first cleaved end 1208A of the first optical fiber 1204A to expose an inner portion of the first optical fiber 1204A. A coating may also be removed from the second cleaved end 1208B of the second optical fiber 1204B to expose an inner portion of the second optical fiber 1204B. For example, a longitudinal length, L, of the inner portion of the first optical fiber 1204A and the second optical fiber 1204B that is exposed may be between 5 mm and 20 mm. In such embodiments, the method 1500 may further include securing the first optical fiber 1204A and the second optical fiber 1204B by the respective inner portions.

In some embodiments, the cleave angle measurement system 1200 may also include a beam splitter 1240. In such embodiments, the method 1500 may also include transmitting the first wavelength and the second wavelength from the light source 1220 through the beam splitter 1240, reflecting the first wavelength off of the first cleaved end 1208A, reflecting the second wavelength off of the second cleaved end 1208B, and reflecting, by the beam splitter 1240, the first wavelength reflected off of the first cleaved end 1208A and the second wavelength reflected off of the second cleaved end 1208B to the image sensor 1210.

In still other embodiments, the cleave angle measurement system 1200 may also include a grating 1216. In such embodiments, the grating 1216 may be positioned to direct the first wavelength from the light source 1220 to the first cleaved end 1208A of the first optical fiber 1204A and direct the second wavelength from the light source 1220 to the second cleaved end 1208B of the second optical fiber 1204B.

In embodiments in which the cleave angle measurement system 1200 includes the grating 1216, the cleave angle measurement system 1200 may further include a collecting lens 1214 positioned between the grating 1216 and the beam splitter 1240. In such embodiments, the method 1500 may include transmitting a light beam from the light source 1220, where the light beam includes the first wavelength and the second wavelength, diffracting, by the grating 1216, the light beam 1222 such that the collecting lens 1214 selectively positions the diffracted light beam 1226B to transmit onto first cleaved end 1208A, and diffracting, by the grating 1216, the light beam 1222 such that the collecting lens 1214 selectively positions the diffracted light beam 1226A onto first cleaved end 1208A.

The method 1500 may include step 1515 at which an optical center for the image sensor 1210 may be determined. For example, the optical center for the image sensor 1210 may be determined by any of the methods or techniques described herein, such as those described with reference to FIG. 8.

The method 1500 may include step 1520. At step 1520, the method 1500 may include reflecting a first wavelength transmitted by the light source 1220 off of the first cleaved end 1208A of the first optical fiber 1204A. Then, at step 1525, the method 1500 may include determining, based on the first wavelength reflected off of the first cleaved end 1208A, a first cleave angle for the first cleaved end 1208A. For example, determining the first cleave angle for the first cleaved end 1208A may include detecting, by the image sensor 1210, the first wavelength reflected off of the first cleaved end of the first optical fiber; generating, based on the first wavelength detected by the image sensor 1210, a first emission face measurement for the first cleaved end 1208A of the first optical fiber 1204A in a first position; computing a first optical centroid of the first emission face measurement; determining a first radial distance for the first emission face measurement of the first optical fiber 1204A; and computing, based on the first radial distance, the first cleave angle. The first radial distance for the first emission face measurement may be based on the optical center of the image sensor 1210.

The method 1500 may also include steps 1530 and 1535. At step 1530, the method 1500 may include reflecting the second wavelength transmitted by the light source 1220 off of the second cleaved end 1208B of the second optical fiber 1204B. Then, at step 1535, the method 1500 may include determining, based on the second wavelength reflected off of the second cleaved end 1208B, a second cleave angle for the second cleaved end 1208B. In example embodiments, the first wavelength may be different from the second wavelength.

It should be appreciated that the specific steps illustrated in FIG. 15 provide a particular method of measuring a cleave angle of a plurality of optical fibers using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize many variations, modifications, and alternatives.

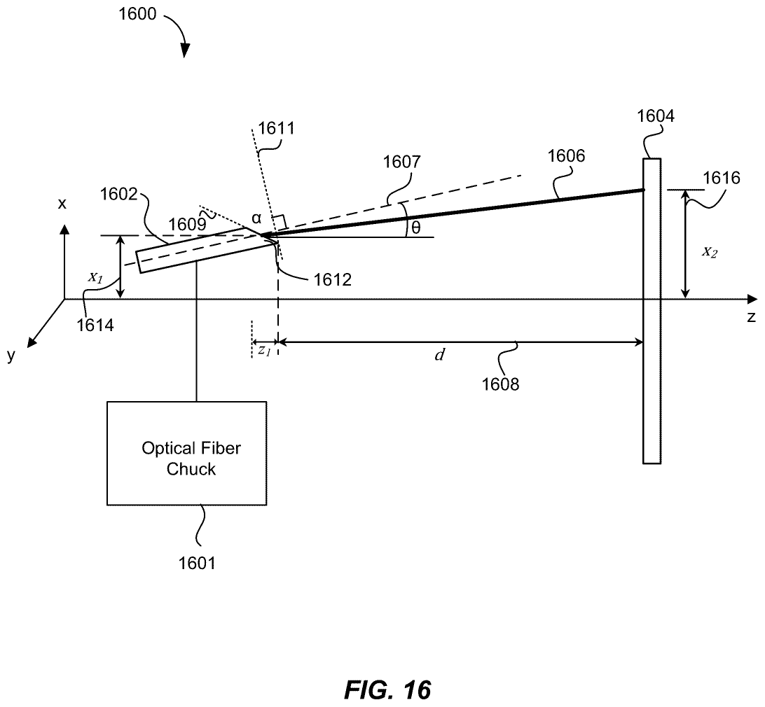

FIG. 16 is a simplified schematic diagram of a cleave angle measurement system, according to an embodiment of the present invention. Various embodiments of the cleave angle measurement system may be used in an automated system such as system 100 shown in FIG. 1.

A cleave angle measurement system 1600 includes an optical fiber chuck 1601 that is configured to support an optical fiber 1602 and an image sensor 1604 that is configured to detect characterization light 1606 emitted from the optical fiber 1602. Various distances with respect to the optical fiber 1602 are measured as part of the cleave angle measure system 1600. Distance d 1608 refers to a distance measured along the z-axis between the distal tip 1612 of the optical fiber 1602 and the image sensor 1604.

A first distance x₁ 1614 refers to a distance measured along the x-axis between the distal tip 1612 of the optical fiber 1602 and the z-axis. A second distance x₂ 1616 refers to a distance along the x-axis between a point where the characterization light 1606 meets the image sensor 1604 and the z-axis. Angle θ is the angle between the direction of propagation of the characterization light 1606 and the z-axis. First distance x₁ 1614 and angle θ may be measured by one or more cameras, not shown. The second distance x₂ 1616 may be measured by the image sensor 1604. As shown, the optical fiber 1602 is displaced from (e.g., tilted with respect to) the z-axis. In various embodiments, the optical fiber 1602 is substantially aligned with the z-axis such that a longitudinal axis 1607 of the optical fiber 1602 is parallel to the z-axis. A cleave angle α is measured from a first axis 1609 defined by the cleaved, distal tip 1612 to a second axis 1611 that is perpendicular to the longitudinal axis 1607.

According to various embodiments of the present disclosure, indices of refraction may be assumed (e.g., known) and the position(s) of the camera(s) are predefined. For example, the index of refraction corresponding to the optical fiber 1602 that is used for one or more computations described throughout the present disclosure can be the effective index of the optical fiber cladding, n₁ and/or the index of refraction of the core of the optical fiber 1602 (i.e., the core index), n₂. Furthermore, a distance d 1608 referring to a distance measured along the z-axis between the distal tip of the optical fiber and the image sensor 1604 (e.g., position sensing device) is known.

In some embodiments, a second distance x₂ 1616 may be calculated as follows:

$${x}_{2} = {x}_{1} + d ( θ + ( \frac{{n}_{2}}{{n}_{1}} - 1 ) α )$$

Accordingly, the cleave angle α may be calculated as follows:

$$α = \frac{{x}_{2} - {x}_{1} - θ d}{( \frac{{n}_{2}}{{n}_{1}} - 1 ) d}$$

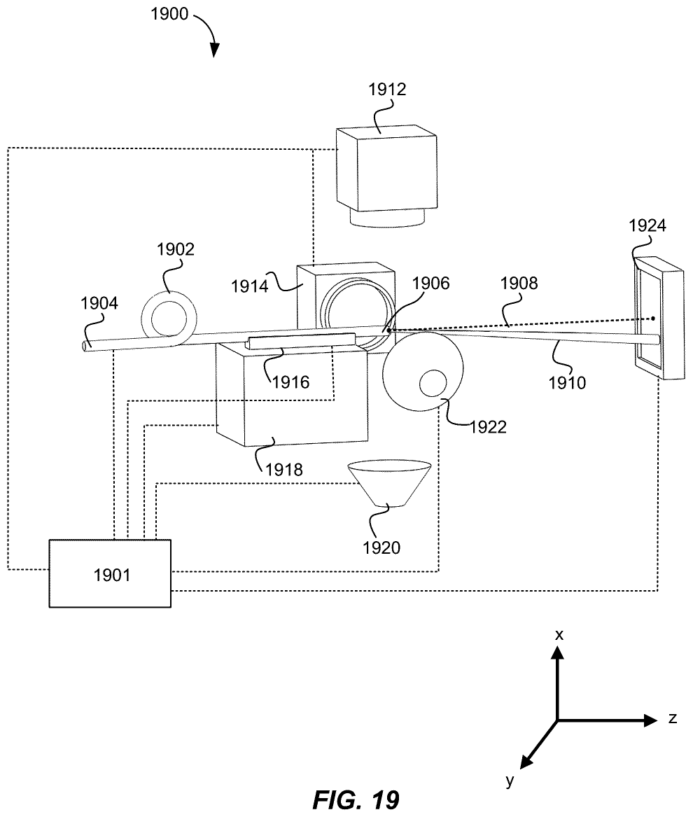

Static and active methods of cleave angle measurements using the systems described herein include embodiments described in detail below. A static method does not include a multi-axis stage (such as multi-axis stage 1918 described with respect to FIG. 19 and FIG. 20). The static method provides a lower cost solution and reduces system complexity by eliminating components that will require maintenance or be sources of failure. The active method, including a multi-axis stage (such as multi-axis stage 1918 described with respect to FIG. 19 and FIG. 20), may yield improved accuracy. For example, higher magnification cameras will have reduced depth of focus. An optical fiber located slightly out of the plane may provide an additional source of error since the position is less well known. Having a multi-axis stage and moving the optical fiber into a well-behaved region improves accuracy of optical measurements.

According to at least some embodiments, the position of one or more cameras are predefined, the position sensing device origin is predefined, a distance d referring to a distance along the z-axis between the distal tip of the optical fiber and the image sensor (e.g., position sensing device) is known, and the indices of refraction (n₁ and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging. Similarly, a distance z₁ referring to a distance along the z-axis accounting for error in nominal distance d is determined from the imaging.

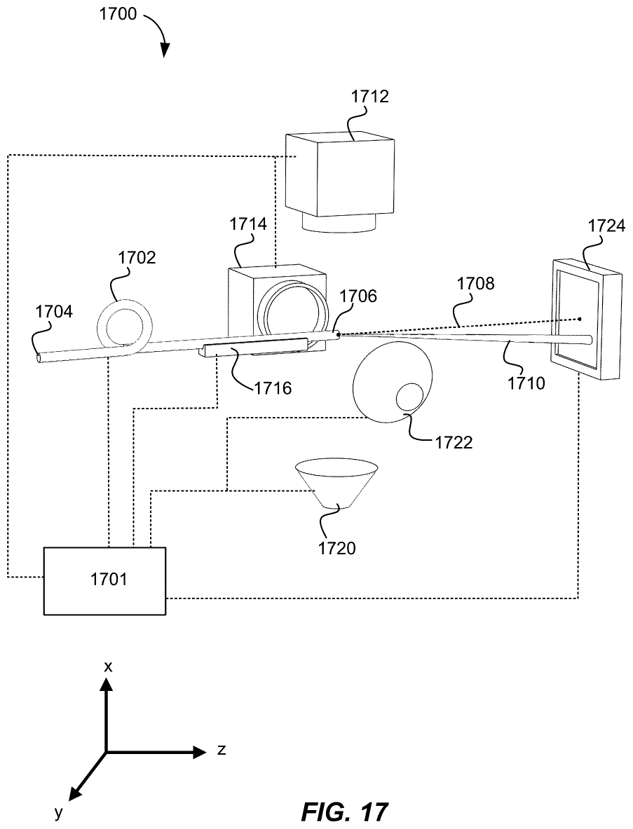

FIG. 17 is a simplified perspective view of a cleave angle measurement system, according to an embodiment of the present invention. Various embodiments of the cleave angle measurement system may be used in an automated system such as system 100 shown in FIG. 1. The cleave angle measurement system 1700 may be used to perform at least some embodiments of the static method described herein. The cleave angle measurement system 1700 includes an optical fiber chuck 1716 configured to receive an optical fiber 1702 having a proximal tip 1704, a distal tip 1706, and a nominal optical axis 1708. A light source (not shown) may be provided proximal to the proximal tip 1704 of the optical fiber 1702 and the light source may be configured to emit light. For example, the light source may be a laser coupled into the optical fiber 1702 at the proximal tip 1704 such that light emitted from the light source passes through the optical fiber 1702 toward the distal tip 1706. Thus, the optical fiber 1702 is configured to receive light emitted by the light source at the proximal tip 1704 of the optical fiber 1702 and emit characterization light 1710 from the distal tip 1706 of the optical fiber 1702.

In various embodiments, the cleave angle measurement system 1700 includes one or more cameras that are focused on and measure the position and orientation (i.e., the pose) of the distal tip 1706 of the optical fiber 1702. The cleave angle measurement system 1700 includes a pair of cameras for detecting and/or measuring the pose of the distal tip 1706 of the optical fiber 1702. The pose of the distal tip 1706 of the optical fiber 1702 as referred to throughout the present disclosure includes the six degrees of freedom (DOF) pose of the optical fiber 1702, specifically, the distal tip 1706 of the optical fiber 1702. In particular, the pose of the optical fiber 1702 refers to the six mechanical degrees of freedom of movement of a rigid body (e.g., the optical fiber 1702) in three-dimensional space including forward/backward (surge), up/down (heave), left/right (sway) translation in three perpendicular axes, combined with changes in orientation through rotation about three perpendicular axes, often termed yaw (normal axis), pitch (transverse axis), and roll (longitudinal axis). For example, the pose of the distal tip 1706 of the optical fiber 1702 includes a position and angle in the direction of each of the x-axis and the y-axis. According to any of the embodiments described herein, a position may be detected, measured, determined, reported, etc., as a coordinate pair (e.g., (x, y)) or as a coordinate trio (e.g., (x, y, z)), as would be appreciated by a person having ordinary skill in the art upon reading the present disclosure.

As shown, the cleave angle measurement system 1700 includes a first camera 1712 facing toward the optical fiber 1702. In some embodiments, the first camera 1712 is positioned at a higher x-position along the x-axis than the x-position of the optical fiber 1702 such that the first camera 1712 is positioned above and aligned with the optical fiber 1702. Furthermore, the first camera 1712 may be positioned facing downward and toward the optical fiber 1702. The first camera 1712 is configured to measure a first position of the distal tip 1706 of the optical fiber 1702 and a first angle corresponding to the nominal optical axis 1708 (e.g., the longitudinal axis) of the optical fiber 1702. In this particular configuration, the nominal optical axis 1708 of the optical fiber 1702 is aligned with the z-axis and the nominal optical axis 1708 may be interchangeably referred to as the longitudinal axis. In other configurations, the nominal optical axis 1708 of the optical fiber 1702 is tilted relative to the z-axis and an angle θ is measured between the nominal optical axis 1708 of the optical fiber 1702 and the z-axis, such as the angle θ described with respect to FIG. 16. In various embodiments, the first camera 1712 is disposed in a plane orthogonal to the nominal optical axis 1708 of the optical fiber 1702 (in this configuration, the longitudinal axis, or the z-axis).

The cleave angle measurement system 1700 further includes a second camera 1714 facing toward the optical fiber 1702. In some embodiments, the second camera 1714 is positioned at an x-position equal to or close to the x-position of the optical fiber 1702 such that the second camera 1714 is aligned with the distal tip 1706 of the optical fiber 1702. The second camera 1714 is configured to measure a second position of the distal tip 1706 of the optical fiber 1702 and a second angle corresponding to the nominal optical axis 1708 of the optical fiber 1702. The second camera 1714 is disposed in the plane orthogonal to the nominal optical axis 1708 of the optical fiber 1702 (in this configuration, the longitudinal axis, or the z-axis). For example, in at least some embodiments, the first camera 1712 and the second camera 1714 are disposed along directions that are orthogonal to the longitudinal axis and the first camera 1712 is disposed along a direction that is orthogonal to the direction along which the second camera 1714 is disposed.

In various embodiments, each of the first camera 1712 and the second camera 1714 detect (e.g., measure) the pose of the distal tip 1706 of the optical fiber 1702 and report the measurements associated with the pose to be used for cleave angle computation, to be described in detail below.

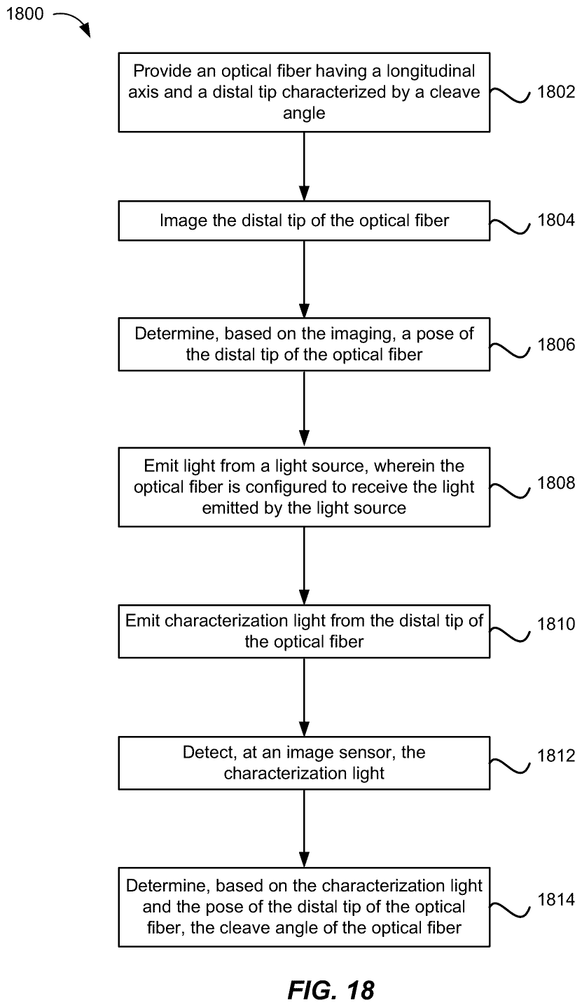

In various embodiments, cleave angle measurement system 1700 includes one or more processors 1701 to perform the various aspects of the methods described herein. The one or more processors 1701 cause various components of cleave angle measurement system 1700 to perform one or more functions. For example, the one or more processors 1701 are adapted to cause the first camera 1712 and the second camera 1714 to image the distal tip 1706 of the optical fiber 1702. Furthermore, the one or more processors 1701 perform various operations including determining, based on the imaging, a pose of the distal tip 1706 of the optical fiber 1702 and determining, based on the characterization light 1710 and the pose of the distal tip 1706 of the optical fiber 1702, the cleave angle of the optical fiber 1702, to be described in further detail below with respect to FIG. 18 and method 1800.

The cleave angle measurement system 1700 may include an optical fiber chuck 1716 configured to support the optical fiber 1702. In some embodiments, the optical fiber chuck 1716 may include a mechanical clamp, a vacuum clamp, or any other clamping mechanism known in the art. In some embodiments, the optical fiber chuck 1716 is configured to align the nominal optical axis 1708 of the optical fiber 1702 with the longitudinal axis (e.g., the z-axis) such as in the configuration shown in FIG. 17. In some embodiments, the optical fiber chuck 1716 is configured to translate along the z-axis and thus translates the optical fiber 1702 along the z-axis as it is supported by the optical fiber chuck 1716. For example, the optical fiber chuck 1716 and/or the optical fiber 1702 may be displaced along the z-axis so that the optical fiber chuck 1716 and/or the optical fiber 1702 can be positioned at different z-positions along the z-axis.

The cleave angle measurement system 1700 may further include one or more backlights to illuminate the distal tip 1706 of the optical fiber 1702. In other embodiments, reflective illumination may be used to illuminate the distal tip 1706 of the optical fiber 1702. In the embodiment illustrated in FIG. 17, the cleave angle measurement system 1700 includes a first backlight 1720 disposed opposite the first camera 1712. The first backlight 1720 is operable to illuminate at least the distal tip 1706 of the optical fiber 1702. The cleave angle measurement system 1700 may also include a second backlight 1722 disposed opposite the second camera 1714. The second backlight 1722 is operable to illuminate at least the distal tip 1706 of the optical fiber 1702. In various embodiments, the first backlight 1720 is disposed in a plane orthogonal to a plane in which the second backlight 1722 is disposed. In further embodiments, the first camera 1712, the first backlight 1720, the second backlight 1722, and the second camera 1714 may each be disposed in a direction that is orthogonal to each other and the first camera 1712, the first backlight 1720, the second backlight 1722, and the second camera 1714 may each be located in a direction that is orthogonal to the z-axis (e.g., the longitudinal axis, in this case, the nominal optical axis 1708 of the optical fiber 1702). In other embodiments, other configurations of the first camera 1712, the first backlight 1720, the second backlight 1722, and the second camera 1714 may be used as would be understood by one having ordinary skill in the art upon reading the present disclosure.

The cleave angle measurement system 1700 further includes a position sensing device 1724 that is operable to measure the characterization light 1710 emitted from the distal tip 1706 of the optical fiber 1702. The position sensing device 1724 may be a camera, a quadrant photodiode, an image sensor, etc. The characterization light 1710 emitted from the distal tip 1706 of the optical fiber 1702 is emitted onto the receiving surface of the position sensing device 1724. The detected (e.g., measured) position of the characterization light 1710 on the position sensing device 1724 is reported and used for cleave angle computation, to be described in detail below.

FIG. 18 is a simplified flowchart illustrating a method for measuring a cleave angle of an optical fiber using a cleave angle measurement system according to an embodiment of the present invention. Various embodiments of the method for measuring a cleave angle of an optical fiber using cleave angle measurement system may be used in an automated system such as system 100 shown in FIG. 1. The method 1800 includes providing an optical fiber having a longitudinal axis and a distal tip characterized by a cleave angle (1802). The cleaved end of an optical fiber may be an end of the optical fiber having a cleave or cut that is perpendicular to the longitudinal length of the optical fiber. The cleave angle is a reference to how perpendicular the cleaved end of the optical fiber is to the optical axis of the fiber. Typically, the optical axis of the optical fiber is along the longitudinal length of the optical fiber, and thus the cleave angle may be the degree to which the cleaved end is perpendicular to the length of the optical fiber, as described in detail above.

The method also includes imaging the distal tip of the optical fiber (1804). In various embodiments, imaging is performed by a first camera and a second camera. For example, the first camera can face toward the optical fiber and may be positioned at a higher x-position on an x-axis including the optical fiber such that the first camera is above and aligned with the optical fiber. Furthermore, the first camera may be positioned facing downward and toward the optical fiber to image the distal tip of the optical fiber. A second camera can face toward the optical fiber. In some embodiments, the second camera is positioned at or near the x-position of the optical fiber on an x-axis including the optical fiber such that the second camera is aligned with the distal tip of the optical fiber. The first camera and the second camera may each be disposed in a direction that is orthogonal to the longitudinal axis. In at least some embodiments, the first camera may be disposed in a direction that is orthogonal to a direction that the second camera is disposed.

The method further includes determining, based on the imaging, a pose of the distal tip of the optical fiber (1806). The pose of the distal tip of the optical fiber includes at least a position and angle of the distal tip. For example, the first camera detects (e.g., measures) a first position of the distal tip and a first angle corresponding to the longitudinal axis and the second camera detects (e.g., measures) a second position of the distal tip and a second angle corresponding to the longitudinal axis. In various embodiments, the pose of the distal tip of the optical fiber includes measurements associated with each of the six degrees of freedom of the optical fiber.

According to at least some embodiments of the static method, the position of one or more cameras are predefined, the position sensing device origin is predefined, a distance d referring to a distance along the z-axis between the distal tip of the optical fiber and the image sensor (e.g., position sensing device) is known, and the indices of refraction (mi and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging. Similarly, a distance z₁ referring to a distance along the z-axis accounting for error in nominal distance d is determined from the imaging.

In at least some embodiments, determining the pose of the distal tip of the optical fiber includes translating the optical fiber chuck and the optical fiber along the longitudinal axis. Translating the optical fiber chuck and the optical fiber along the longitudinal axis includes displacing the optical fiber along the longitudinal axis. In some embodiments, a multi-axis stage may be used to translate the optical fiber chuck and the optical fiber along the longitudinal axis (e.g., the z-axis) and along the x-axis.

The method further includes emitting light from a light source (1808). A light source may be provided proximal to the proximal tip of the optical fiber and the light source may be configured to emit light. For example, the light source may be a laser coupled into the optical fiber from the proximal tip such that light emitted from the light source passes through the optical fiber toward the distal tip. The optical fiber is configured to receive the light emitted by the light source. The light passes through the longitudinal length of the optical fiber. The method further includes emitting characterization light from the distal tip of the optical fiber (1810).

In various embodiments, method 1800 may optionally include illuminating the distal tip via a first backlight disposed opposite the first camera and a second backlight disposed opposite the second camera. Reflection illumination methods may be used, according to at least some embodiments.

The method also includes detecting, at an image sensor, the characterization light (1812). The image sensor may be a camera or a quadrant photodiode, according to various embodiments. Detecting, at the image sensor, the characterization light includes determining a position of the characterization light. The characterization light emitted from the distal tip of the optical fiber is emitted onto the receiving surface of the image sensor. The detected (e.g., measured) position of the characterization light on the image sensor may be reported with measurements from the first camera and the second camera.

The method further includes determining, based on the characterization light and the pose of the distal tip of optical fiber, the cleave angle of the optical fiber (1814). According to various embodiments of the present disclosure, indices of refraction may be assumed (e.g., known) and the position(s) of the camera(s) are predefined. For example, the index of refraction including the effective index and/or the core index may be assumed for one or more computations described throughout the present disclosure. Furthermore, a distance d referring to a distance along the z-axis between the distal tip of the optical fiber and the image sensor (e.g., position sensing device) is known.

Light may be passed through the optical fiber and measured by the position sensing device with respect to the position of the first camera and the second camera. The cleave angle with respect to the x-direction ax may be calculated based on the following equation:

$${α}_{x} = \frac{{x}_{2} - {x}_{1} - ( d + {z}_{1} ) θ}{( \frac{{n}_{2}}{{n}_{1}} - 1 ) ( d + {z}_{1} )} .$$

The foregoing steps are repeated to solve for the cleave angle with respect to the y-direction ay based on the following equation:

$${α}_{y} = \frac{{y}_{2} - {y}_{1} - ( d + {z}_{1} ) θ}{( \frac{{n}_{2}}{{n}_{1}} - 1 ) ( d + {z}_{1} )} .$$

The cleave angle α is determined by the following equation: α=\sqrt{αₓ²+α_{y}²}.

It should be appreciated that the specific steps illustrated in FIG. 18 provide a particular method of measuring a cleave angle of an optical fiber using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 18 may include multiple sub-steps that may be performed in various sequences as appropriate to the individual step. Furthermore, additional steps may be added or removed depending on the particular applications. One of ordinary skill in the art would recognize many variations, modifications, and alternatives.

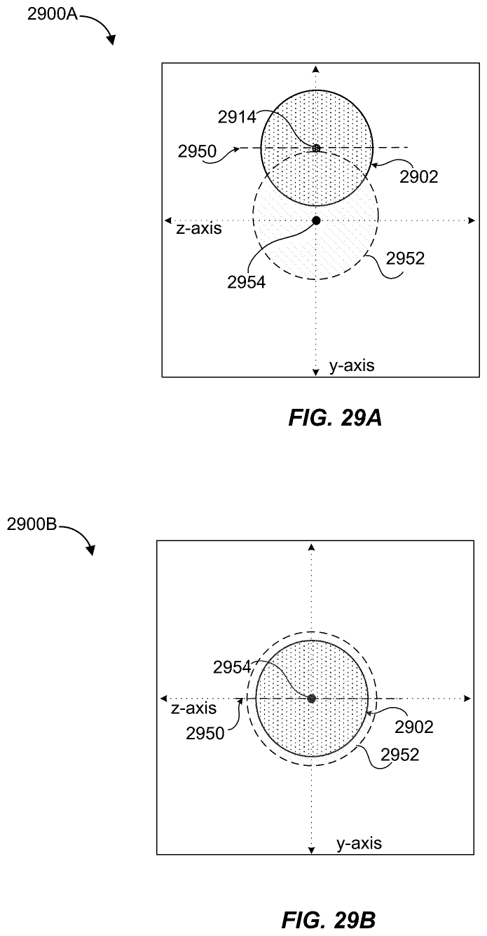

FIG. 19 is a simplified perspective view of a cleave angle measurement system, according to another embodiment of the present invention. Various embodiments of the cleave angle measurement system may be used in an automated system such as system 100 shown in FIG. 1. FIG. 19 includes similar components as those shown and described with respect to FIG. 20. Accordingly, similar numbering may be used to describe components having similar configurations and/or functions and the description provided in relation to FIG. 29 is applicable to the elements illustrated in FIG. 19 as appropriate.

The cleave angle measurement system 1900 includes an optical fiber chuck 1916 configured to receive an optical fiber 1902 having a proximal tip 1904, a distal tip 1906, and a nominal optical axis 1908. A light source (not shown) may be provided proximal to the proximal tip 1904 of the optical fiber and the light source may be configured to emit light. For example, the light source may be a laser coupled into the optical fiber 1902 from the proximal tip 1904 such that light emitted from the light source passes through the optical fiber 1902 toward the distal tip 1906. The optical fiber 1902 is configured to receive light emitted by the light source at the proximal tip 1904 of the optical fiber 1902 and emit characterization light 1910 from the distal tip 1906 of the optical fiber 1902.

In various embodiments, the cleave angle measurement system 1900 includes one or more cameras that are focused onto the pose of the distal tip 1906 of the optical fiber 1902. The cleave angle measurement system 1900 includes a pair of cameras for detecting and/or measuring the pose of the distal tip 1906 of the optical fiber 1902. The pose of the distal tip 1906 of the optical fiber 1902 as referred to throughout the present disclosure includes six degrees of freedom (DOF) of the optical fiber 1902. In particular, the pose of the optical fiber 1902 refers to the six mechanical degrees of freedom of movement of a rigid body (e.g., the optical fiber 1902) in three-dimensional space including forward/backward (surge), up/down (heave), left/right (sway) translation in three perpendicular axes, combined with changes in orientation through rotation about three perpendicular axes, often termed yaw (normal axis), pitch (transverse axis), and roll (longitudinal axis). For example, the pose of the optical fiber 1902 includes a position and angle in the direction of each of the x-axis and the z-axis.

As shown, the cleave angle measurement system 1900 includes a first camera 1912 facing toward the optical fiber 1902. In some embodiments, the first camera 1912 is positioned at a higher x-position on an x-axis including the optical fiber 1902 such that the first camera 1912 is above and aligned with the optical fiber 1902. Furthermore, the first camera 1912 may be positioned facing downward and toward the optical fiber 1902. The first camera 1912 is configured to measure a first position of the distal tip 1906 of the optical fiber 1902 and a first angle corresponding to the nominal optical axis 1908 (e.g., the longitudinal axis) of the optical fiber 1902. In this particular configuration, the nominal optical axis 1908 of the optical fiber 1902 is aligned with the z-axis and the nominal optical axis 1908 may be interchangeably referred to as the longitudinal axis. In other configurations the nominal optical axis 1908 of the optical fiber 1902 is tilted relative to the z-axis and an angle θ is measured between the nominal optical axis 1908 of the optical fiber 1902 and the z-axis, such as the angle θ described with respect to FIG. 16. In various embodiments, the first camera 1912 is disposed in a plane orthogonal to the nominal optical axis 1908 of the optical fiber 1902 (in this configuration, the longitudinal axis, or the z-axis).

The cleave angle measurement system 1900 further includes a second camera 1914 facing toward the optical fiber 1902. In some embodiments, the second camera 1914 is positioned at or near the x-position of the optical fiber 1902 and on the x-axis including the optical fiber 1902 such that the second camera 1914 is aligned with the optical fiber 1902. The second camera 1914 configured to measure a second position of the distal tip 1906 of the optical fiber 1902 and a second angle corresponding to the nominal optical axis 1908 of the optical fiber 1902. The second camera 1914 is disposed in the plane orthogonal to the nominal optical axis 1908 of the optical fiber 1902 (in this configuration, the longitudinal axis, or the z-axis). For example, in at least some embodiments, the first camera 1912 and the second camera 1914 are disposed along directions that are orthogonal to the longitudinal axis and the first camera 1912 is disposed along a direction that is orthogonal to the direction along which the second camera 1914 is disposed.

In various embodiments, each of the first camera 1912 and the second camera 1914 detect (e.g., measure) the pose of the distal tip 1906 of the optical fiber 1902 and report the measurements associated with the pose to be used for cleave angle computation, to be described in detail below.

The cleave angle measurement system 1900 may include an optical fiber chuck 1916 configured to support the optical fiber 1902. In some embodiments, the optical fiber chuck 1916 may include a mechanical clamp, a vacuum clamp, or any other clamping mechanism known in the art. In some embodiments, the optical fiber chuck 1916 is configured to align the nominal optical axis 1908 of the optical fiber 1902 with the longitudinal axis (e.g., the z-axis) such as in the configuration shown in FIG. 19. In some embodiments, the optical fiber chuck 1916 is configured to translate along the z-axis and further translate the optical fiber 1902 the optical fiber chuck 1916 supports along the z-axis. For example, the optical fiber chuck 1916 and/or the optical fiber 1902 may be displaced to different z-positions along the z-axis.

In various embodiments, FIG. 19 illustrates an “active” method of cleave angle measurement. For example, cleave angle measurement system 1900 includes a multi-axis stage 1918. The multi-axis stage 1918 is coupled to the optical fiber chuck 1916 and/or the optical fiber 1902 such that the optical fiber chuck 1916 and/or the optical fiber 1902 may be translated in both a direction oriented along the x-axis and a direction oriented along the z-axis. Accordingly, incremental changes in pose of the distal tip 1906 of the optical fiber 1902 (e.g., at least the position and angle in the x-direction and the y-direction) may be detected (e.g., measured) and reported by the first camera 1912, the second camera 1914, and the position sensing device 1924.

In various embodiments, cleave angle measurement system 1900 includes one or more processors 1901 to perform the various aspects of the methods described herein. The one or more processors 1901 cause various components of cleave angle measurement system 1900 to perform one or more functions. For example, the one or more processors 1901 are adapted to cause the first camera 1912 and the second camera 1914 to image the distal tip 1906 of the optical fiber 1902. Furthermore, the one or more processors 1901 perform various operations including determining, based on the imaging, a pose of the distal tip 1906 of the optical fiber 1902 and determining, based on the characterization light 1910 and the pose of the distal tip 1906 of the optical fiber 1902, the cleave angle of the optical fiber 1902, to be described in further detail below with respect to FIG. 20 and method 2000.

The cleave angle measurement system 1900 may further include one or more backlights to illuminate the distal tip 1906 of the optical fiber 1902. In some embodiments, reflective illumination may be used to illuminate the distal tip 1906 of the optical fiber 1902. In some embodiments, the cleave angle measurement system 1900 includes a first backlight 1920 disposed opposite the first camera 1912. The first backlight 1920 is operable to illuminate at least the distal tip 1906 of the optical fiber 1902. The cleave angle measurement system 1900 may also include a second backlight 1922 disposed opposite the second camera 1914. The second backlight 1922 is operable to illuminate at least the distal tip 1906 of the optical fiber 1902. In various embodiments, the first backlight 1920 is disposed orthogonal to the second backlight 1922. In further embodiments, the first camera 1912, the first backlight 1920, the second backlight 1922, and the second camera 1914 are orthogonal to each other and located in a plane orthogonal to the z-axis (e.g., the longitudinal axis, in this case, the nominal optical axis 1908 of the optical fiber 1902). In other embodiments, other configurations of the first camera 1912, the first backlight 1920, the second backlight 1922, and the second camera 1914 may be used as would be understood by one having ordinary skill in the art upon reading the present disclosure.

The cleave angle measurement system 1900 further includes a position sensing device 1924 that is operable to measure the characterization light 1910 emitted from the distal tip 1906 of the optical fiber 1902. The position sensing device 1924 may be a camera, a quadrant photodiode, an image sensor, etc. The characterization light 1910 emitted from the distal tip 1906 of the optical fiber 1902 is emitted onto the receiving surface of the position sensing device 1924. The detected (e.g., measured) position of the characterization light 1910 on the position sensing device 1924 is reported and used for cleave angle computation, to be described in detail below.

FIG. 20 is a simplified flowchart illustrating a method for measuring a cleave angle of an optical fiber using a cleave angle measurement system according to another embodiment of the present invention. Various embodiments of the method for measuring a cleave angle of an optical fiber using cleave angle measurement system may be used in an automated system such as system 100 shown in FIG. 1. The method 2000 includes providing an optical fiber having a longitudinal axis and a distal tip characterized by a cleave angle (2002). The cleaved end of an optical fiber may be an end of the optical fiber having a cleave or cut that is perpendicular to the longitudinal length of the optical fiber. The cleave angle is a reference to how perpendicular the cleaved end of the optical fiber is to the optical axis of the fiber. Typically, the optical axis of the optical fiber is along the longitudinal length of the optical fiber, and thus the cleave angle may be the degree to which the cleaved end is perpendicular to the length of the optical fiber, as described in detail above.

The method also includes imaging the distal tip of the optical fiber (2004). In various embodiments, imaging is performed by a first camera and a second camera. For example, the first camera can face toward the optical fiber and may be positioned at a higher x-position on an x-axis including the optical fiber such that the first camera is above and aligned with the optical fiber. Furthermore, the first camera may be positioned facing downward and toward the optical fiber to image the distal tip of the optical fiber. A second camera can face toward the optical fiber. In some embodiments, the second camera is positioned at or near the x-position of the optical fiber on an x-axis including the optical fiber such that the second camera is aligned with the distal tip of the optical fiber. The first camera and the second camera may each be disposed in a direction that is orthogonal to the longitudinal axis. In at least some embodiments, the first camera may be disposed in a direction that is orthogonal to a direction that the second camera is disposed.

The method further includes translating the optical fiber via a multi-stage axis to reduce or minimize a distance from the distal tip of the optical fiber and the longitudinal axis (2006). According to the active method, the multi-axis stage may be translated in the x-direction until the first distance x₁ is reduced or minimized. For example, the multi-axis stage may be translated downwards such that the distal tip of the of the optical fiber is aligned with the longitudinal axis and/or the distal tip of the optical fiber is not tilted with respect to the longitudinal axis. In some embodiments, a multi-axis stage may be used to translate the optical fiber chuck and the optical fiber along the longitudinal axis (e.g., the z-axis) and along the x-axis.

The method further includes determining, based on the imaging, a pose of the distal tip of the optical fiber (2008). The pose of the distal tip of the optical fiber includes at least a position and angle of the distal tip. For example, the first camera detects (e.g., measures) a first position of the distal tip and a first angle corresponding to the longitudinal axis and the second camera detects (e.g., measures) a second position of the distal tip and a second angle corresponding to the longitudinal axis. In various embodiments, the pose of the distal tip of the optical fiber includes measurements associated with each of the six degrees of freedom of the optical fiber.

According to at least some embodiments of the active method, the position of one or more cameras are predefined, the position sensing device origin is predefined, a distance d referring to a distance along the z-axis between the distal tip of the optical fiber and the image sensor (e.g., position sensing device) is known, and the indices of refraction (n₁ and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging.

The method further includes emitting light from a light source (2010). A light source may be provided proximal to the proximal tip of the optical fiber and the light source may be configured to emit light. For example, the light source may be a laser coupled into the optical fiber from the proximal tip such that light emitted from the light source passes through the optical fiber toward the distal tip. The optical fiber is configured to receive the light emitted by the light source. The light passes through the longitudinal length of the optical fiber. The method further includes emitting characterization light from the distal tip of the optical fiber (2012).

In various embodiments, method 2000 may optionally include illuminating the distal tip via a first backlight disposed opposite the first camera and a second backlight disposed opposite the second camera. Reflection illumination methods may be used, according to at least some embodiments.

The method also includes detecting, at an image sensor, the characterization light (2014). The image sensor may be a camera or a quadrant photodiode, according to various embodiments. Detecting, at the image sensor, the characterization light includes determining a position of the characterization light. The characterization light emitted from the distal tip of the optical fiber is emitted onto the receiving surface of the image sensor. The detected (e.g., measured) position of the characterization light on the image sensor may be reported with measurements from the first camera and the second camera.

The method further includes determining, based on the characterization light and the pose of the distal tip of optical fiber, the cleave angle of the optical fiber (2016). According to various embodiments of the present disclosure, indices of refraction may be assumed (e.g., known) and the position(s) of the camera(s) are predefined. For example, the index of refraction including the effective index and/or the core index may be assumed for one or more computations described throughout the present disclosure. Furthermore, a distance d referring to a distance along the z-axis between the distal tip of the optical fiber and the image sensor (e.g., position sensing device) is known.

Light may be passed through the optical fiber and measured by the position sensing device with respect to the position of the first camera and the second camera. According to some embodiments of the active method, the multi-axis stage may be translated in the x-direction and z-direction until the first distance x₁ and distance z₁ are minimized to zero and the cleave angle with respect to the x-direction αₓ may be calculated based on the following equation:

$${α}_{x} = \frac{{x}_{2} - ( d ) θ}{( \frac{{n}_{2}}{{n}_{1}} - 1 ) ( d )} .$$

The foregoing steps are repeated to solve for the cleave angle with respect to the y-direction α_{y}:

$${α}_{y} = \frac{{y}_{2} - ( d ) θ}{( \frac{{n}_{2}}{{n}_{1}} - 1 ) ( d )} .$$

The cleave angle α is determined by the following equation: α=\sqrt{αₓ²+α_{y}²}.

According to some embodiments of the active method, the multi-axis stage may be translated in the x-direction and z-direction and rotated around the y-axis until the first distance x₁, first distance z1, and angle θ are minimized such that the equation to solve for the cleave angle with respect to the x-direction αₓ is:

$${α}_{x} = \frac{{x}_{2}}{( \frac{{n}_{2}}{{n}_{1}} - 1 ) ( d )} .$$

The cleave angle with respect to the y-direction α_{y} is:

$${α}_{y} = \frac{{y}_{2}}{( \frac{{n}_{2}}{{n}_{1}} - 1 ) ( d )} .$$

The cleave angle α is determined by the following equation: α=\sqrt{αₓ²+α_{y}²}.

In another embodiment, a position and angle may be selected as a reference origin where the distal tip of the optical fiber will be centered and in focus. The optical fiber may be placed onto the optical fiber chuck and moved to the preset origin. Light may be passed through the optical fiber and the positions and angles are measured and recorded for each of the x-axis and the z-axis. The foregoing steps may be repeated as the optical fiber is rotated between measurements to create a circular locus of points on the sensor plane from multiple samplings. If the multi-axis stage is not used, each sampled point is transformed to accommodate the measured x₁ and θ offsets, in a manner that would become apparent to one having ordinary skill in the art upon reading the present disclosure. The centroid of the locus defines the nominal sensor centroid for the system and the centroid may be stored and used as the reference origin for future measurements.

During an alignment process, an optical fiber may be aligned with an external body. For example, optical fibers are often spliced to various external bodies, such as another optical fiber or a piece of optical equipment, and precise alignment between the optical fiber and the external body is utilized to maximize power transmission to or from the external body.

During the alignment process it is generally important to align the fiber such that light emitted by the optical fiber is minimally offset with respect to a corresponding end component. For example, a cleave angle of a cleaved end of an optical fiber may impact the offset or orientation of light emitted by the optical fiber. Any offset in the emitted light may impact the performance of the optical fiber in an optical system. Conventional cleave angle measurement systems and techniques are often unable to measure the cleave angle to within a degree of angle and often have minimal repeatability.

Manufacturing properties of the optical fiber, however, may impact the alignment process. For example, an optical fiber may include a cleaved end. The cleaved end of an optical fiber may be an end of the optical fiber having a cleave or cut that is generally perpendicular to the longitudinal length of the optical fiber. The cleave is generally made during a manufacturing process of the optical fiber. The angle of the cleaved end, referred to herein as a cleave angle, may impact the alignment process. The cleave angle is a reference to how perpendicular the cleaved end of the optical fiber is to the optical axis of the fiber. Typically, the optical axis of the optical fiber is aligned with the longitudinal length of the optical fiber, and thus the cleave angle may be the degree to which the cleaved end is perpendicular to the length of the optical fiber.

The cleave angle of an optical fiber may impact the alignment process for the optical fiber. Specifically, the cleave angle of the optical fiber may impact the angle and orientation (e.g., offset) at which light is emitted from the cleaved end of the optical fiber. Conventional approaches, however, to measuring the cleave angle of an optical fiber are often unable to measure the cleave angle to within a degree of angle and often have minimal repeatability. Moreover, conventional methods may be fiber type-specific, requiring mode matching and wavelength matching between the optical fiber and the measuring equipment. As such, there is a need in the art for improved methods and systems related to measuring a cleave angle of an optical fiber.

It should be appreciated that the specific steps illustrated in FIG. 20 provide a particular method of measuring a cleave angle of an optical fiber using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 20 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 21 is a simplified schematic diagram of an optical fiber alignment and positioning system 2100 according to an embodiment of the present invention. Various embodiments of optical fiber alignment and positioning system 2100 may be used in an automated system such as system 100 shown in FIG. 1. The optical fiber alignment and positioning system 2100 may be used to position and align a polarization maintaining fiber, such as optical fiber 2110, with one or more external bodies (e.g., another optical fiber, a microlens array, and the like). As shown, the optical fiber 2110 may include a first end 2112 and a second end 2114 extending axially along an x-axis. The optical fiber alignment and positioning system 2100 may be used to align and position the first end 2112 of the optical fiber with one or more external bodies.

To align the optical fiber 2110 with an external body, it may be desirable to maintain the polarization of the light output by the optical fiber 2110 with respect to the external body. For example, optical fibers are often spliced to various external bodies, such as another optical fiber or a piece of optical equipment, and precise alignment between the optical fiber and the external body is utilized to maintain the polarization state of the light in the external body. One method of maintaining the polarization of the light output between the optical fiber 2110 and the external body is to align the internal components (e.g., stress rods, core, microstructure, and the like) of the optical fiber 2110 with one or more components of the external body. Thus, proper alignment of the optical fiber 2110 often utilizes precise alignment and positioning of the internal components of the optical fiber 2110.

During an alignment process or an attachment process, an axial load or pressure may be applied to the first end 2112 of the optical fiber 2110. For example, the first end 2112 of the optical fiber 2110 may be pressed against an external body, or the external body may be pressed against the first end 2112 of the optical fiber 2110. To prevent the optical fiber 2110 from moving during the alignment and/or attachment process, the optical fiber alignment and positioning system 2100 may include a vacuum stage. The vacuum stage 2102 may include a first end 2104 and a second end 2106. The vacuum stage 2102 may be configured to receive an optical fiber 2110. For example, the vacuum stage 2102 may include an optical fiber channel 2108. The optical fiber channel 2108 may extend from the first end 2104 to the second end 2106 of the vacuum stage 2102. The optical fiber channel 2108 may be configured to receive the optical fiber 2110. The optical fiber 2110 may be disposed in the optical fiber channel 2108 such that a portion of length 2116 of the optical fiber 2110 contacts the optical fiber channel 2108. The vacuum stage 2102, including the optical fiber channel 2108, is described in greater detail above.

In some embodiments, the optical fiber alignment and positioning system 2100 may also include a mechanical immobilizer 2130. The mechanical immobilizer 2130 may be part of the vacuum stage 2102 or may be separate from the vacuum stage 2102. The mechanical immobilizer 2130 may be positioned to contact a portion 2132 of optical fiber 2110 that cantilevers out of the optical fiber channel 2108 towards an image sensor 2150. In some embodiments, the mechanical immobilizer 2130 may be positioned between the vacuum stage 2102 and the second end 2114 of the optical fiber 2110, while in other embodiments, the mechanical immobilizer 2130 may be positioned between the vacuum stage 2102 and the image sensor 2150, as shown. The position of the mechanical immobilizer 2130 may vary depending on the application.

The mechanical immobilizer 2130 may be configured to securely hold the optical fiber 2110 during the alignment and attachment processes. For example, the mechanical immobilizer 2130 may include two pads positioned on either side of optical fiber 2110 that may contact optical fiber 2110 along portion 2132. The location of the portion 2132 at which the mechanical immobilizer 2130 contacts the optical fiber 2110 may vary depending on the positioning of the mechanical immobilizer 2130, as noted above. The mechanical immobilizer 2130 may be configured to secure optical fiber 2110 in a fixed relationship with respect to the vacuum stage 2102.

When disposed on the vacuum stage 2102, the optical fiber 2110 may be positioned such that the first end 2112 is directed towards the image sensor 2150. In some embodiments, the optical fiber 2110 may emit a light beam 2118 from the first end 2112. The first end 2112 of the optical fiber 2110 may be a cleaved end of the optical fiber 2110. The image sensor 2150 may be positioned to receive at least a portion of the light beam 2118 as emitted from the optical fiber 2110. For example, the image sensor 2150 may be positioned in axial alignment with the first end 2112 of the optical fiber 2110. The light beam 2118 may be light that is emitted from the optical fiber 2110 when light propagates through the length 2116 of the optical fiber 2110. For example, a light source (not shown), such as a laser, may be directed toward the second end 2114 or along the length 2116 of the optical fiber 2110 to generate the light beam 2118.

The image sensor 2150 may be used to identify one or more internal components of the optical fiber 2110. As such, the image sensor 2150 may be positioned to generate an image of an emission face of the optical fiber 2110. For example, the emission face of optical fiber 2110 may be the first end 2112 of the optical fiber 2110. To generate an image of the emission face of the optical fiber 2110, the image sensor 2150 may include any sensor capable of sensing the light beam 2118 when emitted from the first end 2112 of the optical fiber 2110. In an example embodiment, the image sensor 2150 may be a camera. As noted herein, identification of the internal components, such as stress rods and/or core, of the optical fiber 2110 may be used for alignment and positioning processes. For example, based on an image captured by the image sensor 2150, an alignment offset for the optical fiber 2110 may be determined. The alignment offset may be the difference between the position of the emission face of the optical fiber 2110 and an alignment position. The alignment position may be a position of the emission face of the optical fiber 2110 at which the emission face aligns with an external body.

In some embodiments, the optical fiber alignment and positioning system 2100 may also include a controller 2140. The controller 2140 may be operationally coupled with the vacuum stage 2102 via communication line 2142. In some embodiments, the controller 2140 may also be operationally coupled with image sensor 2150 and/or the mechanical immobilizer 2130. For example, after the image sensor 2150 generates an image of the emission face of the optical fiber 2110, the image sensor 2150 may send the image to the controller 2140. The controller 2140 may perform various steps of the methods described herein. For example, the controller 2140 may determine one or more modifications to the position of the optical fiber 2110 based on the image captured by the image sensor 2150. In such an example, based on this determination, the controller 2140 may send instructions to the vacuum stage 2102 to release vacuum from the optical fiber 2110. As will be described in greater detail below, after the vacuum is released, a position of the optical fiber 2110 may be modified or adjusted.

The optical fiber alignment and positioning system 2100 and related methods described herein may also be used for other types of fibers and/or configuration of stress rods and cores of fibers. In various embodiments, the optical fiber alignment and positioning system may be another type of alignment system such as for bow-tie fibers, panda fibers, multi-core fibers, elliptical fibers, photonic crystal optical fibers, and the like.

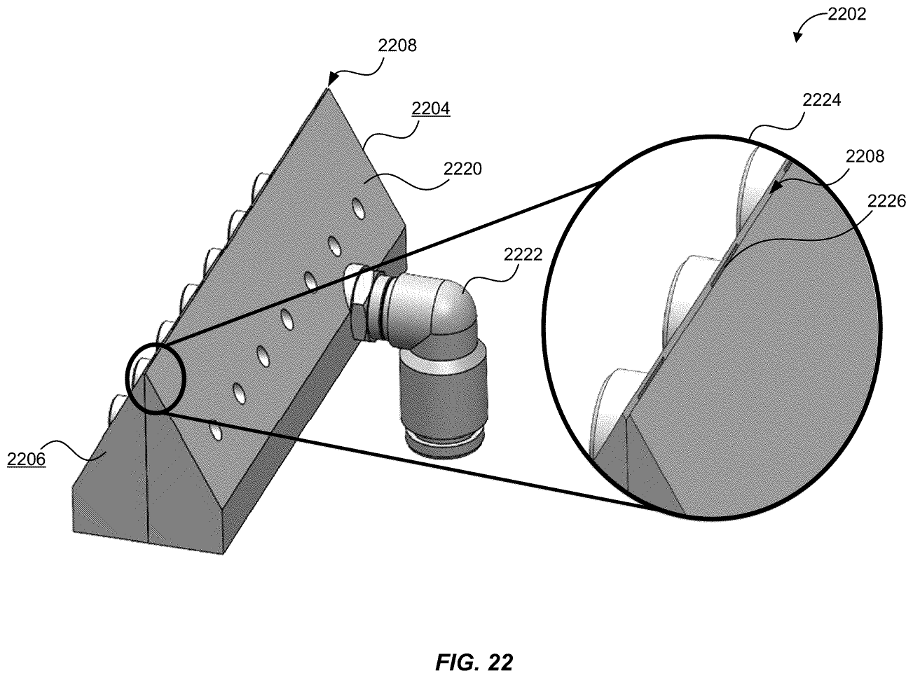

FIG. 22 is a simplified schematic diagram of a vacuum stage 2202 for the optical fiber alignment and positioning system 2100 illustrated in FIG. 21, according to an embodiment of the present invention. Various embodiments of the vacuum stage 2202 for the optical fiber alignment and positioning system 2100 may be used in an automated system such as system 100 shown in FIG. 1. The vacuum stage 2202 may be the same or similar to the vacuum stage 2102 illustrated in FIG. 21. The vacuum stage 2202 may be part of an optical fiber alignment and positioning system, such as the optical fiber alignment and positioning system 2100.

The vacuum stage 2202 may include a body 2220. An optical fiber channel 2208 may be formed as part of the body 2220. The optical fiber channel 2208, which may be the same or similar to the optical fiber channel 2208, may extend from a first end 2204 to a second end 2206 of the body 2220 of the vacuum stage 2202. The optical fiber channel 2208 may be configured to receive an optical fiber, such as the optical fiber 2110 illustrated in FIG. 21.

The vacuum stage 2202 may be configured to apply a vacuum to a portion of the optical fiber (not shown). For example, a vacuum may be applied to the portion of the optical fiber that is disposed in the optical fiber channel 2208. To apply vacuum, the vacuum stage 2202 may include a vacuum inlet 2222. The vacuum inlet 2222 may be operable to be in fluid communication with a vacuum source (not shown). When in fluid communication with a vacuum source, vacuum may be drawn via the vacuum inlet 2222.

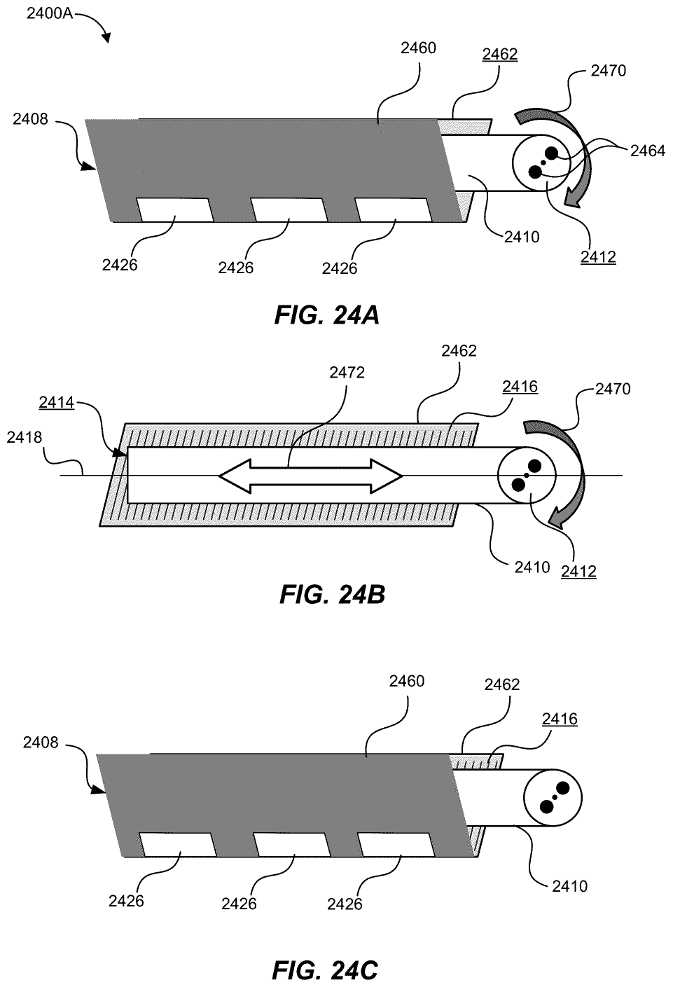

View 2224 illustrates a close-up view of the optical fiber channel 2208. As shown, the optical fiber channel 2208, may include at least two walls. For example, the optical fiber channel 2208 may be formed in the shape of a v-groove. The optical fiber channel 2208 is discussed in greater detail with respect to FIGS. 24A-24C.

To apply vacuum to the portion of the optical fiber disposed in the optical fiber channel 2208, the optical fiber channel 2208 may include a plurality of vacuum ports 2226. The vacuum ports 2226 may extend along a predefined portion of the optical fiber channel 2208 between the first end 2204 and the second end 2206 of the vacuum stage 2202. For example, the vacuum ports 2226 may extend a predetermined unit of length (e.g., 2-25 mm) along the optical fiber channel 2208 between the first end 2204 and the second end 2206. In some embodiments, the vacuum ports 2226 may pass through one or more walls of the optical fiber channel 2208. For example, if the optical fiber channel 2208 is a v-groove, then the vacuum ports 2226 may pass through the first and second walls of the v-groove.

The vacuum ports 2226 may be in fluid communication with one or more passages (not shown) extending through the body 2220 of the vacuum stage 2202. The one or more passages may be in fluid connection with the vacuum inlet 2222 such to extend the vacuum from the vacuum inlet 2222 to the vacuum ports 2226.

As noted above, a vacuum may be applied to an optical fiber disposed in the optical fiber channel 2208. For example, a vacuum force or vacuum pressure may be applied to the optical fiber disposed in the optical fiber channel 2208 via the plurality of vacuum ports 2226. The size of an individual vacuum port (e.g., length and width) may vary depending on the diameter of the optical fiber disposed in the optical fiber channel 2208. Additionally, the size and number of the vacuum ports 2226 may impact the size of the vacuum stage 2202. For example, increasing the length or the number of vacuum ports may increase the size and weight of the vacuum stage 2202, and in some cases, decrease the structural rigidity of the vacuum stage 2202.

By applying a vacuum to the optical fiber, the optical fiber may be held in the optical fiber channel 2208 by frictional forces. The following equation characterizes the force holding the optical fiber in the optical fiber channel 2208, where F is the frictional force applied to the optical fiber, u is the coefficient of friction, also referred to as a friction factor herein, and N is the normal force applied by the vacuum to the optical fiber.

F=μN

The normal force, N, may be controlled by vacuum pressure applied to the optical fiber by the vacuum ports 2226. For example, the normal force, N, may be characterized by the following equation.

N=P_{vac}nAₚₒᵣₜ

As shown, the design of the vacuum ports 2226 and the pressure applied by the vacuum ports 2226 to the optical fiber may impact the frictional force holding the optical fiber in place. In the above equation for the normal force, N, P_{vac} is the vacuum pressure (force/area) that is applied to the optical fiber, n is the number of vacuum ports 2226, and Aₚₒᵣₜ is the cross-sectional area of the vacuum ports 2226.

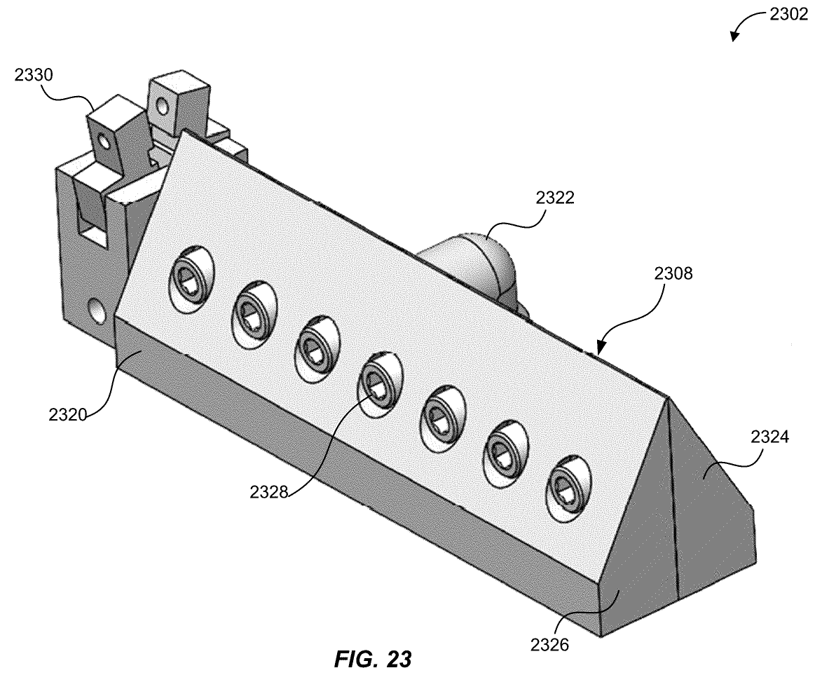

FIG. 23 is a simplified schematic diagram of a vacuum stage for the optical fiber alignment and positioning system illustrated in FIG. 21 having a mechanical immobilizer, according to an embodiment of the present invention. Various embodiments of the vacuum stage for the optical fiber alignment and positioning system may be used in an automated system such as system 100 shown in FIG. 1. Referring to FIG. 23, a vacuum stage 2302 is illustrated that can be utilized with the optical fiber alignment and positioning system 2100 illustrated in FIG. 21 and has a mechanical immobilizer. The vacuum stage 2302 may be the same or similar to the vacuum stage 2202 and may be used as part of the optical fiber alignment and positioning system 2100 as illustrated in FIG. 21. The following discussion is made with reference to FIGS. 21 and 22; however, it should be understood that any systems or techniques described herein may apply.

As shown in FIG. 21, in some embodiments, the optical fiber alignment and positioning system 2100 may include a mechanical immobilizer 2130. The mechanical immobilizer 2330 illustrated in FIG. 23 may be the same or similar to the mechanical immobilizer 2130. In some embodiments, the mechanical immobilizer 2330 may be part of the body 2320 of the vacuum stage 2302, while in other embodiments the mechanical immobilizer 2330 may be separate from the body 2320 of the vacuum stage 2302. As discussed above, the mechanical immobilizer 2330 may be configured to secure an optical fiber, such as the optical fiber 2110 illustrated in FIG. 21, when disposed in an optical fiber channel 2308. The optical fiber channel 2308 may be the same or similar to the optical fiber channel 2108 and/or optical fiber channel 2208.

Similar to the vacuum stage 2202, the vacuum stage 2302 may be operationally configured to apply a vacuum to an optical fiber when disposed in the optical fiber channel 2308. To connect the body 2320 of the vacuum stage 2302 with a vacuum source, the vacuum stage 2302 may include a vacuum inlet 2322.

FIG. 23 also illustrates that the body 2320 of the vacuum stage 2302 may be composed of two main components. As shown, the body 2320 may include a first portion 2324 and a second portion 2326. The first portion 2324 and the second portion 2326 may be secured today by a plurality of attachment mechanisms 2328. In an example embodiment, the attachment mechanisms 2328 may be screws however, those skilled in the art would readily appreciate the various attachment means that could be used to secure the first portion 2324 to the second portion 2326. In the illustrated embodiment, the optical fiber channel 2308 may be formed by the first portion 2324 and the second portion 2326. For example, a first side of the optical fiber channel 2308 may be formed from the first portion 2324 and a second side of the optical fiber channel 2308 may be formed from the second portion 2326. Thus, when the first portion 2324 and the second portion 2326 are secured together, the optical fiber channel 2308 is formed therewith.

FIGS. 24A-C are simplified schematic diagrams of an optical fiber channel 2408 having an optical fiber disposed therein, according to an embodiment of the present invention. For ease of discussion, FIGS. 24A-C are discussed with respect to FIGS. 21-23; however, it should be understood that any system or technique described herein may be applicable. Various embodiments of an optical fiber channel 2408 having an optical fiber disposed therein may be used in an automated system such as system 100 shown in FIG. 1.

FIG. 24A illustrates an embodiment 2400A in which an optical fiber 2410 is disposed within the optical fiber channel 2408. The optical fiber channel 2408 may be the same or similar to the optical fiber channel 2108, the optical fiber channel 2208, or optical fiber channel 2308. For example, the optical fiber channel 2408 may be an optical fiber channel within the optical fiber alignment and positioning system 2100. The optical fiber channel 2408 may be configured to receive and hold the optical fiber 2410. The optical fiber 2410 may be the same or similar to the optical fiber 2110.

In some embodiments, the optical fiber channel 2408 may be a v-groove. As such, the optical fiber channel 2408 may include a first wall 2460 and a second wall 2462. As described above with respect to FIG. 23, in some embodiments, the first wall 2460 may be formed as part of a first portion 2324 of the body 2320 of the vacuum stage 2302, and the second wall 2462 may be formed as part of the second portion 2326 of the body 2320 of the vacuum stage 2302. In other embodiments, the optical fiber channel 2408, including the first wall 2460 and the second wall 2462, may be separate from the body 2220 of the vacuum stage 2202. As noted above with respect to FIG. 22, the optical fiber channel 2408 may include a plurality of vacuum ports 2426. When the optical fiber channel 2408 is a v-groove, then the plurality of vacuum ports 2426 may pass through a portion of the first wall 2460 and/or a portion of the second wall 2462.

When the optical fiber 2410 is disposed in the optical fiber channel 2408, the optical fiber 2410 may be rotated along a rotational direction 2470. The rotational direction 2470 may be about an x-axis or length of the optical fiber 2410. For example, during an alignment process, one or more internal components 2464 exposed via first end 2412 of the optical fiber 2410 may be aligned with an external body. The internal components 2464 may be exposed via first end 2412 because the first end 2412 may be a cleaved end of the optical fiber 2410. In some embodiments, the internal components 2464 may be exposed on the first end 2412 by removing a jacket or coating applied to the optical fiber 2410. As illustrated, the internal components 2464 of the optical fiber 2410 may include stress rods. Other internal components 2464 may include a core or a microstructure.

To align the internal components 2464 with an external body, rotation of the optical fiber 2410 along the rotational direction 2470 may be utilized. As illustrated by FIG. 24B, when rotating the optical fiber 2410 along the rotational direction 2470, the optical fiber 2410 may move axially along an axial direction 2472. The axial direction 2472 may extend along an axis 2418 of the optical fiber. The axis 2418 may extend from the first end 2412 of the optical fiber 2410 to a second end 2414 of the optical fiber 2410.

During an alignment, positioning, or an attachment process, it may be undesirable for the optical fiber 2410 to move along the axial direction 2472. For example, if the optical fiber 2410 moves along the axial direction 2472 during an alignment process, the first end 2412 of the optical fiber 2410 may no longer be in a correct alignment position with an external body. Another example involves an attachment process in which the first end 2412 of the optical fiber is pressed against an external body for bonding. In such an example, if the optical fiber 2410 moves along the axial direction 2472 during the bonding process, the bond between the first end 2412 and the external body may not completely form or even fail if the optical fiber 2410 moves axially away from the external body along the axial direction 2472.

In some implementations, to combat movement of the optical fiber 2410 along the axial direction 2472, additional pressure may be applied to the optical fiber 2410 in a direction perpendicular to the axial direction 2472. For example, some methods may include increasing a vacuum pressure applied to the optical fiber 2410 or applying a clamp to sides of the optical fiber 2410 to prevent axial movement. These methods, however, can impact the accuracy of the alignment and positioning process. For example, increasing pressure applied to the optical fiber 2410 by the vacuum or a clamp to reduce axial movement can impede movement of the optical fiber 2410 in the rotational direction 2470. Rotating the optical fiber 2410 along the rotational direction 2470 is generally utilized during the alignment process, thus impeding this movement can negatively impact the accuracy of an alignment process.

In addition to impeding movement in the rotational direction 2470, some methods of applying additional pressure to the optical fiber 2410 may cause deformation of the optical fiber 2410 along its length. For example, returning to FIG. 22, if the vacuum pressure applied to an optical fiber disposed in the optical fiber channel 2208 is increased to prevent movement of the optical fiber in the axial direction 2472, the additional pressure applied to the portions of the optical fiber disposed over the vacuum ports 2226 may cause deformation or bending of the optical fiber at those portions. Any bending or deformation of the optical fiber can negatively impact the accuracy of the alignment process because after the pressure, vacuum or otherwise, is released, the optical fiber may return to a previous state, thereby ending in a position different than the position used for alignment. Additional issues caused by increasing the vacuum pressure applied to the optical fiber 2410 can include sticking or adhesion of the optical fiber 2410 in the optical fiber channel 2408 due to unreleased pressure.

To provide an optical fiber channel 2408 that allows the optical fiber 2410 to move in the rotational direction 2470 while preventing or minimizing movement in the axial direction 2472, a directional friction surface 2416 is provided herein. The directional friction surface 2416 may be characterized by a plurality of friction factors (e.g., friction coefficients). For example, the directional friction surface 2416 may be characterized by a first friction factor and a second friction factor. In other words, the directional friction surface 2416 may be characterized by a first friction coefficient for friction measured in a first direction and a second friction coefficient for friction measured in a second direction. The first friction factor may be oriented in a first direction such as to provide a frictional force against movement in the first direction. The second friction factor may be oriented in a second direction such as to provide a frictional force against movement in the second direction. The first direction and the second direction may be different directions. In an example embodiment, the first direction may be the axial direction 2472 and the second direction may be the rotational direction 2470. Thus, the second direction can be a circumferential direction (i.e., a tangential direction) oriented 240° to the first direction.

To reduce movement of the optical fiber 2410 in the axial direction 2472, the first friction factor corresponding to the directional friction surface 2416 may be greater than the second friction factor. Because the first friction factor is greater than the second friction factor in this example, the frictional force applied to the optical fiber 2410 in the axial direction 2472 may be greater than the frictional force applied to the optical fiber 2410 in the rotational direction 2470. This may allow the optical fiber 2410 to rotate in the rotational direction 2470, while preventing or minimizing movement of the optical fiber 2410 in the axial direction 2472.

The directional friction surface may contact at least a portion of the optical fiber 2410. For example, the directional friction surface may contact the portion of the optical fiber 2410 that is disposed within the optical fiber channel 2408. As shown by FIG. 24C, the internal walls, such as the first wall 2460 and the second wall 2462, may include the directional friction surface 2416. When the optical fiber channel 2408 is not a v-groove, then one or more walls that form the optical fiber channel 2408 may include the directional friction surface 2416.

In some embodiments, the directional friction surface 2416 may be part of the first wall 2460 and the second wall 2462, while in other embodiments, the directional friction surface 2416 may be a coating or material applied to the first wall 2460 and the second wall 2462. For example, the directional friction surface 2416 may be formed from the material of the first wall 2460 and the second wall 2462. As the first wall 2460 and the second wall 2462 are formed by the optical fiber channel 2408, the directional friction surface 2416 may be formed from the material of the optical fiber channel 2408. With reference to FIG. 23, the optical fiber channel 2308 may be formed by the first portion 2324 and the second portion 2326 of the body 2320. In such examples, the directional friction surface 2416 may be formed by the material of the first portion 2324 and/or the second portion 2326 of the body 2320. In other words, the directional friction surface 2416 may be formed by the material or as part of the vacuum stage 2302.

In other embodiments, the directional friction surface 2416 may be a coating that is applied to a surface of the optical fiber channel 2408, such as the first wall 2460 and the second wall 2462 of the optical fiber channel 2408. In other examples, the directional friction surface 2416 may be a coating that is applied to a surface of vacuum stage 2302.

The material forming the directional friction surface 2416 may be a softer material than the material utilized for the first wall 2460 and the second wall 2462. For example, the directional friction surface 2416 may be or include composite material. For example, the directional friction surface 2416 may be or include a fiber glass or ceramic matrix composites containing soft polymer binders or polymer matrix composite. Conventionally, an optical fiber channel, such as the optical fiber channel 2408, may be composed of a hard material, such as steel, to prevent deformation or decompression of the optical fiber 2410 into the material of the optical fiber channel 2408. Hard material, however, is often characterized by a single friction factor (e.g., friction coefficient), thereby allowing similar movement in both the axial direction 2472 and the rotational direction 2470. In contrast, the softer materials provided herein for the directional friction surface 2416 may provide friction factor differences in the axial direction 2472 and rotational direction 2470. By providing the directional friction surface 2416 with a first friction factor that is greater than a second friction factor, the directional friction surface 2416 may limit movement in a first direction (e.g., axial direction 2472), while allowing movement in the second direction (e.g., the rotational direction 2470).

It should be understood that the arrangement of the first friction factor and the second friction factor on the directional friction surface 2416 may vary depending on the desired movement of the optical fiber 2410. For example, in certain applications, it may be advantageous to allow the optical fiber 2410 to move in the axial direction 2472 while limiting movement of the optical fiber 2410 in the rotational direction 2470. In such cases, the first friction factor may be less than the second friction factor. The direction, orientation, and arrangement of the first friction factor and the second friction factor may influence the directions in which movement of the optical fiber 2410 is allowed and limited.

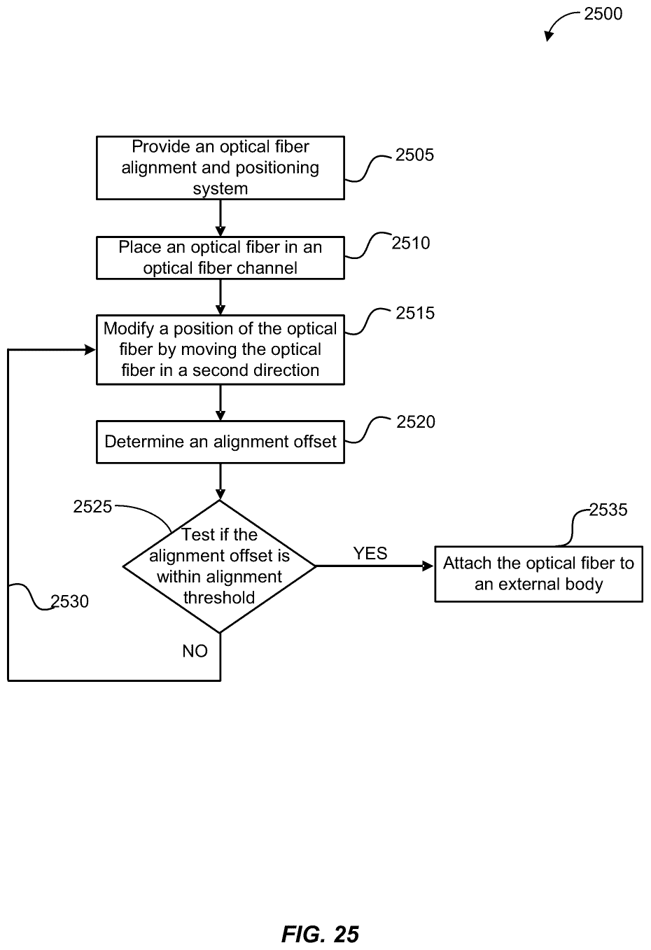

FIG. 25 is a simplified flowchart illustrating a method 2500 for aligning and positioning an optical fiber using an optical fiber alignment and positioning system according to an embodiment of the present invention. Various embodiments of method 2500 may be performed in an automated system such as system 100 shown in FIG. 1. For example, the method 2500 may be for aligning and positioning an optical fiber using the optical fiber alignment and positioning system 600. For ease of explanation, the following discussion is made with reference to FIGS. 21-24C; however, it should be understood that any system or technique discussed herein may be applicable to the method 2500.

At step 2505, the method 2500 may include providing an optical fiber alignment and positioning system, such as the optical fiber alignment and positioning system 2100 illustrated in FIG. 21. As illustrated in FIG. 21, the optical fiber alignment and positioning system 2100 may include a vacuum stage 2102 having a first end 2112 and a second end 2114. The vacuum stage 2102 may include a vacuum inlet, such as the vacuum inlet 2222, that is operable to be in fluid communication with a vacuum source. The vacuum stage 2102 may also include one or more passages extending through the vacuum stage that are in fluid communication with a plurality of vacuum ports, such as the vacuum ports 2226. The one or more passages may fluidly connect the plurality of vacuum ports with the vacuum source.

The vacuum stage 2102 may also include an optical fiber channel, such as the optical fiber channel 2108. The optical fiber channel 2108 may extend from the first end 2112 to the second end 2114 of the vacuum stage 2102. The plurality of ports may pass through the optical fiber channel 2108. As discussed above, the optical fiber channel 2108 may include a v-groove, such as the optical fiber channel 2408 illustrated by FIG. 24A. In such embodiments, the optical fiber channel 2108 may be formed by a first wall, such as the first wall 2460, and a second wall, such as the second wall 2462. When the optical fiber channel 2108 includes a v-groove, the plurality of vacuum ports, such as the vacuum ports 2426, may pass through the first wall 2460 and the second wall 2462, as illustrated in FIG. 24A.

In some embodiments, the optical fiber channel 2108 may include a directional friction surface, such as the directional friction surface 2416. For example, the first wall 2460 and the second wall 2462 of the optical fiber channel 2408 may include the directional friction surface 2416. The directional friction surface 2416 may be formed as part of the optical fiber channel 2108, while in other embodiments, the directional friction surface 2416 may be a coating applied to a surface of the optical fiber channel 2108.

The directional friction surface 2416 may include a first friction factor in a first direction and a second friction factor in a second direction. In an example embodiment, the first friction factor may be higher than the second friction factor. As described above with respect to FIGS. 24A-C, the first direction may be an axial direction, such as the axial direction 2472, and the second direction may be a rotational or tangential direction, such as the rotational direction 2470.

The optical fiber channel 2108 may be configured to receive at least a portion of an optical fiber, such as the optical fiber 2110. As such, the method may include step 2510. At step 2510, the method 2500 may include placing an optical fiber in the optical fiber channel. For example, the method 2500 may include placing the optical fiber 2410 in the optical fiber channel 2408 such that at least a portion of the optical fiber 2410 is in contact with the directional friction surface 2416. In some embodiments, the method may include applying a vacuum to a portion of the optical fiber 2110. For example, the vacuum may be applied via the plurality of vacuum ports 2426 to the portion of the optical fiber 2410.

At step 2515, the method 2500 may include modifying a position of the optical fiber 2110 by moving the optical fiber 2110 in the second direction to a modified position. For example, modifying the position of the optical fiber 2110 by moving the optical fiber 2110 in the second direction may include rotating the optical fiber 2110 in a rotational direction to the modified position. With reference to FIG. 24A, the optical fiber 2410 may be rotated in the rotation direction 2470. After modifying the position of the optical fiber 2110 to the modified position, the mechanical immobilizer 2130 may be opened to release the optical fiber 2110.

At step 2520, the method 2500 may include determining an alignment offset for the optical fiber 2110. The alignment offset may be an amount by which the optical fiber 2110 is off from an alignment position with an external body. At step 2525, the method may include determining if the alignment offset is within an alignment threshold. In some embodiments, the alignment threshold may vary depending on application. For example, in some applications, such as fusion splicing, the tolerance of the alignment threshold may be small, thereby allowing minimal variation between the position of the optical fiber 2110 and the external body. In other applications, the tolerance of the alignment threshold may be larger, thereby allowing more flexibility with respect to the orientation of the optical fiber 2110.

If at step 2525, it is determined that the alignment offset of the optical fiber 2110 is not within the alignment threshold, the method 2500 may return to step 2515 via iterative step 2530. At step 2515, the optical fiber 2110 may be modified to a further modified position by moving the optical fiber in the second direction. After the optical fiber 2110 is moved to the further modified position, a second alignment offset may be determined at step 2520. At step 2525, the second alignment offset may be compared to the alignment threshold.

If, at step 2525, it is determined that the alignment offset of any iteration (e.g., first alignment offset, second alignment offset, etc.) is within the alignment threshold, then the method may continue to step 2535. At step 2535, the method 2500 may include attaching the optical fiber to an external body. For example, the first end 2112 of the optical fiber 2110 may be attached to the external body. In an example embodiment, the first end 2112 of the optical fiber 2110 may be bonded or otherwise secured to the external body.

In some embodiments, the method 2500 may include securing a portion of the optical fiber 2110 using a mechanical immobilizer, such as the mechanical immobilizer 2130. The mechanical immobilizer may be closed about a portion of the optical fiber 2110 to immobilize the optical fiber 2110 to prevent misalignment prior to attaching the optical fiber 2110 to the external body. The mechanical immobilizer may be used when a holding force greater than the vacuum holding force is utilized to prevent misalignment.

It should be appreciated that the specific steps illustrated in FIG. 25 provide a particular method for aligning and positioning an optical fiber using an optical fiber alignment and positioning system according to an embodiment of the present invention. Other sequences of steps may also be performed according to alternative embodiments. For example, alternative embodiments of the present invention may perform the steps outlined above in a different order. Moreover, the individual steps illustrated in FIG. 25 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 26 is a simplified schematic diagram of a microlens array (MLA) 2600 according to an embodiment of the present invention. Various embodiments of an MLA 2600 may be used in an automated system such as system 100 shown in FIG. 1. As shown, the MLA 2600 may include multiple lenslets 2602. Each lenslet 2602 may be a microlens. A microlens may be a small lens, generally with a diameter less than a millimeter (mm) and as small as 10 microns (μm). Each of the lenslets 2602 may be a single microlens with one planar surface and one convex (e.g., spherical) surface to refract the light. In some cases, the lenslets 2602 may be or include several layers of optical material to achieve desired optical properties. In some embodiments, the MLA 2600 may be formed by a one-dimensional or two-dimensional array of the lenslets 2602 on a supporting substrate. The lenslets 2602 may serve to focus and concentrate light from one or more optical fibers.

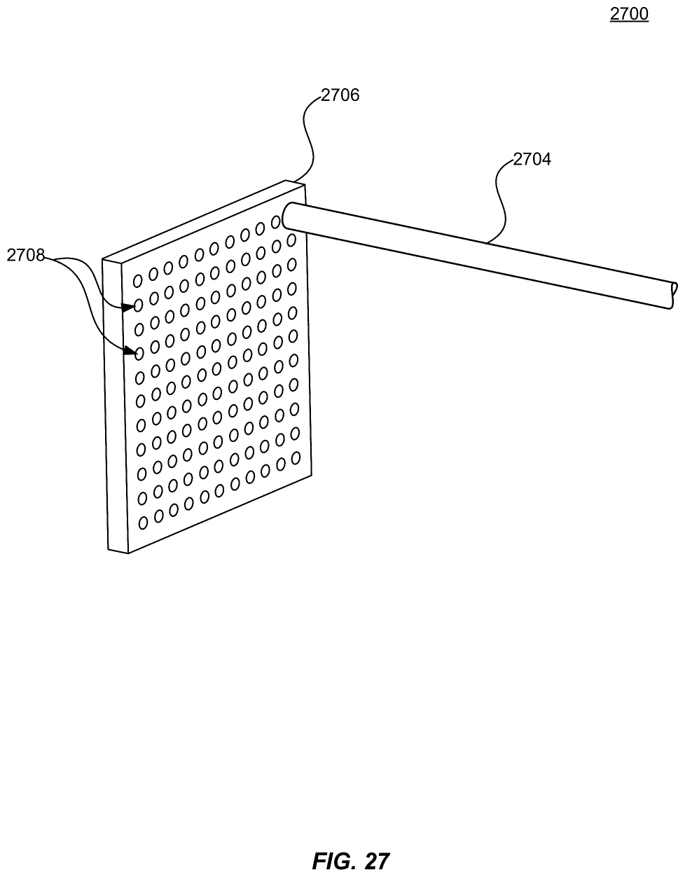

Turning now to FIG. 27, a simplified schematic diagram 2700 of a conventional alignment process for aligning an optical fiber 2704 with a lenslet of an MLA is provided. Conventional approaches often involve an orifice plate 2706 having multiple orifices 2708. In some embodiments, an MLA may be part of the orifice plate 2706. In other embodiments, the orifice plate 2706 may be aligned with an MLA such that each of the orifices 2708 align with a lenslet of the MLA. In an example, the orifices 2708 may be manufactured with lithography techniques.

To align the optical fiber 2704 with a lenslet under a conventional approach, the optical fiber 2704 may be inserted into one of the orifices 2708. Since the orifice is aligned with a lenslet, inserting the optical fiber 2704 into one of the orifices 2708 is used to align the optical fiber 2704 with the lenslet. The use of the orifice plate 2706 for alignment, however, can provide for various deficiencies in the alignment process. For example, the orifice plate 2706 does not allow for independent fiber alignment, nor does it allow for correction of fiber manufacturing imperfections, nor does it allow for alignment of the tip and tilt of the optical fiber 2704. And while decreasing the diameter of the orifices may improve alignment tolerances, decreasing the diameter of the orifice often lends to damage of the optical fiber or failure during the insertion process.

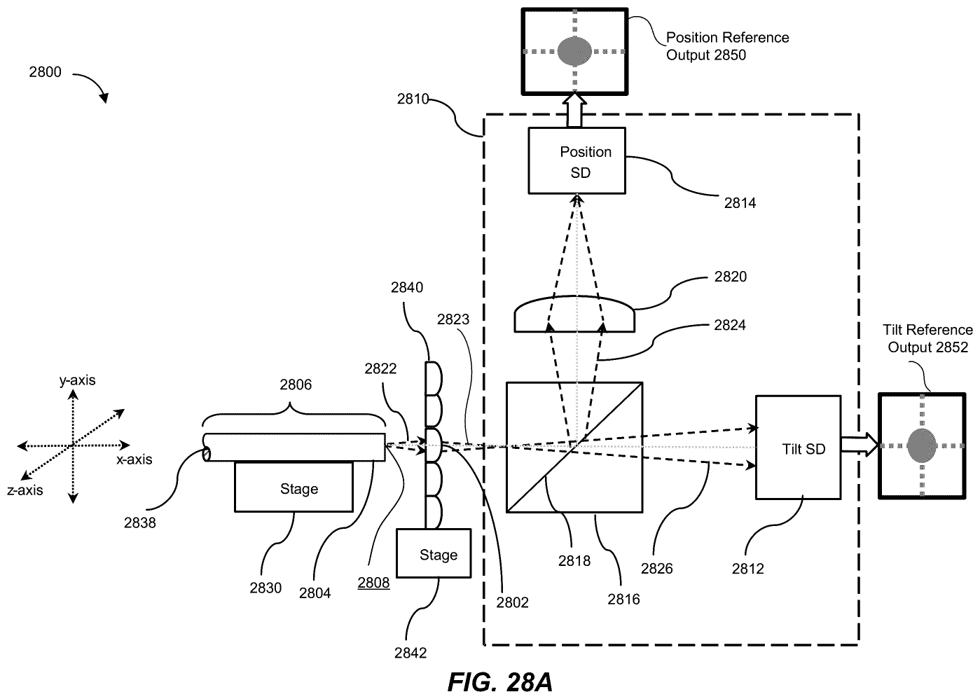

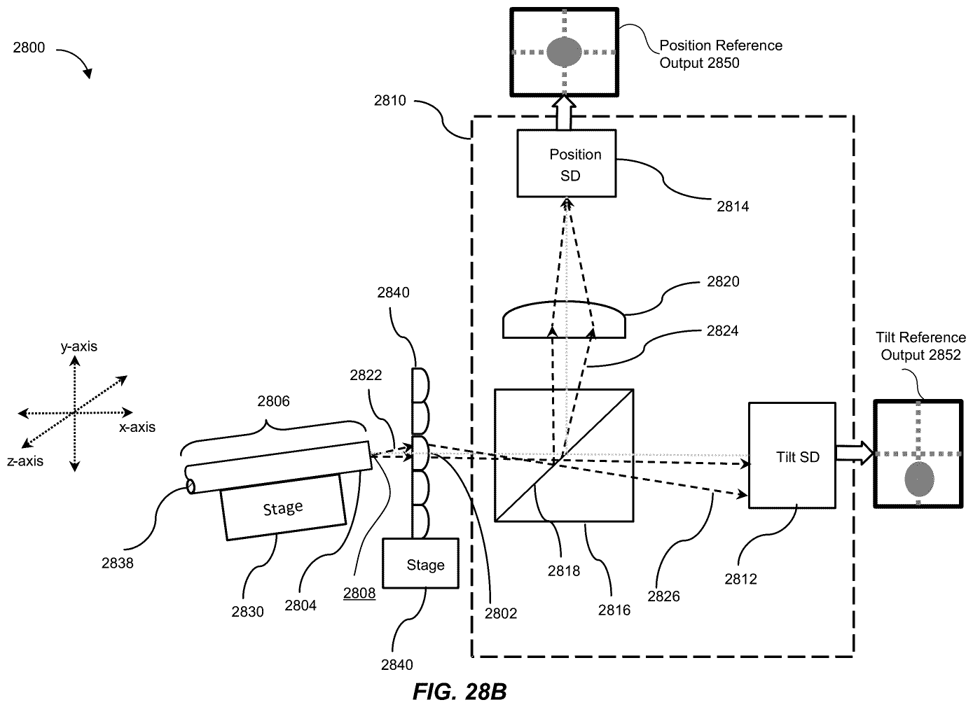

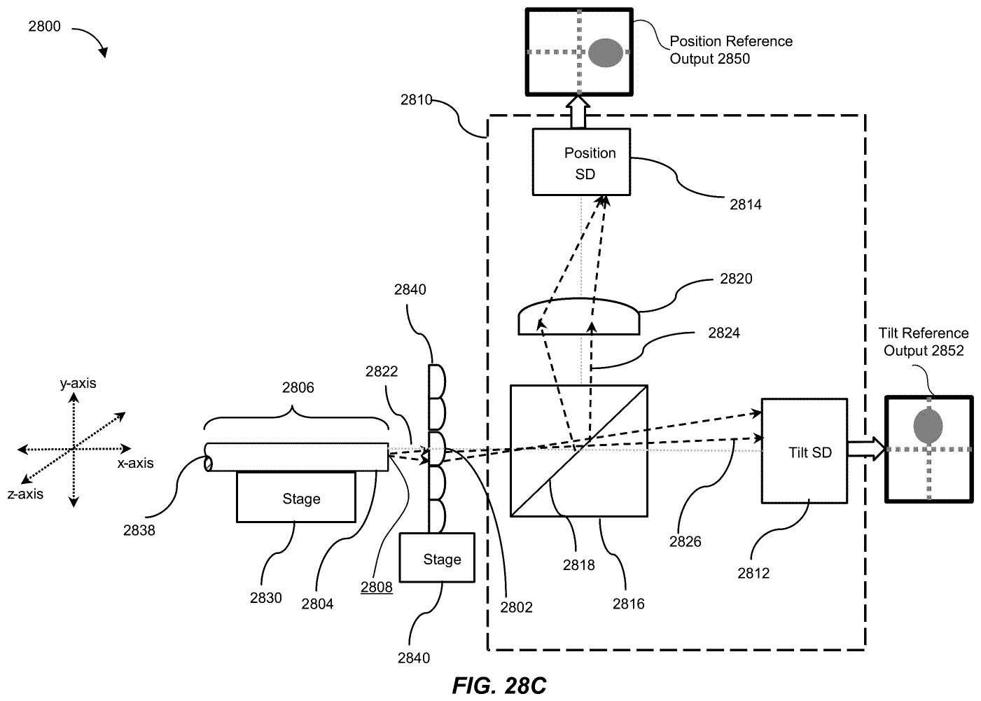

To provide for independent and active optical fiber alignment with an MLA, an MLA alignment system is provided herein. FIG. 28A provides a simplified schematic diagram of a system 2800 for performing an MLA alignment according to an embodiment of the present invention when an optical fiber is located at the nominal position. The system 2800 may be used to align one or more optical fibers, such as optical fiber 2804, with an MLA, such as MLA 2840. Specifically, the system may include an MLA alignment system 2810 for positioning and aligning the optical fiber 2804 with a lenslet 2802 of the MLA 2840. As shown, MLA 2840 may include multiple lenslets and the MLA alignment system 2810 may be used to position and align multiple optical fibers with the multiple lenslets of the MLA.

The optical fiber 2804 may be a polarization maintaining fiber having one or more stress rods, a patterned microstructure, or one or more cores. In some embodiments, the optical fiber 2804 may be or include a bow-tie fiber, a panda fiber, a multi-core fiber, an elliptical fiber, a photonic crystal optical fiber, or the like. Advantageously, the system 2800 may be agnostic to the optical polarization state of the optical fiber 2804. As such, in other embodiments, the optical fiber 2804 may be a single mode fiber, a multi-mode fiber, or any other type of optical fiber. The optical fiber 2804 may have a diameter that is less than 250 μm. For example, the optical fiber 2804 may have a diameter that is less than 225 μm, less than 200 μm, less than 175 μm, less than 850 μm, less than 125 μm, or less than 100 μm.

As noted above, the optical fiber 2804 may have individual manufacturing characteristics or properties. For example, the optical fiber 2804 may have a cleaved end 2808 with a different cleave angle from another optical fiber. The cleaved end 2808 of the optical fiber 2804 may be an end of the optical fiber having a cleave or cut that is substantially perpendicular to the longitudinal length 2806 of the optical fiber 2804 made during the manufacturing process.

Other manufacturing properties of the optical fiber 2804 may include a bend or curvature of the optical fiber 2804 along the longitudinal length 2806 of the optical fiber 2804. During or after the manufacturing process, the optical fiber 2804 may be wound or rolled into a bundle, which can result in a bend or curvature of the optical fiber 2804 along the longitudinal length 2806. Additional manufacturing characteristics of the optical fiber 2804 may include the material of the optical fiber 2804 and whether the optical fiber 2804 includes a jacket or coating. An additional manufacturing characteristic of the optical fiber 2804 may include the centration of the optical core with respect to the outer fiber cylinder diameter. Centration errors of the optical core can result in an optical axis that is different from the mechanical axis of the optical fiber.

The manufacturing characteristics of the optical fiber 2804 may impact the orientation and/or offset of light emitted from the optical fiber 2804. For example, if the cleaved end 2808 of the optical fiber 2804 has a non-zero cleave angle (a zero cleave angle being a perfectly perpendicular cleave to the longitudinal length 2806 of the optical fiber 2804), then light emitted from the cleaved end 2808 of the optical fiber 2804 may be offset by an angle proportional to the non-zero cleave angle. Any offset of light emitted from the cleaved end 2808 may impact the performance of the optical fiber 2804.

The positioning and alignment of the cleaved end 2808 with the lenslet 2802 may also affect the characteristics of light emitted from the optical fiber 2804. As noted above, the optical fiber 2804 may be positioned and aligned with the lenslet 2802. Specifically, the cleaved end 2808 of the optical fiber 2804 may be aligned with the lenslet 2802 such that light beams 2822 transmit through the lenslet 2802 and generate refracted light beams 2823. The refracted light beams 2823 may be formed by refraction of the light beams 2822 through the lenslet 2802.

During the assembly of the fiber and MLA system, the cleaved end 2808 of the optical fiber 2804 is aligned with the lenslet 2802. Alignment of the cleaved end 2808 of the optical fiber with the lenslet 2802 as used herein may mean that the optical fiber 2804 is positioned such that the refracted light beams 2823, as propagated through the lenslet 2802, are maximized so as to maintain the intensity of the light beams 2822. In some embodiments, the MLA 2840 may be positioned at a predetermined distance from the optical fiber 2804. Specifically, the MLA 2840 may be positioned such that the lenslet 2802 is at a predetermined distance from the cleaved end 2808 of the optical fiber 2804. For example, the predetermined distance may be less than 10 μm, less than 100 μm, less than 500 μm, or less than 1 mm. In other embodiments, the MLA 2840 may be positioned such that the lenslet 2802 is in contact or near contact with the cleaved end 2808 of the optical fiber 2804.

The MLA alignment system 2810 can be used to align the optical fiber 2804 with the lenslet 2802. To provide for precise alignment between the cleaved end 2808 and the lenslet 2802, and, advantageously, compensate for any manufacturing characteristics of the individual optical fiber, the MLA alignment system 2810 may include one or more position sensing devices. For example, as illustrated in FIG. 28A, the MLA alignment system 2810 may include a tilt sensing device 2812 and a position sensing device 2814. The tilt sensing device 2812 and/or the position sensing device 2814 may be or include a camera, quadrant photodiode, or other instrument capable of sensing an output position of the optical fiber 2804.

The tilt sensing device 2812 may be configured and positioned to sense the tilt of the optical fiber 2804. The tilt of the optical fiber 2804 may be or include the orientation and position of the cleaved end 2808 with respect to the longitudinal length 2806 of the optical fiber 2804. For example, if the cleaved end 2808 of the optical fiber 2804 is higher on the y-axis than other portions of the optical fiber 2804, as measured along the longitudinal length 2806 of the optical fiber 2804, then the optical fiber 2804 may be tilted. Tilting of the optical fiber 2804 may be caused by a curvature or bend in the optical fiber 2804.

The position sensing device 2814 may be configured and positioned to sense the latitudinal (z-axis) and longitudinal (y-axis) position of the optical fiber 2804. To align the cleaved end 2808 with the lenslet 2802, the cleaved end 2808 may need to be positioned at specific x-y-z coordinates. Additionally, to maximize the intensity of the refracted light beams 2823 refracted through the lenslet 2802, the cleaved end 2808 may need to be positioned at specific x-y-z coordinates. The position sensing device 2814 may sense and provide an output reading of the x-y-z coordinates of the optical fiber 2804.

To direct the refracted light beams 2823 to both the tilt sensing device 2812 and the position sensing device 2814, the MLA alignment system 2810 may include a beam splitter 2816. The beam splitter 2816 may be positioned in axial alignment with the optical fiber 2804 and the MLA 2840. The beam splitter 2816 may be positioned between the MLA 2840 and the tilt sensing device 2812 along the x-axis. The beam splitter 2816 may also be positioned to produce reflected light beams 2824 to the position sensing device 2814. For example, the beam splitter 2816 may include a surface 2818 that reflects a portion of the refracted light beams 2823 towards the position sensing device 2814 as reflected light beams 2824. The surface 2818 may be a reflective surface such as a mirror. As shown, the beam splitter 2816 may reflect a portion of the light beams 2822 toward the position sensing device 2814 while transmitting the remaining portion of the refracted light beams 2823 as transmitted light beams 2826 to the tilt sensing device 2812. Although the position sensing device 2814 is illustrated as receiving light reflected from beam splitter 2816, this is not required by embodiments of the present invention and, in other embodiments, the position sensing device 2814 may be switched with the tilt sensing device 2812 so that the tilt sensing device 2812 receives light reflected from beam splitter 2816. One of ordinary skill in the art would recognize many variations, modifications, and alternatives.

In some embodiments, the MLA alignment system 2810 may include a collecting lens 2820. The collecting lens 2820 may be positioned between the beam splitter 2816 and the position sensing device 2814. The reflected light beams 2824 may be received by the collecting lens 2820 and directed to the position sensing device 2814. A focal length of the collecting lens 2820 and the distance from the beam splitter 2816 to the collecting lens 2820 may be determined based on a given wavelength of the light beams 2822 and the properties of the MLA 2840.

To position and align the optical fiber 2804, the MLA alignment system 2810 may generate a reference output for the optical fiber 2804. The position sensing device 2814 may generate a position reference output 2850 and the tilt sensing device 2812 may generate a tilt reference output 2852. Although the position reference output 2850 and the tilt reference output 2852 are illustrated as part of system 2800, it should be understood that the position reference output 2850 and the tilt reference output 2852 are not physical components of the system 2800.

Rather, the position reference output 2850 and the tilt reference output 2852 are provided to illustrate a measurement or output provided by the respective sensing device. The position reference output 2850 and the tilt reference output 2852 are described in greater detail with reference to FIGS. 29A and 29B.

In the illustrated embodiment, the position reference output 2850 and the tilt reference output 2852 are images of the collected beams incident on the position sensing device 2814 and tilt sensing device 2812, respectively. In other embodiments, the position reference output 2850 and the tilt reference output 2852 may be one or more analog or digital signals collected by a quadrant photodiode or similar positioning tool. One of ordinary skill in the art would recognize many variations, modifications, and alternatives to this design.

To generate the position reference output 2850 and the tilt reference output 2852 for the optical fiber 2804, the position sensing device 2814 and the tilt sensing device 2812 may measure the optical fiber's position and tilt, respectively. Based on a tilt measurement and a position measurement, taken by the tilt sensing device 2812 and the position sensing device 2814, respectively, the MLA alignment system 2810 may determine whether to adjust or modify the position and/or orientation of the optical fiber 2804. For example, the MLA alignment system 2810 may determine that the optical fiber 2804 may need to be moved along the x-axis, e.g., to adjust the focal point of light beams 2822, based on the position measurement.

To adjust or modify the position of the optical fiber 2804, the system 2800 may include a stage 2830. In some embodiments, the stage 2830 may be part of the MLA alignment system 2810. In other embodiments, the stage 2830 may be separate from the MLA alignment system 2810. The stage 2830 may be configured to hold and adjust the position of the optical fiber 2804. For example, the stage 2830 may move the optical fiber along the x-axis, along the y-axis, or along the z-axis. In some embodiments, the stage 2830 may be configured to adjust the tilt of the optical fiber 2804 by rotating the optical fiber 2804. For example, the stage 2830 may be or include a rotational stage that is configured to rotate the optical fiber 2804. The rotational stage may rotate the optical fiber 2804 about the x-axis, also known as u-rotation; about the y-axis, also known as v-rotation; or about the z-axis, also known as w-rotation. Tilt, as used herein, may include v-rotation or w-rotation of the optical fiber 2804. As used herein, moving or adjusting the position of the optical fiber 2804 may be understood to move the optical fiber 2804 along one or more of the x-axis, y-axis, and/or z-axis, or rotating the optical fiber 2804 along one or more of a u-rotation, v-rotation, or w-rotation.

FIG. 28B provides a simplified schematic diagram of a system 2800 for performing an MLA alignment according to an embodiment of the present invention when the optical fiber 2804 is in rotational misalignment. For example, FIG. 28B may illustrate the MLA alignment system 2810 when the optical fiber 2804 is displaced in the positive v-direction due to a rotation about the z-axis. The light beams 2822 and the transmitted light beams 2826 are also tilted by the same displacement in the v-direction leading to a change in the tilt reference output 2852 as measured by the tilt sensing device 2812. The reflected light beams 2824 are also tilted by this same angle until they reach the collecting lens 2820. The collecting lens 2820 is selected such that the position reference output 2850 of the position sensing device 2814 remains unchanged for any displacements in the v-direction or w-direction.

FIG. 28C provides a simplified schematic diagram of a system 2800 for performing an MLA alignment according to an embodiment of the present invention when the optical fiber 2804 is in translational misalignment. For example, FIG. 28C shows the MLA alignment system 2810 when the optical fiber 2804 is displaced in the negative y-direction. The refracted light beams 2823 and the transmitted light beams 2826 from the lenslet 2802 are also displaced the same amount in the y-direction leading to a positive change in the tilt reference output 2852 as measured by the tilt sensing device 2812. The reflected light beams 2824 are also displaced resulting in a negative change in the position reference output 2850 as measured by the position sensing device 2814.

After adjusting or modifying the position of the optical fiber 2804, the MLA alignment system 2810 may gather one or more measurements to determine if the position of the optical fiber 2804 is within a positional tolerance. If the optical fiber 2804 is within a positional tolerance, then a tilt measurement and a position measurement for the position of the optical fiber 2804 may be measured. The tilt sensing device 2812 may measure the tilt measurement and the position sensing device 2814 may measure the position measurement.

FIG. 29A illustrates a diagram 2900A of an emission spot 2902 used to calculate a tilt measurement. The diagram 2900A may be used to generate the tilt reference output 2852. Although the following discussion is with respect to a tilt measurement, the position measurement may be gathered and corrected to generate a corrected reference output using one or more of the following techniques or steps. For ease of discussion, FIGS. 29A and 29B are discussed with reference to FIGS. 28A-C; however, it should be understood any systems provided herein may be used.

The emission spot 2902 may be generated from a light beam incident on and captured by the tilt sensing device 2812. In the case of a position measurement, the position sensing device 2814 may capture a light beam incident on the position sensing device and used to generate the emission spot 2902. The emission spot 2902 may correspond to the cleaved end 2808 of the optical fiber 2804. One of several image processing methods can be utilized to detect and/or identify the various components of the optical fiber. For example, in one embodiment, z,y-coordinates of the centroid 2914 of the emission spot 2902 can be determined by use of an intensity weighted centroid calculation. In an alternate embodiment, the z,y-coordinates may be determined from a computational fitting algorithm of an ideal spot to the measured emission spot 2902. Alternate computational variations will be evident to one skilled in the art.

The light beam used to generate the diagram 2900A may be captured by receiving the reflected light beams 2824 and the transmitted light beams 2826. It should be understood that allowing the beam spot to expand may increase the sensitivity of the measurements gathered by the tilt sensing device 2812 and/or the position sensing device 2814, but the overall beam spot may be limited by the physical size of the tilt sensing device 2812 and/or the position sensing device 2814.

A degree of tilt may be calculated for the emission spot 2902. The degree of tilt may correspond to the tilt measurement for the optical fiber 2804. To calculate the degree of tilt, a tilt offset 2950 may be determined for the emission spot 2902. For example, in some embodiments, the degree of tilt may be determined by the centroid 2914 of emission spot 2902. The difference between the z-y coordinates identified by the tilt offset 2950 and an origin 2954 (e.g., z-y coordinates of 0,0) may be used to determine the degree of tilt (e.g., the tilt measurement) for the optical fiber 2804. The tilt measurement may be determined based on the degree of tilt of emission spot 2902.

For a position measurement, similar techniques may be utilized. For example, based on the light beam captured by the position sensing device 2814, centroid 2914 of the emission spot 2902 may be used to determine the position of the cleaved end 2808 of the optical fiber 2804.

The tilt measurement and the position measurement may be part of the alignment offset used to determine whether emission spot 2902 (e.g., corresponding to the cleaved end 2808 of the optical fiber 2804) is in an alignment position. The alignment position may be a position at which the emission spot 2902 is located within a predefined tolerance from a reference zero position.

For example, when aligning the fiber to the system, an initial measurement is taken of the position reference output 2850 and the tilt reference output 2852. The fiber is first rotated to a second rotation position in the v-direction and w-direction until the tilt reference output is reduced below a predefined threshold. Next, the fiber is rotated to a second translation position in the y-direction and z-direction until the position reference output 2850 is reduced below a predefined threshold. Once completed, the tilt reference output 2852 is regenerated. If the tilt reference output 2852 has increased beyond the predefined threshold, the optical fiber is then moved to a third rotational position and the entire process is iterated until both the position reference output 2850 and tilt reference output 2852 are reduced to values less than the corresponding threshold.

In some embodiments, it may be desirable to position the cleaved end 2808 of the optical fiber 2804 at an alignment position prior to positioning and alignment of an MLA in order to collect a reference alignment output. For example, the alignment position of the emission spot 2902 may be used as part of a reference output for positioning and aligning an MLA. The reference output may include a tilt value (e.g., the tilt measurement) and a position value (e.g., the position measurement). The reference output may provide a reading or coordinates as to the orientation, including positional and rotational (e.g., tilt), of the emission face of the optical fiber 2804. The reading or coordinates of the reference output may be used as a reference point during the positioning and the alignment of the MLA. For example, as will be described in greater detail below, the reference output may be used to determine an alignment threshold for the MLA. In an embodiment, the MLA may be positioned and aligned such that the spot beam received by the tilt sensing device 2812 and the position sensing device 2814 after placement of the MLA is similar or the same as the spot beam received prior to placement of the MLA within the system 2800.

The reference output may be generated from the tilt measurement and the position measurement. In some embodiments, the reference output may be a sum or reading of the tilt measurement and the position measurement. After the reference output is generated, the reference output may be compared to an alignment threshold. For example, the tilt measurement may be compared to a tilt threshold and the position measurement may be compared to a position threshold.

As shown by diagram 2900A, the emission spot 2902 of the optical fiber 2804 may have a tilt offset 2950. The tilt measurement generated from the tilt offset 2950 may be compared with a tilt threshold 2952. In some embodiments, the emission spot 2902 may also include a positional offset. Similar to the tilt measurement, the position measurement generated from the positional offset may be compared with a position threshold.

If the tilt measurement is within the tilt threshold 2952 and the position measurement is within the position threshold, then the MLA may be placed within the system 2800. However, if either the tilt measurement or the position measurement is not within the tilt threshold 2952 or the position threshold, respectively, then the cleaved end 2808 of optical fiber 2804 may be rotated, moved, or otherwise adjusted to orient the emission spot 2902 to a modified position. For example, to generate the tilt measurement and the position measurement, the optical fiber 2804 may be in a first position. If either one of the tilt measurement or the position measurement is not within a tilt threshold 2952 or a position threshold, respectively, then the optical fiber 2804 may be positioned to a second position. At the second position, a second tilt measurement and a second position measurement may be measured. The second tilt measurement and the second position measurement may be compared to the tilt threshold 2952 and the position threshold, respectively. If the second tilt measurement and the second position measurement are within the respective thresholds, the MLA may be placed in the system 2800. However, if the second tilt measurement and the second position measurement are not within the respective threshold, then the optical fiber 2804 may be positioned in a third position. In this manner, generating the reference output and adjusting the optical fiber such that the reference output is within an alignment threshold may be an iterative process.

When the tilt measurement or the position measurement is not within a respective threshold, the cleaved end 2808 of the optical fiber 2804 may be positioned in a modified position. The optical fiber 2804 may be positioned or adjusted using the stage 2830. As noted above, moving or adjusting the position of the optical fiber 2804 may be understood as moving the optical fiber 2804 along one or more of the x-axis, y-axis, or z-axis, or rotating the optical fiber 2804 about one or more of a u-rotation, v-rotation, or w-rotation.

In some embodiments, the degree or amount of movement utilized to position the optical fiber 2804 such that the tilt measurement or the position measurement is within the respective threshold, may be computationally determined. For example, using the diagram 2900A, a rotation angle may be determined based on the tilt offset 2950 and/or the position offset of the emission spot 2902. The rotation angle may be the degree or amount of rotation necessary for tilt offset 2950 to align with the horizontal x-axis. In some cases, after rotating cleaved end 2808 of optical fiber 2804 based on the degree of tilt, another diagram 2900A of emission spot 2902 may be generated in the modified position.

The tilt offset and/or the position offset may be due to one of or both of the orientation of the optical fiber 2804 or the cleaved end 2808. For example, as described above, the cleaved end 2808 may include a cleave angle. The cleave angle may determine the orientation or angle at which light beams 2822 are emitted from the cleaved end 2808. If the cleave angle is not zero or exactly perpendicular to the longitudinal length 2806 of the optical fiber, then light beams 2822 may be emitted at an angle that is not parallel to the longitudinal length 2806 of the optical fiber 2804, i.e., not parallel to the x-axis. In other words, if the cleave angle is zero, then light beams 2822 would be emitted approximately parallel to the longitudinal length 2806 of the optical fiber 2804. Any variation from a zero cleave angle may impact the angle at which light beams 2822 are emitted.

In embodiments in which the cleave angle is zero, any tilt measured by the tilt sensing device 2812 may be due to the orientation of the optical fiber 2804. Tilting of the optical fiber 2804 due to orientation may mean that the cleaved end 2808 is in a different plane than the opposing end 2838. For example, if the optical fiber 2804 is tilted but has a zero cleave angle, then the cleaved end 2808 may be at a different position along the y-axis, x-axis, or z-axis than the opposing end 2838. To address the tilt of the optical fiber 2804, the stage 2830 may move the optical fiber 2804 in a respective direction to fix the tilt.

In embodiments where the cleaved end 2808 is on the same plane as the opposing end 2838, the optical fiber 2804 may have tilt due to the cleaved end 2808. For example, if the cleave angle of cleaved end 2808 is non-zero, then the light beams 2822 may be emitted at an angle with respect to the x-axis. Emittance of the light beams 2822 at an angle may be measured as tilt by the tilt sensing device 2812. To compensate for the tilt caused by the non-zero cleave angle, the optical fiber 2804 may be rotated about the y-axis or v-rotation. In other words, the cleaved end 2808 may be raised or lowered, while the opposing end 2838 is lowered or raised, respectively. The degree to which the optical fiber is rotated under v-rotation may correspond to the degree to which the cleave angle of the cleaved end 2808 varies from zero.

It should be understood that the type of rotation may vary depending on the orientation of the cleave angle for the cleaved end 2808. For example, if the cleave angle is non-zero along the y-axis, then the optical fiber 2804 may be rotated along a v-rotation (e.g., about the y-axis). If the cleave angle is non-zero along the z-axis, then the optical fiber 2804 may be rotated along a u-rotation. It should be appreciated that in some embodiments the optical fiber 2804 may be symmetrical. As such, there may be only two angles for the cleave angle. Variations in the x-direction may result in a more complex fiber face than a cleave angle. It should also be appreciated that the cleave angle may be non-zero in any combination of y-z coordinates, and as such, rotation of the optical fiber 2804 to address the non-zero cleave angle may be done by a respective combination of the v-w rotations.

FIG. 29B illustrates a diagram 2900B of the emission spot 2902 positioned such that the tilt measurement is within the tilt threshold 2952. The diagram 2900B may also illustrate the emission spot 2902 positioned such that the position measurement is within the position threshold. The diagram 2900B may be used to generate the tilt reference output 2852.

Similarly, if the emission spot 2902 had a position offset, then the optical fiber 2804 may be moved until a position measurement for the emission spot 2902 is within a position threshold. For example, the optical fiber 2804 may be modified until the emission spot 2902 aligns with the origin 2954 of the z-y axis or at some predetermined z-y coordinates.

It should be appreciated that aligning the emission spot 2902 with the tilt threshold 2952 and a position threshold may be an iterative process. For example, if the cleaved end 2808 is non-zero and a tilt measurement is determined, then the optical fiber 2804 may first be rotated along a respective rotation based on the tilt offset 2950. For example, based on the diagram 2900A, the optical fiber 2804 may be rotated along a v-rotation such that the cleaved end 2808 is moved down the y-axis while the opposing end 2838 is moved up the y-axis. Rotating the optical fiber 2804 along the v-rotation may cause the position of the emission spot 2902 to move downwards. As such, the position measurement generated by the position sensing device 2814 may determine a position offset. Then, based on the position offset, the longitudinal length 2806 of the optical fiber 2804 may be moved up on the y-axis. Moving the longitudinal length 2806 of the optical fiber 2804 up the y-axis may affect the tilt measurement generated by the tilt sensing device 2812. The optical fiber 2804 may be rotated to address the tilt measurement, and the process may continue until both the tilt measurement is within the tilt threshold 2952 and the position measurement is within the position threshold.

Once the tilt measurement and the position measurement of the emission spot 2902 are within the tilt threshold 2952 and the position threshold, respectively, a reference output, such as the position reference output 2850 and the tilt reference output 2852, may be generated. The reference output may be generated by at least one of the tilt measurement and/or the position measurement taken at the position of the optical fiber 2804, that is within the threshold. In some embodiments, the tilt threshold 2952 and/or the position threshold may vary depending on application. For example, in some applications, such as fusion splicing, the tolerance of the tilt threshold 2952 and/or position threshold may be small, thereby allowing minimal variation orientation of emission spot 2902. In other applications, the tolerance of the tilt threshold 2952 and/or position threshold may be larger, thereby allowing more flexibility with respect to the angular orientation of emission spot 2902.

After the reference output is generated, the MLA 2840 may be placed within the system 2800. It should be understood that, when generating the tilt measurement and the position measurement, and thereby the reference output, the MLA 2840 may not be present within the system 2800. Instead, the image of the emission spot 2902 may be captured from the cleaved end 2808 of the optical fiber 2804 prior to placement of the MLA 2840 within the system. After the reference output is generated, as described herein, the MLA 2840 may be positioned between the cleaved end 2808 of the optical fiber 2804 and the MLA alignment system 2810. Then, using the same or similar techniques as described above for capturing the tilt measurement and the position measurement, and generating the reference output therefrom, an MLA tilt value, an MLA position value, and an MLA beam output may be determined. For example, the MLA tilt value may be determined in a manner similar to how the tilt measurement is determined, the MLA position value may be determined in a manner similar to how the position measurement is determined, and the MLA beam output may be generated in a manner similar to how the reference output is generated.

The MLA 2840 may be placed within the system 2800 such that the lenslet 2802 is in rough alignment with the cleaved end 2808 of the optical fiber. Rough alignment, as used herein, may mean alignment according to human perception. For example, the MLA 2840 may be positioned within the system 2800 such that the lenslet 2802 visually appears to be in alignment with the cleaved end 2808 of the optical fiber 2804. Due to the small size of the optical fiber and the lenslet 2802 of the MLA, despite being in rough alignment, the cleaved end 2808 and the lenslet 2802 may not be in true alignment. Accordingly, to position and align the lenslet 2802 with the cleaved end 2808 of the optical fiber 2804, the tilt sensing device 2812 may measure an MLA tilt value and the position sensing device 2814 may measure an MLA position value. The MLA tilt value may be measured in a manner similar to the tilt measurement and the MLA position value may be measured in a manner similar to the position measurement.

An MLA beam output may be generated from at least one of the MLA tilt value and/or the MLA position value. As noted above, the MLA beam output may be generated using a similar method as is used for generating the reference output. The main difference is that the reference output may be generated without the MLA present in the system 2800 and the MLA beam output may be generated with the MLA present in the system 2800. The MLA beam output may be compared to an alignment threshold. In an example embodiment, comparing the MLA beam output to an alignment threshold may include comparing the MLA tilt value to an MLA tilt threshold and/or comparing the MLA position value to an MLA position threshold. The alignment threshold may include one or both of the MLA tilt threshold and the MLA position threshold.

Generation of the MLA beam output may be a similar iterative process to generation of the reference output in that the MLA tilt value and/or the MLA position value may be measured and then compared to their respective thresholds. If the MLA tilt value and/or the MLA position value are not within a respective threshold, however, the position of the MLA 2840 may be modified or adjusted, not the optical fiber 2804.

Returning now to FIG. 28A, the MLA 2840 may be placed and held within the system 2800 on an MLA stage 2842. The MLA stage 2842 may be configured to modify or adjust the position of the MLA 2840 along the x-axis, y-axis, and z-axis, and rotate the MLA 2840 along a w-rotation, u-rotation, or v-rotation. The position of the MLA 2840 may be modified or adjusted until the MLA beam output is within the alignment threshold. For example, the MLA 2840 may be modified or adjusted until the MLA tilt value and the MLA position are within the MLA tilt threshold and the MLA position threshold, respectively. As noted, the tolerance of the alignment threshold may differ based on application.

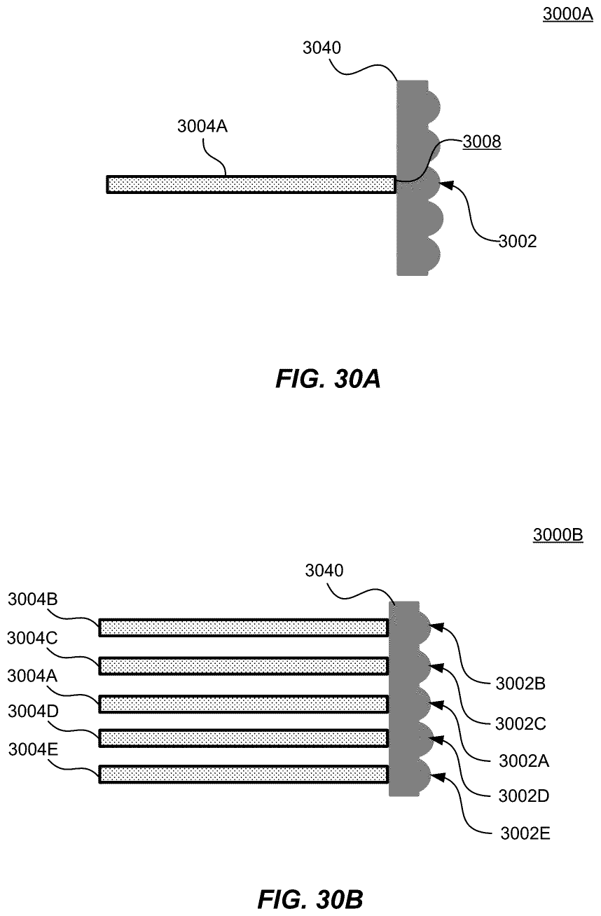

Once the MLA beam output is within the alignment threshold, the optical fiber 2804 may be attached to a lenslet 2802 of the MLA 2840. Turning now to FIG. 30A, a simplified schematic diagram 3000A illustrating alignment of an optical fiber with a lenslet in an MLA using the MLA alignment system illustrated in FIG. 28A is provided. The following discussion for FIGS. 30A and 30B will be made with reference to FIG. 28A; however, it should be understood that any system described herein may be used.

As shown by simplified schematic diagram 3000A, an optical fiber 3004A may be aligned with a lenslet 3002 of an MLA 3040. The optical fiber 3004A may be the same or similar to the optical fiber 2804. The optical fiber 3004A may be positioned and aligned with the lenslet 3002 using the system 2800, specifically using the MLA alignment system 2810, as described above. Once an MLA beam output for the MLA 3040 is within the alignment threshold, as described above, a cleaved end 3008 of the optical fiber 3004A may be attached to the lenslet 3002. Attaching the cleaved end 3008 to the lenslet 3002 may include securing, adhering, bonding, welding, optically contacting or fusing the cleaved end 3008 to the lenslet 3002.

In some embodiments, the optical fiber 3004A may be different from the optical fiber 2804. In such cases, the optical fiber 2804 may be a “golden fiber.” A “golden fiber” may be a fiber that has a desired manufacturing property, such as a desired cleave angle. The optical fiber 2804, when utilized as a golden fiber, may be used to align the MLA 3040, but may be removed from the system 2800 after the MLA 3040 is within the alignment threshold and the optical fiber 3004A may be placed therein for the securing process. The optical fiber 2804 as the golden fiber may be used for alignment of each lenslet in the MLA 3040. This may advantageously allow each of the lenslets to be aligned using the same cleaved end 2808, thereby providing a common alignment reference for each of the lenslets.

FIG. 30B provides a simplified schematic diagram 3000B illustrating alignment of multiple optical fibers 3004A-E with lenslets 3002A-E, i.e., multiple lenslets, in the MLA 3040 using the MLA alignment system illustrated in FIG. 28A. In some embodiments, each of the lenslets 3002A-E of the MLA 3040 may be aligned with one of the multiple optical fibers 3004A-E. For example, the lenslet 3002A may be aligned with the optical fiber 3004A, the lenslet 3002B may be aligned with the optical fiber 3004B, the lenslet 3002C may be aligned with the optical fiber 3004C, the lenslet 3002D may be aligned with the optical fiber 3004D, and the lenslet 3002E may be aligned with the optical fiber 3004E.

As noted above, a golden fiber may be used for alignment of each of the lenslets 3002A-E. For example, the optical fiber 2804 may be used to align each of the lenslets 3002A-E using the MLA alignment system 2810. In such an example, the MLA 2840 may be the same as the MLA 3040. Once each of the lenslets 3002A-E are in an alignment position, based on the alignment threshold, then the optical fiber 2804 may be removed from the system 2800 and replaced with one of the multiple optical fibers 3004A-E for each of the respective lenslets 3002A-E. For example, the optical fiber 2804 may be used for alignment of the lenslet 3002A. Once the lenslet 3002A is within the alignment threshold (based on the MLA tilt value and the MLA position value for the optical fiber 2804), the optical fiber 2804 may be replaced with the optical fiber 3004A in the system 2800. Then the optical fiber 3004A may be secured to the lenslet 3002A. Once the optical fiber 3004A is secured to the lenslet 3002A, the MLA 3040 may be repositioned and the optical fiber 2804 may be positioned back on the stage 2830. The MLA 3040 may be positioned such that the lenslet 3002B is in rough alignment with the optical fiber 2804. The process may then continue through aligning the lenslet 3002B with the optical fiber 2804 and then replacing the optical fiber 2804 with the optical fiber 3004B and securing the optical fiber 3004B to the lenslet 3002B. The process may continue for each of the multiple optical fibers 3004A-E. It should be understood that any number of multiple optical fibers 3004A-E and any number of lenslets 3002A-E may be aligned and/or secured using the systems and techniques used herein.

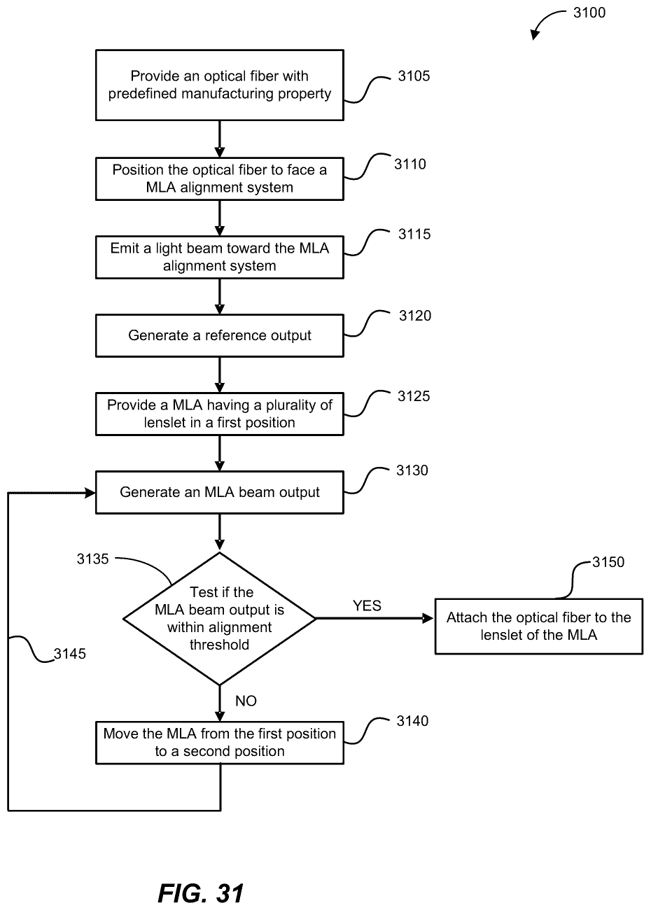

FIG. 31 provides a simplified flowchart illustrating a method 3100 of aligning an optical fiber with an MLA using an MLA alignment system according to an embodiment of the present invention. Various embodiments of the method 3100 of aligning an optical fiber with an MLA using an MLA alignment system may be performed in an automated system such as system 100 shown in FIG. 1. The following discussion is made with reference to FIGS. 28A-28B; however, it should be understood that the method 3100 may be performed using any system or technique described herein.

The method 3100 may include step 3105. At step 3105, an optical fiber, such as optical fiber 2804, having a first end and a second end, may be provided. The first end of the optical fiber may include one or more predefined manufacturing properties. For example, the first end of the optical fiber 2804 may be the cleaved end 2808 having a predefined cleave angle.

At step 3110, the method 3100 may include positioning the optical fiber such that the first end of the optical fiber faces an MLA alignment system. For example, at step 3110, the optical fiber 2804 may be positioned such that the cleaved end 2808 faces the MLA alignment system 2810. The MLA alignment system may include a tilt sensing device, such as the tilt sensing device 2812, and a position sensing device, such as the position sensing device 2814.

At step 3115, the method 3100 may include emitting a light beam from the first end of the optical fiber toward the MLA alignment system. For example, a light beam may be emitted from the cleaved end 2808 of the optical fiber 2804 toward the MLA alignment system 2810. In some embodiments, the MLA alignment system 2810 may further include a beam splitter 2816 and a collecting lens, also referred to as a collection lens, such as the collecting lens 2820. In such cases, step 3115 may further include transmitting a first portion of the light beam from the cleaved end 2808 of the optical fiber 2804 through the beam splitter 2816 before reaching the position sensing device 2814 and reflecting a second portion of the light beam from the cleaved end 2808 of the optical fiber 2804 off of the beam splitter 2816 and through the collecting lens 2820 before reaching the tilt sensing device 2812.

At step 3120, the method 3100 may include generating a reference output for the optical fiber 2804 in a first position. A reference output may be generated prior to placing the MLA 2840 between the optical fiber 2804 and the MLA alignment system 2810. As discussed above with respect to FIGS. 29A and 29B, the reference output may include at least one of a tilt measurement or a position measurement. As such, in some embodiments, the step 3120 may include measuring, via the tilt sensing device, a first tilt measurement based on the light beam emitted from the first end of the optical fiber in the first position and measuring, via the position sensing device, a first position measurement based on the light beam emitted from the first end of the optical fiber in the first position. The first tilt measurement may be compared to a tilt threshold and the first position measurement may be compared to a position threshold.

If the first tilt measurement and/or the first position measurement are not within the tilt threshold and position threshold, respectively, then the method 3100 may further include positioning the optical fiber in a second position. For example, the optical fiber may be moved or adjusted from the first position to the second position by moving the optical fiber along the x-axis, y-axis, z-axis, or rotating the optical fiber along a w-rotation, v-rotation, or u-rotation. At the second position, a second tilt measurement and a second position measurement may be gathered by the tilt sensing device 2812 and the position sensing device 2814, respectively.

A second reference output may be generated based on the second tilt measurement and the second position measurement. In some embodiments, the second tilt measurement may be compared to the tilt threshold and the second position measurement may be compared to the position threshold. As noted above, the method 3100 may be an iterative process in which the positioning of the optical fiber 2804 may be modified until the tilt measurement and/or the position measurement are within the tilt threshold and the position threshold, respectively. Once the tilt measurement and the position measurement are within their respective thresholds, the method 3100 may continue to the next step.

At step 3125, the method may include providing an MLA, such as the MLA 2840, having a plurality of lenslets in a first position between the first end of the optical fiber and the MLA alignment system. In some embodiments, the MLA 2840 may be positioned such that the lenslet 2802 is in rough alignment with the cleaved end 2808 of the optical fiber 2804. For example, the MLA 2840 may be placed in the first position such that the light beam emitting from the cleaved end 2808 of the optical fiber 2804 transmits through the lenslet 2802 of the MLA 2840.

Once the MLA 2840 is in the first position, an MLA beam output may be generated at step 3130. The MLA beam output may include at least one of a first MLA tilt value or a first

MLA position value. The MLA beam output may be generated by measuring, via the tilt sensing device 2812, the first MLA tilt value and measuring, via the position sensing device, the first MLA position value.

At step 3135, the method may include comparing the MLA beam output to an alignment threshold. In some embodiments, comparing the MLA beam output to the alignment threshold may include comparing the first MLA tilt value to an MLA tilt threshold, and comparing the first MLA position value to an MLA position threshold. In an example embodiment, the alignment threshold may include the first MLA tilt threshold and the first MLA position threshold.

If the MLA beam output is not within the alignment threshold, then the method 3100 may continue to step 3140. At step 3140, the MLA 2840 may be moved from the first position to a second position. For example, moving the MLA 2840 from the first position to the second position may include moving or adjusting the MLA 2840 along at least one of an x-axis, a y-axis, z-axis, w-rotation, u-rotation, or v-rotation. Once the MLA 2840 is at the second position, the method 3100 may return to step 3130 via iterative step 3145. At step 3130, a second MLA beam output may be generated based on the second position of the MLA. To generate the second MLA beam output, a second MLA tilt value may be measured via the tilt sensing device 2812 and a second MLA position value may be measured via the position sensing device 2814.

The second MLA beam output may then be compared to the alignment threshold at step 3135. For example, the second MLA tilt value may be compared to the MLA tilt threshold and the second MLA position value may be compared to the MLA position threshold. The method 3100 is an iterative process in that steps 3130-3145 may repeat until the MLA beam output is within the alignment threshold.

Once the MLA beam output is within the alignment threshold, the method 3100 may continue to step 3150. At step 3150, the optical fiber 2804 may be attached to the lenslet 2802 of the MLA 2840. In some embodiments, a different optical fiber than the optical fiber 2804 may be attached to the lenslet 2802. For example, as described with respect to FIGS. 30A and 30B, the optical fiber 2804 may be a golden fiber and once the MLA 2840 is in an alignment position, the optical fiber 2804 may be replaced with the optical fiber 3004A. The optical fiber 3004A may be attached or secured to the lenslet 2802. Attaching the optical fiber 2804 (or the optical fiber 3004A) to the lenslet 2802 of the MLA 2840 may include securing or bonding the cleaved end 2808 of the optical fiber 2804 to the lenslet 2802.

It should be appreciated that the specific steps illustrated in FIG. 31 provide a particular method of aligning an optical fiber with an MLA using an MLA alignment system according to an embodiment of the present invention. Other sequences of steps may also be performed according to alternative embodiments. For example, alternative embodiments of the present invention may perform the steps outlined above in a different order. Moreover, the individual steps illustrated in FIG. 31 may include multiple sub-steps that may be performed in various sequences as appropriate to the individual step. Furthermore, additional steps may be added or removed depending on the particular applications. One of ordinary skill in the art would recognize many variations, modifications, and alternatives.

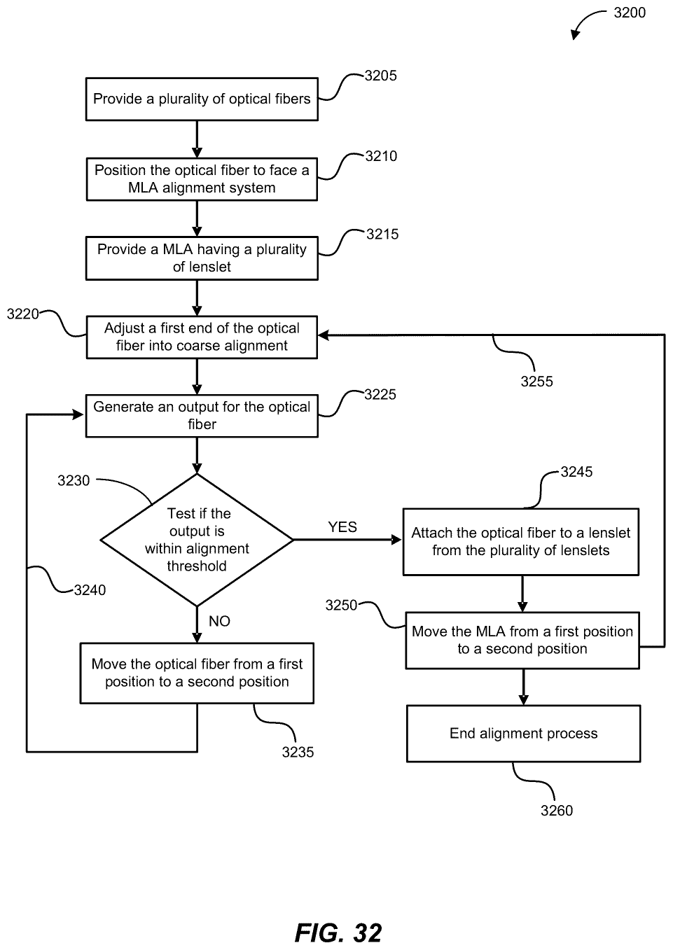

FIG. 32 provides a simplified flowchart illustrating a method of aligning multiple optical fibers with multiple lenslets of an MLA using an MLA alignment system according to an embodiment of the present invention. The following discussion is made with reference to other FIGS., however, it should be understood that the method 3200 may be performed using any system or technique described herein.

At step 3205, the method 3200 may include providing a plurality of optical fibers. For example, multiple optical fibers 3004A-E may be provided. The multiple optical fibers 3004A-E may include a first optical fiber having a first end and a second end and a second optical fiber having a third end and a fourth end. At step 3210, a first optical fiber, such as the optical fiber 3004A, may be positioned such that the first end (e.g., the cleaved end 2808) faces an MLA alignment system, such as the MLA alignment system 2810. The MLA alignment system may include a tilt sensing device, such as the tilt sensing device 2812, and a position sensing device, such as the position sensing device 2814.

At step 3215, an MLA having a plurality of lenslets may be provided at a first position. For example, the MLA 2840 having a plurality of lenslets may be provided between the cleaved end 2808 of the optical fiber 2804 and the MLA alignment system 2810. As noted with reference to FIGS. 30A and 30B, the MLA may have a plurality of lenslets, such as lenslets 3002A-E, including a first lenslet and a second lenslet. For example, the lenslet 3002A may be the first lenslet and the lenslet 3002B may be the second lenslet.

In some embodiments, the method 3200 may include emitting a light beam from the first end of the first optical fiber. In an example embodiment, the MLA alignment system 2810 may include a beam splitter, such as beam splitter 2816, and a collecting lens, such as the collecting lens 2820. In such examples, the light beam emitted from the first end of the first optical fiber may include transmitting a first portion of the light beam from the first end of the first optical fiber through the beam splitter 2816 before reaching the position sensing device 2814 and reflecting a second portion of the light beam from the first end of the first optical fiber off of the beam splitter 2816 and through the collecting lens 2820 before reaching the tilt sensing device 2812.

At step 3220, the first end of the optical fiber may be adjusted into coarse alignment with the first lenslet. For example, the cleaved end of the optical fiber 3004A may be adjusted into coarse alignment with the lenslet 3002A. In some embodiments, adjusting the first end of the optical fiber into coarse alignment with the first lenslet may include positioning the first end of the optical fiber at a predetermined distance from a surface of the first lenslet. As noted above, coarse alignment may mean alignment of the first end of the optical fiber with the first lenslet according to the human perception (e.g., visually aligning the first end with the first lenslet).

At step 3225, an output may be generated. For example, a first MLA beam output may be generated for the first optical fiber. The first MLA beam output may include at least one of a first tilt value or a first position value. The first tilt value may be measured by the tilt sensing device 2812 and the first position value may be measured by the position sensing device 2814.

At step 3230, the first MLA beam output may be compared to an alignment threshold. The alignment threshold may include at least one of an MLA tilt threshold or an MLA position threshold. If at step 3230, the MLA beam output is not within the alignment threshold, then the method 3200 may continue to step 3235. At step 3235, the optical fiber may be moved from a first position to a second position. For example, the optical fiber 2804 may be moved or adjusted along an x-axis, a y-axis, z-axis, or rotated along a w-rotation, a u-rotation, or a v-rotation.

The method 3200 may return to step 3225 via iteration step 3240. At step 3225, a second MLA beam output may be generated for the optical fiber in the second position. For example, a second MLA tilt value may be measured via the tilt sensing device 2812 and a second MLA position value may be measured via the position sensing device 2814. The second output may be generated based on the second MLA tilt value and the second MLA position value.

At step 3230, the second MLA beam output may be compared to the alignment threshold. In some embodiments, the second MLA tilt value may be compared to the MLA tilt threshold and the second MLA position value may be compared to the MLA position threshold. The method 3200 may be an iterative process in that steps 3225-3240 may be performed until the MLA beam output is within the alignment threshold.

Once the MLA beam output is within the alignment threshold, the method may continue to step 3245. At step 3245, the optical fiber may be attached to the lenslet. For example, the first end of the first optical fiber may be attached to the first lenslet of the plurality of lenslets. As discussed above with reference to FIG. 30B, a first end of the optical fiber 3004A may be attached to the lenslet 3002A. Attaching the optical fiber to the lenslet may include securing or bonding the optical fiber to the lenslet.

Once the first end of the first optical fiber is attached to the first lenslet, the MLA may be moved from the first position to the second position at step 3250. Moving the MLA to the second position may include moving the MLA to a second position between the third end of the second optical fiber and the MLA alignment system. The method 3200 may return to step 3220 via iterative step 3255. At step 3220, the third end of the second optical fiber may be adjusted into coarse alignment with the second lenslet. For example, with reference to FIG. 30B, after the optical fiber 3004A is attached to the lenslet 3002A, the MLA 3040 may be moved to a second position such that the optical fiber 3004B is in coarse alignment with the lenslet 3002B. Specifically, the third end of the optical fiber 3004B may be adjusted into coarse alignment with the lenslet 3002B.

After the third end of the optical fiber 3004B is in coarse alignment with the lenslet 3002B, then a second MLA beam output for the optical fiber 3004B may be generated and the method 3200 may continue through steps 3230-3240 until the second MLA beam output for the optical fiber 3004B is within the alignment threshold. At that point, the optical fiber 3004B may be attached to the lenslet 3002B at step 3245. Then at step 3250, the MLA may be moved to a third position between a fifth end of a third optical fiber, such as the optical fiber 3004C, and the MLA alignment system such that the fifth end of the third optical fiber is in coarse alignment with a third lenslet, such as the lenslet 3002C, at step 3220.

The method 3200 may continue until all of the plurality of optical fibers are attached to a respective lenslet in the MLA. At that point, the method 3200 may continue to step 3260 at which the alignment process is ended.

It should be appreciated that the specific steps illustrated in FIG. 32 provide a particular method of aligning multiple optical fibers with multiple lenslets of an MLA using an MLA alignment system according to an embodiment of the present invention. Other sequences of steps may also be performed according to alternative embodiments. For example, alternative embodiments of the present invention may perform the steps outlined above in a different order. Moreover, the individual steps illustrated in FIG. 32 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method for constructing a fiber array, the method comprising: a) selecting a fiber spool among one or more fiber spools; b) processing a portion of the fiber spool to form an optical fiber having an output end; c) positioning a substrate at a position of a plurality of positions; d) aligning the output end of the optical fiber to the substrate; e) coupling the output end of the optical fiber to a location of a plurality of locations on the substrate; f) detaching the optical fiber from the fiber spool to form an input end of the optical fiber; g) marking the optical fiber; and repeating c) through g) for each of the plurality of locations on the substrate; and determining that the substrate has been positioned at each of the plurality of positions.

Example 2 is the method of example 1, wherein selecting the fiber spool among the one or more fiber spools comprises: providing an optical fiber presence sensing system comprising: a first illumination source configured to emit a light beam along an optical path; and a first detector, wherein the first detector is: positioned off-axis with respect to the optical path; and configured to detect a presence of light; positioning the optical fiber along the optical path; impinging the light beam onto at least a portion of the optical fiber; refracting light from the light beam by at least a portion of the optical fiber to produce a refracted beam; and detecting, based at least in part on the refracted beam and using the first detector, the optical fiber.

Example 3 is the method of example(s) 1-2, wherein processing a portion of the fiber spool to form an optical fiber having an output end comprises: drawing a length of fiber from the fiber spool to form the optical fiber; transporting an end of the optical fiber from the fiber spool to a stripper; installing a length of the optical fiber into the stripper; and stripping any coating off the length of the optical fiber.

Example 4 is the method of example(s) 1-3, wherein processing a portion of the fiber spool to form an optical fiber having an output end comprises: transporting the optical fiber from the fiber spool to a clean area; removing coating debris from a length of the optical fiber; and cleaning the optical fiber.

Example 5 is the method of example(s) 1-4, wherein processing a portion of the fiber spool to form an optical fiber having an output end comprises: transporting a length of the optical fiber to a cleaver; installing the length of the optical fiber into the cleaver; cleaving the optical fiber; and removing the optical fiber from the fiber spool.

Example 6 is the method of example(s) 1-5, wherein processing a portion of the fiber spool to form an optical fiber having an output end comprises: providing the optical fiber having a longitudinal axis and a distal tip characterized by a cleave angle; imaging the distal tip of the optical fiber; determining, based on the imaging, a pose of the distal tip of the optical fiber; emitting light from a light source, wherein the optical fiber is configured to receive the light emitted by the light source; emitting characterization light from the distal tip of the optical fiber;

detecting, at an image sensor, the characterization light; and determining, based on the characterization light and the pose of the distal tip of the optical fiber, the cleave angle of the optical fiber.

Example 7 is the method of example(s) 1-6, wherein processing a portion of the fiber spool to form an optical fiber having an output end comprises: providing the optical fiber having a longitudinal axis and a distal tip characterized by a cleave angle; imaging the distal tip of the optical fiber; translating the optical fiber via a multi-stage axis to reduce or minimize a distance from the distal tip of the optical fiber and the longitudinal axis; determining, based on the imaging, a pose of the distal tip of the optical fiber; emitting light from a light source, wherein the optical fiber is configured to receive the light emitted by the light source; emitting characterization light from the distal tip of the optical fiber; detecting, at an image sensor, the characterization light; and determining, based on the characterization light and the pose of the distal tip of the optical fiber, the cleave angle of the optical fiber.

Example 8 is the method of example(s) 1-7, wherein aligning the optical fiber to a substrate comprises: translating the optical fiber to a rotation station; placing an optical fiber onto a rotation stage; securing the optical fiber on the rotation stage; illuminating the optical fiber on the rotation stage; collecting an initial image of an emission face of the optical fiber; calculating a rotational offset of the optical fiber based on the initial image; rotating the optical fiber on the rotation stage if the rotational offset of the optical fiber is not within a tolerance; iteratively collecting at least one more additional image of the emission face of the optical fiber; and releasing the optical fiber if the rotational offset of the optical fiber is within the tolerance.

Example 9 is the method of example(s) 1-8, wherein aligning the optical fiber to a substrate comprises: translating the optical fiber to a rotation station; placing a first optical fiber on a first rotation stage; placing a second optical fiber on a second rotation stage; securing the first optical fiber on the first rotation stage; securing the second optical fiber on the second rotation stage; collecting an initial image of a first emission face of the first optical fiber and a second emission face of the second optical fiber; calculating an alignment offset based on the initial image; rotating the first optical fiber to a modified position if the alignment offset is not within a tolerance; iteratively collecting at least one more additional image of the first emission face of the first optical fiber and the second emission face of the second optical fiber; and releasing the optical fiber if the alignment offset is within the tolerance.

Example 10 is the method of example(s) 1-9, wherein aligning the optical fiber to a substrate comprises: translating the optical fiber to a rotation station; placing an optical fiber on a rotation stage, wherein the optical fiber comprises a cantilevered end; securing the optical fiber on the rotation stage; collecting a plurality of images, wherein each of the plurality of images is associated with a different rotational position of the cantilevered end of the optical fiber; determining that the plurality of images is at a threshold; computing a deflection of the cantilevered end of the optical fiber based on the plurality of images is associated with a different rotational position of the cantilevered end of the optical fiber; and computing a radius of curvature of the optical fiber based on the deflection of the cantilevered end of the optical fiber.

Example 11 is the method of example(s) 1-10, wherein detaching the optical fiber from the fiber spool to form the input end of the optical fiber comprises: taking up at least a portion of the optical fiber; locating and grabbing the output end of the optical fiber; and cutting the at least a portion of the optical fiber.

Example 12 is the method of example(s) 1-11, wherein marking the optical fiber comprises: transporting the optical fiber coupled to the substrate to a labeling station; and labeling the optical fiber coupled to the substrate.

Example 13 is the method of example(s) 1-12, wherein coupling the output end of the optical fiber to a location of a plurality of locations on the substrate comprises laser welding.

Example 14 is the method of example(s) 1-13, further comprising applying a potting agent to each fiber-substrate.

Example 15 is the method of example(s) 1-14, further comprising curing the potting agent.

Example 16 is the method of example(s) 1-15, wherein processing the portion of the fiber spool includes removing a fiber jacket from the portion of the fiber spool.

Example 17 is the method of example(s) 1-16, wherein an optical fiber is positioned at each of the plurality of positions for forming the fiber array.

Example 18 is the method of example(s) 1-17, wherein the input end of the optical fiber is configured to receive light from a light source.

Example 19 is the method of example(s) 1-18, wherein marking the optical fiber includes labelling the optical fiber including an index to a position in the fiber array.

Example 20 is the method of example(s) 1-19, wherein a plurality of fiber spools are selected and processed concurrently.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for constructing a fiber array, the method comprising:
a) selecting a fiber spool among one or more fiber spools;
b) processing a portion of the fiber spool to form an optical fiber having an output end;
c) positioning a substrate at a position of a plurality of positions;
d) aligning the output end of the optical fiber to the substrate;
e) coupling the output end of the optical fiber to a location of a plurality of locations on the substrate;
f) detaching the optical fiber from the fiber spool to form an input end of the optical fiber;
g) marking the optical fiber; and
repeating c) through g) for each of the plurality of locations on the substrate; and
determining that the substrate has been positioned at each of the plurality of positions.

2. The method of claim 1, wherein selecting the fiber spool among the one or more fiber spools comprises:
providing an optical fiber presence sensing system comprising:
a first illumination source configured to emit a light beam along an optical path; and
a first detector, wherein the first detector is:
positioned off-axis with respect to the optical path; and
configured to detect a presence of light;
positioning the optical fiber along the optical path;
impinging the light beam onto at least a portion of the optical fiber;
refracting light from the light beam by at least a portion of the optical fiber to produce a refracted beam; and
detecting, based at least in part on the refracted beam and using the first detector, the optical fiber.

3. The method of claim 1, wherein processing a portion of the fiber spool to form an optical fiber having an output end comprises:
drawing a length of fiber from the fiber spool to form the optical fiber;
transporting an end of the optical fiber from the fiber spool to a stripper;
installing a length of the optical fiber into the stripper; and
stripping any coating off the length of the optical fiber.

4. The method of claim 1, wherein processing a portion of the fiber spool to form an optical fiber having an output end comprises:
transporting the optical fiber from the fiber spool to a clean area;
removing coating debris from a length of the optical fiber; and
cleaning the optical fiber.

5. The method of claim 1, wherein processing a portion of the fiber spool to form an optical fiber having an output end comprises:
transporting a length of the optical fiber to a cleaver;
installing the length of the optical fiber into the cleaver;
cleaving the optical fiber; and
removing the optical fiber from the fiber spool.

6. The method of claim 1, wherein processing a portion of the fiber spool to form an optical fiber having an output end comprises:
providing the optical fiber having a longitudinal axis and a distal tip characterized by a cleave angle;
imaging the distal tip of the optical fiber;
determining, based on the imaging, a pose of the distal tip of the optical fiber;
emitting light from a light source, wherein the optical fiber is configured to receive the light emitted by the light source;
emitting characterization light from the distal tip of the optical fiber;
detecting, at an image sensor, the characterization light; and
determining, based on the characterization light and the pose of the distal tip of the optical fiber, the cleave angle of the optical fiber.

7. The method of claim 1, wherein processing a portion of the fiber spool to form an optical fiber having an output end comprises:
providing the optical fiber having a longitudinal axis and a distal tip characterized by a cleave angle;
imaging the distal tip of the optical fiber;
translating the optical fiber via a multi-stage axis to reduce or minimize a distance from the distal tip of the optical fiber and the longitudinal axis;
determining, based on the imaging, a pose of the distal tip of the optical fiber;
emitting light from a light source, wherein the optical fiber is configured to receive the light emitted by the light source;
emitting characterization light from the distal tip of the optical fiber;
detecting, at an image sensor, the characterization light; and
determining, based on the characterization light and the pose of the distal tip of the optical fiber, the cleave angle of the optical fiber.

8. The method of claim 1, wherein aligning the optical fiber to a substrate comprises:
translating the optical fiber to a rotation station;
placing an optical fiber onto a rotation stage;
securing the optical fiber on the rotation stage;
illuminating the optical fiber on the rotation stage;
collecting an initial image of an emission face of the optical fiber;
calculating a rotational offset of the optical fiber based on the initial image;
rotating the optical fiber on the rotation stage if the rotational offset of the optical fiber is not within a tolerance;
iteratively collecting at least one more additional image of the emission face of the optical fiber; and
releasing the optical fiber if the rotational offset of the optical fiber is within the tolerance.

9. The method of claim 1, wherein aligning the optical fiber to a substrate comprises:
translating the optical fiber to a rotation station;
placing a first optical fiber on a first rotation stage;
placing a second optical fiber on a second rotation stage;
securing the first optical fiber on the first rotation stage;
securing the second optical fiber on the second rotation stage;
collecting an initial image of a first emission face of the first optical fiber and a second emission face of the second optical fiber;
calculating an alignment offset based on the initial image;
rotating the first optical fiber to a modified position if the alignment offset is not within a tolerance;
iteratively collecting at least one more additional image of the first emission face of the first optical fiber and the second emission face of the second optical fiber; and
releasing the optical fiber if the alignment offset is within the tolerance.

10. The method of claim 1, wherein aligning the optical fiber to a substrate comprises:
translating the optical fiber to a rotation station;
placing an optical fiber on a rotation stage, wherein the optical fiber comprises a cantilevered end;
securing the optical fiber on the rotation stage;
collecting a plurality of images, wherein each of the plurality of images is associated with a different rotational position of the cantilevered end of the optical fiber;
determining that the plurality of images is at a threshold;
computing a deflection of the cantilevered end of the optical fiber based on the plurality of images is associated with a different rotational position of the cantilevered end of the optical fiber; and
computing a radius of curvature of the optical fiber based on the deflection of the cantilevered end of the optical fiber.

11. The method of claim 1, wherein detaching the optical fiber from the fiber spool to form the input end of the optical fiber comprises:
taking up at least a portion of the optical fiber;
locating and grabbing the output end of the optical fiber; and
cutting the at least a portion of the optical fiber.

12. The method of claim 1, wherein marking the optical fiber comprises:
transporting the optical fiber coupled to the substrate to a labeling station; and
labeling the optical fiber coupled to the substrate.

13. The method of claim 1, wherein coupling the output end of the optical fiber to a location of a plurality of locations on the substrate comprises laser welding.

14. The method of claim 1, further comprising applying a potting agent to each fiber-substrate.

15. The method of claim 14, further comprising curing the potting agent.

16. The method of claim 1, wherein processing the portion of the fiber spool includes removing a fiber jacket from the portion of the fiber spool.

17. The method of claim 1, wherein an optical fiber is positioned at each of the plurality of positions for forming the fiber array.

18. The method of claim 1, wherein the input end of the optical fiber is configured to receive light from a light source.

19. The method of claim 1, wherein marking the optical fiber includes labelling the optical fiber including an index to a position in the fiber array.

20. The method of claim 1, wherein a plurality of fiber spools are selected and processed concurrently.
